(19) United States
(12) Patent Application Publication
(10) Pub. No.: US 2025/0153788 A1
(43) Pub. Date: May 15, 2025

(54) AUTOMATED CONNECTION BETWEEN VEHICLE AND COUNTERPART-DISPOSED CONFIGURATION

(71) Applicant: ELECTRANS TECHNOLOGIES LTD., Oakville (CA)

(72) Inventors: Brian Layfield, Oakville (CA); Brian Fan, Oakville (CA); Mitchell Phillips, Oakville (CA); Andrew Constantinescu, Oakville (CA); Abhinav Dhar, Oakville (CA)

(21) Appl. No.: 18/834,612

(22) PCT Filed: Jan. 31, 2022
(86) PCT No.: PCT/CA2023/050136

§ 371 Date: Jul. 30, 2024

Related U.S. Application Data
(60) Provisional application No. 63/304,741, filed on Jan. 31, 2022.

(51) Int. Cl. B62D 53/12; B60D 1/01; B60D 1/64

(52) U.S. Cl. CPC B62D 53/12; B60D 1/015; B60D 1/64

(57) ABSTRACT

Disclosed herein is a vehicle, comprising a vehicle-defined connection counterpart and an object manipulator. The object manipulator comprises an end effector releasably coupled with the vehicle-defined connection counterpart, such that a coupled end effector is established, and a guide, configured for guiding displacement of the end effector. The vehicle-defined connection counterpart is configured for connection to a configuration-defined connection counterpart of a configuration, such as a trailer or a charging dock. While the object manipulator is disposed in contact engagement with the configuration, in response to a force applied to the object manipulator for urging displacement of the object manipulator towards the configuration, an alignment reaction force is applied by the configuration to the object manipulator to urge displacement of the object manipulator, with effect that an alignment relationship-obtaining displacement of the coupled end effector, relative to the configuration-defined connection counterpart, is effectuated by the alignment reaction force.

### FIELD

This disclosure relates generally to the road transportation industry. More specifically, the disclosure is directed at an automated connection between a vehicle and a counterpart-disposed configuration, such as a trailer or a charging dock.

### BACKGROUND

To transport a trailer by a towing vehicle, fluid and electrical connections between the towing vehicle and the trailer are to be established for the actuation and control of the fluid system and the electrical system of the trailer, for example, service brakes, parking brakes, the ABS brakes, and turn signals. Currently, establishment of such connections are done manually, wherein an operator of the towing vehicle exits the vehicle to connect the air and electrical lines from the towing vehicle to the trailer.

Further, vehicles require energy for operation. For example, a towing vehicle requires diesel fuel to operate the engine for driving the vehicle, electrical energy to operate the electrical components of the towing vehicle and the electrical system of the trailer that is being towed by the towing vehicle, hydrogen to operate a hydrogen drive system, natural gas to operate a natural gas motor, and pneumatic gas to operate the pneumatic components of the towing vehicle and the fluid system of the trailer. The different types of energy are stored on the towing vehicle, for example, in a diesel fuel tank, battery, hydrogen storage tank, natural gas tank, and pneumatic gas tank. As the energy is used, the energy storage device in which the energy is stored has to be replenished. Currently, replenishment of the energy storage device is done manually, wherein an operator of the towing vehicle exits the vehicle to connect the energy storage devices on the towing vehicle to a corresponding energy source.

### SUMMARY

In one aspect, there is provided a vehicle, comprising: a vehicle-defined connection counterpart; and an object manipulator, comprising: an end effector releasably coupled with the vehicle-defined connection counterpart, such that a coupled end effector is established; and a guide, configured for guiding displacement of the end effector; wherein: the vehicle-defined connection counterpart is configured for connection to a configuration-defined connection counterpart of a counterpart-disposed configuration, the counterpart-disposed configuration comprising: a front surface; and a bottom surface, disposed below the front surface; the vehicle is configured to co-operate with the counterpart-disposed configuration such that: while: (i) the coupled end effector is established, (ii) the vehicle-defined connection counterpart and the configuration-defined connection counterpart are co-operatively disposed in a misaligned relationship, wherein, in the misaligned relationship, there is an absence of alignment between the vehicle-defined connection counterpart and the configuration-defined connection counterpart, and (iii) the object manipulator is disposed in a guiding-effective relationship with the counterpart-disposed configuration, wherein, in the guiding-effective relationship, contact engagement between the object manipulator and the front surface and bottom surface of the counterpart-disposed configuration is effectible: while the object manipulator is disposed in contact engagement with the front surface and bottom surface, in response to a force applied to the object manipulator for urging displacement of the object manipulator towards the front surface and the bottom surface, an alignment reaction force is applied by the front surface and the bottom surface to the object manipulator to urge displacement of the object manipulator, with effect that an alignment relationship-obtaining displacement of the coupled end effector, relative to the configuration-defined connection counterpart, is effectuated by the alignment reaction force, wherein the alignment relationship-obtaining displacement is guided by the guide, wherein the guided displacement is effective for emplacing the vehicle-defined connection counterpart in alignment with the configuration-defined connection counterpart, such that the vehicle-defined connection counterpart and the configuration-defined connection counterpart become disposed in an alignment relationship for establishing connection between the vehicle-defined connection counterpart and the configuration-defined connection counterpart.

In another aspect, there is provided a kit for modifying a vehicle and a counterpart-absent configuration, the counterpart-absent configuration comprises, a front surface, a bottom surface disposed below the front surface, the kit comprising: vehicle adaptor components including: a vehicle-defined connection counterpart; and an object manipulator, comprising: an end effector configured for being releasably coupled with the vehicle-defined connection counterpart, such that a coupled end effector is established; and a guide, configured for guiding displacement of the end effector; configuration adaptor components including: a configuration-defined connection counterpart; and wherein: while: (i) the vehicle adaptor components are installed within a vehicle, with effect that a modified vehicle is established, such that the modified vehicle includes the vehicle-defined connection counterpart and the object manipulator, and (ii) the configuration adaptor components are installed within the counterpart-absent configuration with effect that a modified configuration is established, such that the modified configuration includes the configuration-defined connection counterpart: the vehicle-defined connection counterpart is configured for connection to the configuration-defined connection counterpart; and the modified vehicle and the modified configuration are co-operatively configured such that: while: (i) the coupled end effector is established, (ii) the vehicle-defined connection counterpart and the configuration-defined connection counterpart are co-operatively disposed in a misaligned relationship, wherein, in the misaligned relationship, there is an absence of alignment between the vehicle-defined connection counterpart and the configuration-defined connection counterpart, and (iii) the object manipulator is disposed in a guiding-effective relationship with the modified configuration, wherein, in the guiding-effective relationship, contact engagement between the object manipulator and the front surface and bottom surface of the modified configuration is effectible: while the object manipulator is disposed in contact engagement with the front surface and bottom surface, in response to a force applied to the object manipulator for urging displacement of the object manipulator towards the front surface and the bottom surface, an alignment reaction force is applied by the front surface and the bottom surface to the object manipulator to urge displacement of the object manipulator, with effect that an alignment relationship-obtaining displacement of the coupled end effector, relative to the configuration-defined connection counterpart, is effectuated by the alignment reaction force, wherein the alignment relationship-obtaining displacement is guided by the guide, wherein the guided displacement is effective for emplacing the vehicle-defined connection counterpart in alignment with the configuration-defined connection counterpart, such that the vehicle-defined connection counterpart and the configuration-defined connection counterpart become disposed in an alignment relationship for establishing connection between the vehicle-defined connection counterpart and the configuration-defined connection counterpart.

In another aspect, there is provided a system, comprising: a towing vehicle, comprising: a vehicle-defined connection counterpart; and an object manipulator, comprising: an end effector releasably coupled with the vehicle-defined connection counterpart, such that a coupled end effector is established; and a guide, configured for guiding displacement of the end effector; a counterpart-disposed configuration, comprising: a configuration-defined connection counterpart; a front surface; and a bottom surface, disposed below the front surface; wherein: the vehicle-defined connection counterpart and the configuration-defined connection counterpart are co-operatively configured for connection; the vehicle and the counterpart-disposed configuration are co-operatively configured such that: while: (i) the coupled end effector is established, (ii) the vehicle-defined connection counterpart and the configuration-defined connection counterpart are co-operatively disposed in a misaligned relationship, wherein, in the misaligned relationship, there is an absence of alignment between the vehicle-defined connection counterpart and the configuration-defined connection counterpart, and (iii) the object manipulator is disposed in a guiding-effective relationship with the counterpart-disposed configuration, wherein, in the guiding-effective relationship, contact engagement between the object manipulator and the front surface and bottom surface of the counterpart-disposed configuration is effectible: while the object manipulator is disposed in contact engagement with the front surface and bottom surface, in response to a force applied to the object manipulator for urging displacement of the object manipulator towards the front surface and the bottom surface, an alignment reaction force is applied by the front surface and the bottom surface to the object manipulator to urge displacement of the object manipulator, with effect that an alignment relationship-obtaining displacement of the coupled end effector, relative to the configuration-defined connection counterpart, is effectuated by the alignment reaction force, wherein the alignment relationship-obtaining displacement is guided by the guide, wherein the guided displacement is effective for emplacing the vehicle-defined connection counterpart in alignment with the configuration-defined connection counterpart, such that the vehicle-defined connection counterpart and the configuration-defined connection counterpart become disposed in an alignment relationship for establishing connection between the vehicle-defined connection counterpart and the configuration-defined connection counterpart.

In another aspect, there is provided a counterpart-disposed configuration, comprising: a configuration-defined connection counterpart; a front surface; and a bottom surface; disposed below the front surface; wherein: the configuration-defined connection counterpart is configured for connection to a vehicle-defined connection counterpart of a vehicle, the vehicle comprising: an object manipulator, comprising: an end effector releasably coupled with the vehicle-defined connection counterpart, such that a coupled end effector is established; and a guide, configured for guiding displacement of the end effector; the counterpart-disposed configuration is configured to co-operate with the vehicle such that: while: (i) the coupled end effector is established, (ii) the vehicle-defined connection counterpart and the configuration-defined connection counterpart are co-operatively disposed in a misaligned relationship, wherein, in the misaligned relationship, there is an absence of alignment between the vehicle-defined connection counterpart and the configuration-defined connection counterpart, and (iii) the object manipulator is disposed in a guiding-effective relationship with the counterpart-disposed configuration, wherein, in the guiding-effective relationship, contact engagement between the object manipulator and the front surface and bottom surface of the counterpart-disposed configuration is effectible: while the object manipulator is disposed in contact engagement with the front surface and bottom surface, in response to a force applied to the object manipulator for urging displacement of the object manipulator towards the front surface and the bottom surface, an alignment reaction force is applied by the front surface and the bottom surface to the object manipulator to urge displacement of the object manipulator, with effect that an alignment relationship-obtaining displacement of the coupled end effector, relative to the configuration-defined connection counterpart, is effectuated by the alignment reaction force, wherein the alignment relationship-obtaining displacement is guided by the guide, wherein the guided displacement is effective for emplacing the vehicle-defined connection counterpart in alignment with the configuration-defined connection counterpart, such that the vehicle-defined connection counterpart and the configuration-defined connection counterpart become disposed in an alignment relationship for establishing connection between the vehicle-defined connection counterpart and the configuration-defined connection counterpart.

In another aspect, there is provided a vehicle, comprising: a vehicle-defined connection counterpart; and an object manipulator, comprising: an end effector releasably coupled with the vehicle-defined connection counterpart, such that a coupled end effector is established; a pivotable platform; and a curved track, wherein the coupled end effector and the curved track are co-operatively configured such that displacement of the coupled end effector is guided by the curved track along a curvilinear path defined by the curved track; wherein: the vehicle-defined connection counterpart is configured for connection to a configuration-defined connection counterpart of a counterpart-disposed configuration; the vehicle is configured to co-operate with the counterpart-disposed configuration such that: while: (i) the coupled end effector is established, (ii) the vehicle-defined connection counterpart and the configuration-defined connection counterpart are co-operatively disposed in a misaligned relationship, wherein, in the misaligned relationship, there is an absence of alignment between the vehicle-defined connection counterpart and the configuration-defined connection counterpart, and (iii) the object manipulator is disposed in a guiding-effective relationship with the counterpart-disposed configuration, wherein, in the guiding-effective relationship, contact engagement between the pivotable platform and the counterpart-disposed configuration is effectible, and contact engagement between the coupled end effector and the counterpart-disposed configuration is effectible: the pivotable platform is configured to co-operate with the counterpart-disposed configuration such that, while the pivotable platform is disposed in contact engagement with the counterpart-disposed configuration, in response to a platform-displacement force applied to the pivotable platform to urge displacement of the pivotable platform towards the counterpart-disposed configuration, a platform-urging reaction force is applied by the counterpart-disposed configuration to the pivotable platform to urge pivoting of the object manipulator, with effect that a pivoting of the coupled end effector, relative to the configuration-defined connection counterpart, is effectuated by the platform-urging reaction force, wherein the pivoting is effective for emplacing the vehicle-defined connection counterpart in angular alignment with the configuration-defined connection counterpart about a pitch axis; the curved track and the end effector are configured to co-operate with the counterpart-disposed configuration such that, while the coupled end effector is disposed in contact engagement with the counterpart-disposed configuration, in response to an end effector-displacement force applied to the end effector to urge displacement of the end effector towards the counterpart-disposed configuration, an end effector-urging reaction force is applied by the counterpart-disposed configuration to the end effector to urge displacement of the end effector, with effect that a curvilinear displacement of the coupled end effector, relative to the configuration-defined connection counterpart, is effectuated by the end effector-urging reaction force, wherein the curvilinear displacement is guided by the curved track along the curved path, wherein the curvilinear displacement is effective for emplacing the vehicle-defined connection counterpart in angular alignment with the configuration-defined connection counterpart about a yaw axis; wherein the pivoting and curvilinear displacement of the coupled end effector are for emplacing the vehicle-defined connection counterpart in alignment with the configuration-defined connection counterpart, such that the vehicle-defined connection counterpart and the configuration-defined connection counterpart become disposed in an alignment relationship for establishing connection between the vehicle-defined connection counterpart and the configuration-defined connection counterpart.

In another aspect, there is provided a kit for modifying a vehicle and a counterpart-absent configuration, the kit comprising: vehicle adaptor components including: a vehicle-defined connection counterpart; and an object manipulator, comprising: an end effector configured for being releasably coupled with the vehicle-defined connection counterpart, such that a coupled end effector is established; and a pivotable platform; and a curved track, wherein the coupled end effector and the curved track are co-operatively configured such that displacement of the coupled end effector is guided by the curved track along a curvilinear path defined by the curved track; configuration adaptor components including: a configuration-defined connection counterpart; and wherein: while: (i) the vehicle adaptor components are installed within a vehicle, with effect that a modified vehicle is established, such that the modified vehicle includes the vehicle-defined connection counterpart and the object manipulator, and (ii) the configuration adaptor components are installed within the counterpart-absent configuration with effect that a modified configuration is established, such that the modified configuration includes the configuration-defined connection counterpart: the vehicle-defined connection counterpart is configured for connection to the configuration-defined connection counterpart; and the modified vehicle and the modified configuration are co-operatively configured such that: while: (i) the coupled end effector is established, (ii) the vehicle-defined connection counterpart and the configuration-defined connection counterpart are co-operatively disposed in a misaligned relationship, wherein, in the misaligned relationship, there is an absence of alignment between the vehicle-defined connection counterpart and the configuration-defined connection counterpart, and (iii) the object manipulator is disposed in a guiding-effective relationship with the modified configuration, wherein, in the guiding-effective relationship, contact engagement between the pivotable platform and the modified configuration is effectible, and contact engagement between the coupled end effector and the modified configuration is effectible: the pivotable platform is configured to co-operate with the modified configuration such that, while the pivotable platform is disposed in contact engagement with the modified configuration, in response to a platform-displacement force applied to the pivotable platform to urge displacement of the pivotable platform towards the modified configuration, a platform-urging reaction force is applied by the counterpart-disposed configuration to the pivotable platform to urge pivoting of the object manipulator, with effect that a pivoting of the coupled end effector, relative to the configuration-defined connection counterpart, is effectuated by the platform-urging reaction force, wherein the pivoting is effective for emplacing the vehicle-defined connection counterpart in angular alignment with the configuration-defined connection counterpart about a pitch axis; the curved track and the end effector are configured to co-operate with the modified configuration such that, while the coupled end effector is disposed in contact engagement with the modified configuration, in response to an end effector-displacement force applied to the end effector to urge displacement of the end effector towards the modified configuration, an end effector-urging reaction force is applied by the modified configuration to the end effector to urge displacement of the end effector, with effect that a curvilinear displacement of the coupled end effector, relative to the configuration-defined connection counterpart, is effectuated by the end effector-urging reaction force, wherein the curvilinear displacement is guided by the curved track along the curved path, wherein the curvilinear displacement is effective for emplacing the vehicle-defined connection counterpart in angular alignment with the configuration-defined connection counterpart about a yaw axis; wherein the pivoting and curvilinear displacement of the coupled end effector are for emplacing the vehicle-defined connection counterpart in alignment with the configuration-defined connection counterpart, such that the vehicle-defined connection counterpart and the configuration-defined connection counterpart become disposed in an alignment relationship for establishing connection between the vehicle-defined connection counterpart and the configuration-defined connection counterpart.

In another aspect, there is provided a system, comprising: a vehicle, comprising: a vehicle-defined connection counterpart; an object manipulator, comprising: an end effector configured to be releasably coupled with the vehicle-defined connection counterpart, such that a coupled end effector is established; a pivotable platform; and a curved track, wherein the coupled end effector and the curved track are co-operatively configured such that displacement of the coupled end effector is guided by the curved track along a curvilinear path defined by the curved track; a counterpart-disposed configuration, comprising: configuration-defined connection counterpart; wherein: the vehicle-defined connection counterpart and the configuration-defined connection counterpart are co-operatively configured for connection; the vehicle and the counterpart-disposed configuration are co-operatively configured such that: while: (i) the coupled end effector is established, (ii) the vehicle-defined connection counterpart and the configuration-defined connection counterpart are co-operatively disposed in a misaligned relationship, wherein, in the misaligned relationship, there is an absence of alignment between the vehicle-defined connection counterpart and the configuration-defined connection counterpart, and (iii) the object manipulator is disposed in a guiding-effective relationship with the counterpart-disposed configuration, wherein, in the guiding-effective relationship, contact engagement between the pivotable platform and the counterpart-disposed configuration is effectible, and contact engagement between the coupled end effector and the counterpart-disposed configuration is effectible: the pivotable platform is configured to co-operate with the counterpart-disposed configuration such that, while the pivotable platform is disposed in contact engagement with the counterpart-disposed configuration, in response to a platform-displacement force applied to the pivotable platform to urge displacement of the pivotable platform towards the counterpart-disposed configuration, a platform-urging reaction force is applied by the counterpart-disposed configuration to the pivotable platform to urge pivoting of the object manipulator, with effect that a pivoting of the coupled end effector, relative to the configuration-defined connection counterpart, is effectuated by the platform-urging reaction force, wherein the pivoting is effective for emplacing the vehicle-defined connection counterpart in angular alignment with the configuration-defined connection counterpart about a pitch axis; the curved track and the end effector are configured to co-operate with the counterpart-disposed configuration such that, while the coupled end effector is disposed in contact engagement with the counterpart-disposed configuration, in response to an end effector-displacement force applied to the end effector to urge displacement of the end effector towards the counterpart-disposed configuration, an end effector-urging reaction force is applied by the counterpart-disposed configuration to the end effector to urge displacement of the end effector, with effect that a curvilinear displacement of the coupled end effector, relative to the configuration-defined connection counterpart, is effectuated by the end effector-urging reaction force, wherein the curvilinear displacement is guided by the curved track along the curved path, wherein the curvilinear displacement is effective for emplacing the vehicle-defined connection counterpart in angular alignment with the configuration-defined connection counterpart about a yaw axis; wherein the pivoting and curvilinear displacement of the coupled end effector are for emplacing the vehicle-defined connection counterpart in alignment with the configuration-defined connection counterpart, such that the vehicle-defined connection counterpart and the configuration-defined connection counterpart become disposed in an alignment relationship for establishing connection between the vehicle-defined connection counterpart and the configuration-defined connection counterpart.

In another aspect, there is provided a counterpart-disposed configuration, comprising: a configuration-defined connection counterpart; wherein: the configuration-defined connection counterpart is configured for connection to a vehicle-defined connection counterpart of a vehicle, the vehicle comprising: an object manipulator, comprising: an end effector releasably coupled with the vehicle-defined connection counterpart, such that a coupled end effector is established; a pivotable platform; and a curved track, wherein the coupled end effector and the curved track are co-operatively configured such that displacement of the coupled end effector is guided by the curved track along a curvilinear path defined by the curved track; the counterpart-disposed configuration is configured to co-operate with the vehicle such that: while: (i) the coupled end effector is established, (ii) the vehicle-defined connection counterpart and the configuration-defined connection counterpart are co-operatively disposed in a misaligned relationship, wherein, in the misaligned relationship, there is an absence of alignment between the vehicle-defined connection counterpart and the configuration-defined connection counterpart, and (iii) the object manipulator is disposed in a guiding-effective relationship with the counterpart-disposed configuration, wherein, in the guiding-effective relationship, contact engagement between the pivotable platform and the counterpart-disposed configuration is effectible, and contact engagement between the coupled end effector and the counterpart-disposed configuration is effectible: the pivotable platform is configured to co-operate with the counterpart-disposed configuration such that, while the pivotable platform is disposed in contact engagement with the counterpart-disposed configuration, in response to a platform-displacement force applied to the pivotable platform to urge displacement of the pivotable platform towards the counterpart-disposed configuration, a platform-urging reaction force is applied by the counterpart-disposed configuration to the pivotable platform to urge pivoting of the object manipulator, with effect that a pivoting of the coupled end effector, relative to the configuration-defined connection counterpart, is effectuated by the platform-urging reaction force, wherein the pivoting is effective for emplacing the vehicle-defined connection counterpart in angular alignment with the configuration-defined connection counterpart about a pitch axis; the curved track and the end effector are configured to co-operate with the counterpart-disposed configuration such that, while the coupled end effector is disposed in contact engagement with the counterpart-disposed configuration, in response to an end effector-displacement force applied to the end effector to urge displacement of the end effector towards the counterpart-disposed configuration, an end effector-urging reaction force is applied by the counterpart-disposed configuration to the end effector to urge displacement of the end effector, with effect that a curvilinear displacement of the coupled end effector, relative to the configuration-defined connection counterpart, is effectuated by the end effector-urging reaction force, wherein the curvilinear displacement is guided by the curved track along the curved path, wherein the curvilinear displacement is effective for emplacing the vehicle-defined connection counterpart in angular alignment with the configuration-defined connection counterpart about a yaw axis; wherein the pivoting and curvilinear displacement of the coupled end effector are for emplacing the vehicle-defined connection counterpart in alignment with the configuration-defined connection counterpart, such that the vehicle-defined connection counterpart and the configuration-defined connection counterpart become disposed in an alignment relationship for establishing connection between the vehicle-defined connection counterpart and the configuration-defined connection counterpart.

In another aspect, there is provided a vehicle, comprising: a vehicle-defined connection counterpart; and an object manipulator, mounted to a frame of the vehicle, the object manipulator being releasably coupled to the vehicle defined-connection counterpart such that a coupled object manipulator is established, wherein the coupled object manipulator is configurable in a coupled object manipulator retracted configuration and a coupled object manipulator alignment-effective configuration; wherein: the vehicle-defined connection counterpart is configured for connection to a configuration-defined connection counterpart of a counterpart-disposed configuration; the vehicle is configured to co-operate with the counterpart-disposed configuration such that: while the coupled object manipulator is disposed in the coupled object manipulator retracted configuration, the vehicle-defined connection counterpart and the configuration-defined connection counterpart are co-operatively disposed in a misaligned relationship, wherein, in the misaligned relationship, there is an absence of alignment between the vehicle-defined connection counterpart and the configuration-defined connection counterpart; while the coupled object manipulator is disposed in the coupled object manipulator alignment-effective configuration, the vehicle-defined connection counterpart and the configuration-defined connection counterpart are co-operatively disposed in an aligned relationship, wherein, in the aligned relationship, the vehicle-defined connection counterpart is disposed in alignment with the configuration-defined connection counterpart, for establishing connection between the vehicle-defined connection counterpart and the configuration-defined connection counterpart; while the coupled object manipulator is disposed in the coupled object manipulator retracted configuration, the coupled object manipulator is nested within the frame of the vehicle and below a swing radius of the counterpart-disposed configuration; and while the coupled object manipulator is disposed in the coupled object manipulator alignment-effective configuration, the coupled object manipulator is elevated relative to its disposition in the coupled object manipulator retracted configuration.

In another aspect, there is provided a trailer comprising: a trailer-defined connection counterpart; wherein: the trailer-defined connection counterpart is configured for connection to a towing vehicle-defined connection counterpart of a towing vehicle, with effect that communication between the towing vehicle and the trailer is established; and the trailer-defined connection counterpart is disposed within a subfloor of the trailer.

In another aspect, there is provided a vehicle, comprising: a vehicle-defined connection counterpart; an energy storage device; and a vehicle-defined communicator that is disposed in communication with the energy storage device, configured for connection with the vehicle-defined connection counterpart, such that a communicating counterpart is established, with effect that communication is established between the vehicle-defined connection counterpart and the energy storage device; wherein: the vehicle is configured to co-operate with a counterpart-present configuration, wherein the counterpart-present configuration comprises: a configuration-defined connection counterpart; a counterpart-present configuration system that is disposed in communication with the configuration-defined connection counterpart; the co-operation of the vehicle and the counterpart-present configuration is such that: while: (i) the communicating counterpart is established, and (ii) the vehicle-defined connection counterpart is connected to the configuration-defined connection counterpart, communication between the energy storage device and the counterpart-present configuration system is established; the vehicle is further configured to co-operate with a counterpart-absent configuration, wherein the configuration-defined connection counterpart is absent from the counterpart-absent configuration, the counterpart-absent configuration further comprising: a counterpart-absent configuration system; and a counterpart-absent configuration-defined connector that is disposed in communication with the counterpart-absent configuration system; the co-operation of the vehicle and the counterpart-absent configuration is such that: while there is an absence of connection between the vehicle-defined communicator and the vehicle-defined connection counterpart, the vehicle-defined communicator is connectible with the counterpart-absent configuration-defined connector, with effect that communication between the energy storage device and the counterpart-absent configuration system is established.

In another aspect, there is provided a system, comprising: a vehicle, comprising: a vehicle-defined connection counterpart; an energy storage device; and a vehicle-defined communicator that is disposed in communication with the energy storage device, configured for connection with the vehicle-defined connection counterpart, such that a communicating counterpart is established, with effect that communication is established between the vehicle-defined connection counterpart and the energy storage device; a counterpart-present configuration, comprising: a configuration-defined connection counterpart; a counterpart-present configuration system that is disposed in communication with the configuration-defined connection counterpart; a counterpart-absent configuration, wherein the configuration-defined connection counterpart is absent from the counterpart-absent configuration, the counterpart-absent configuration further comprising: a counterpart-absent configuration system; and a counterpart-absent configuration-defined connector that is disposed in communication with the counterpart-absent configuration system; wherein: the vehicle and the counterpart-present configuration are co-operatively configured, such that: while: (i) the communicating counterpart is established, and (ii) the vehicle-defined connection counterpart is connected to the configuration-defined connection counterpart, communication between the energy storage device and the counterpart-present configuration system is established; the vehicle and the counterpart-absent configuration are co-operatively configured, such that: while there is an absence of connection between the vehicle-defined communicator and the vehicle-defined connection counterpart, the vehicle-defined communicator is connectible with the counterpart-absent configuration-defined connector, with effect that communication between the energy storage device and the counterpart-absent configuration system is established.

In another aspect, there is provided a kit for modifying a vehicle, the vehicle comprising an energy storage device, comprising: vehicle adapter components, comprising: a vehicle-defined connection counterpart; and a vehicle-defined communicator configured to be disposed in communication with the energy storage device, and configured to be disposed for connection with the vehicle-defined connection counterpart, such that a communicating counterpart is established, with effect that communication is established between the vehicle-defined connection counterpart and the energy storage device; wherein: while the vehicle adaptor components are installed within a vehicle, with effect that a modified vehicle is established, such that the modified vehicle includes the vehicle-defined connection counterpart and the object manipulator: the modified vehicle is configured to co-operate with a counterpart-present configuration, wherein the counterpart-present configuration comprises: a configuration-defined connection counterpart; and a counterpart-present configuration system that is disposed in communication with the configuration-defined connection counterpart; the co-operation of the modified vehicle and the counterpart-present configuration is such that: while: (i) the communicating counterpart is established, and (ii) the vehicle-defined connection counterpart is connected to the configuration-defined connection counterpart, communication between the energy storage device and the counterpart-present configuration system is established; the modified vehicle is further configured to co-operate with a counterpart-absent configuration, wherein the configuration-defined connection counterpart is absent from the counterpart-absent configuration, the counterpart-absent configuration further comprising: a counterpart-absent configuration system; and a counterpart-absent configuration-defined connector that is disposed in communication with the counterpart-absent configuration system; the co-operation of the modified vehicle and the counterpart-absent configuration is such that: while there is an absence of connection between the vehicle-defined communicator and the vehicle-defined connection counterpart, the vehicle-defined communicator is connectible with the counterpart-absent configuration-defined connector, with effect that communication between the energy storage device and the counterpart-absent configuration system is established.

Other aspects will be apparent from the description and drawings provided herein.

### BRIEF DESCRIPTION OF DRAWINGS

In the figures, which illustrate example embodiments,

FIG. 1 is a perspective view of an example embodiment of an object manipulator of a connection apparatus, mounted to a vehicle that is connected to a counterpart-disposed configuration, the vehicle being a towing vehicle and the counterpart-disposed configuration being a trailer;

FIG. 2 is a perspective view of a first adapter counterpart and a second adapter counterpart disposed in an operable communication-effectible alignment;

FIG. 2A is a schematic of the first adapter counterpart and the second adapter counterpart of FIG. 2, wherein there is an absence of connection between the first and second adapter counterparts;

FIG. 2B is a schematic of the first adapter counterpart and the second adapter counterpart of FIG. 2, wherein the first and second adapter counterparts are connected;

FIG. 3 is a block diagram of an example embodiment of a connection apparatus;

FIG. 4 is a perspective view of the object manipulator of FIG. 1, mounted to a towing vehicle that is connected to a trailer, wherein the towing vehicle and trailer are misaligned, and the object manipulator is disposed in a manipulator retracted configuration;

FIG. 5 is a schematic of the bottom of the trailer of FIG. 4;

FIG. 6 is a perspective view of the object manipulator of FIG. 4, the object manipulator is disposed in a manipulator extended configuration;

FIG. 7A is a schematic of the first adapter counterpart and the second adapter counterpart, while the object manipulator is disposed in the manipulator retracted configuration;

FIG. 7B is a schematic of the first adapter counterpart and the second adapter counterpart, while the object manipulator is disposed in the manipulator extended configuration;

FIG. 8 is a perspective view of the object manipulator of FIG. 6, wherein an end effector alignment effector of the object manipulator is disposed in an alignment effector extended configuration;

FIG. 9 is a perspective view of the object manipulator of FIG. 8, wherein an end effector of the end effector alignment effector is disposed in an end effector alignment-ready configuration;

FIG. 10 is a perspective view of the object manipulator of FIG. 9, wherein the end effector of the end effector alignment effector is disposed in an end effector alignment-effective configuration;

FIG. 11 is a schematic of the end effector disposed in the end effector alignment-ready configuration and disposed in the end effector alignment-effective configuration;

FIG. 12 is a perspective view of the object manipulator of FIG. 10, wherein a coupler of the end effector is disposed in a coupler extended configuration;

FIG. 13 is a perspective view of the object manipulator of FIG. 12, wherein the first adapter counterpart and the second adapter counterpart are disposed in operable communication, and the coupler of the end effector is disposed in a coupler retracted configuration;

FIG. 14 is a perspective view of the object manipulator of FIG. 13, wherein the end effector is disposed in the end effector alignment-ready configuration;

FIG. 15 is a perspective view of the object manipulator of FIG. 14, wherein the end effector is disposed in the end effector retracted configuration;

FIG. 16 is a perspective view of the object manipulator of FIG. 15, wherein the end effector alignment effector is disposed in the alignment effector retracted configuration;

FIG. 17 is a perspective view of the object manipulator of FIG. 16, wherein the object manipulator is disposed in the manipulator retracted configuration;

FIG. 18 is a cross-sectional view of the object manipulator, towing vehicle, and trailer, of FIG. 17, taken along line 18-18 of FIG. 17;

FIG. 19 is a perspective view of the object manipulator of FIG. 1;

FIG. 20 is a perspective view of the end effector alignment effector of the object manipulator of FIG. 1;

FIG. 21 is a perspective view of an end effector supporter of the end effector alignment effector of the object manipulator of FIG. 1;

FIG. 22 is a perspective view of an end effector of the end effector alignment effector of the object manipulator of FIG. 1, wherein the end effector is disposed in the end effector retracted configuration;

FIG. 23 is a perspective view of the end effector of the object manipulator of FIG. 1, wherein the end effector is disposed in the end effector alignment-ready configuration;

FIG. 24 is a top elevation view of a mounting plate of an end effector supported by an end effector supporter of an alternate embodiment of the end effector alignment effector of FIG. 20, wherein the mounting plate is disposed at the center of the curved guide;

FIG. 25 is a top elevation view of the mounting plate of the end effector and the end effector supporter of FIG. 24, wherein the mounting plate is disposed to the left of the center of the curved guide;

FIG. 26 is a top elevation view of the mounting plate of the end effector and the end effector supporter of FIG. 24, wherein the mounting plate is disposed to the right of the center of the curved guide;

FIG. 27 is a perspective view of the end effector supporter of the end effector alignment effector of FIG. 24;

FIG. 28 is a perspective view of the displacement guiding configuration of the end effector supporter of FIG. 27;

FIG. 29 is a top elevation view of the displacement guiding configuration of FIG. 28;

FIG. 30 is a bottom perspective view of the mounting plate of the end effector of the end effector alignment effector of FIG. 24;

FIG. 31 is a perspective view of the mounting plate of the end effector supported on the curved guide of the end effector supporter of FIG. 24;

FIG. 32 is a top elevation view of a portion of the mounting plate of the end effector and the curved guide of the end effector supporter of FIG. 24;

FIG. 33 is a top elevation view of the mounting plate of the end effector and the curved guide of the end effector supporter of FIG. 24;

FIG. 34 is a perspective view of the object manipulator of FIG. 1, without the coupler supporter and mounting plate, mounted on the towing vehicle;

FIG. 35 is a top elevation view of the object manipulator of FIG. 1, without the coupler supporter and mounting plate, mounted on the towing vehicle.

FIG. 36 is a top elevation view of a towing vehicle connected to a trailer, with the object manipulator of FIG. 1 mounted to the towing vehicle;

FIG. 37 is a perspective view of an example embodiment of the counterpart-disposed configuration, the counterpart-disposed configuration being a charging dock;

FIG. 38 is a perspective view of the charging dock of FIG. 37 coupled to the vehicle of FIG. 1, wherein there is an absence of connection between the first adapter counterpart and the second adapter counterpart, and the object manipulator is disposed in the manipulator retracted configuration;

FIG. 39 is a perspective view of the charging dock and vehicle of FIG. 38, wherein the first adapter counterpart and the second adapter counterpart are connected, and the object manipulator is disposed in the manipulator retracted configuration.

### DETAILED DESCRIPTION

Disclosed herein is an apparatus 100 configured to effectuate an automated connection between a vehicle 13 and a counterpart-disposed configuration 12, wherein the vehicle 13 includes a vehicle-defined connection counterpart 302, and the counterpart-disposed configuration 12 includes a configuration-defined connection counterpart 350. In some embodiments, for example, the vehicle 13 is a towing vehicle, a car, a van, a truck, and the like. In some embodiments, for example, the counterpart-disposed configuration 12 is a trailer 12. In some embodiments, for example, the counterpart-disposed configuration 12 is a charging dock or docking station 12. The establishing of the connection between the vehicle-defined connection counterpart 302 and the configuration-defined connection counterpart 350 is with effect that communication between the vehicle 13 and the counterpart-disposed configuration 12 is established. In some embodiments, for example, the establishment of the communication between the vehicle 13 and the counterpart-disposed configuration 12 is for actuating an operation of the counterpart-disposed configuration 12, and for controlling said actuation of the operation of the counterpart-disposed configuration 12. In some embodiments, for example, the establishment of the communication between the vehicle 13 and the counterpart-disposed configuration 12 is for replenishing an energy storage device of the vehicle 13 via an energy source of the counterpart-disposed configuration 12.

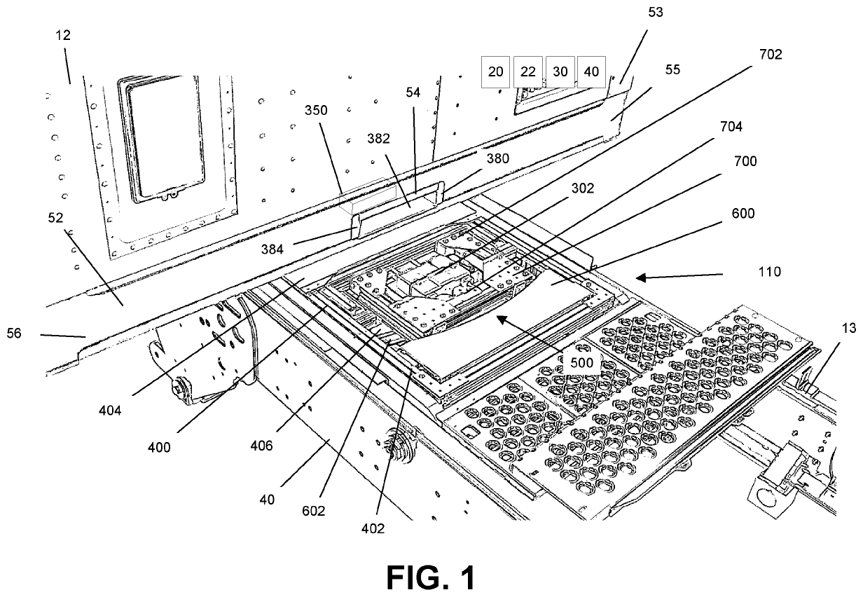

FIG. 1 depicts a towing vehicle 13 that is coupled to a trailer 12. The towing vehicle 13 is configured to tow the trailer 12. In some embodiments, for example, the towing vehicle 13 is a tractor, a yard shifter, or a converter dolly. In some embodiments, for example, the towing vehicle 13 is an autonomous vehicle, such as an autonomous tractor, yard shifter, or converter dolly. In some embodiments, for example, the towing vehicle 13 includes a fifth wheel coupling 15, configured for receiving, for example, slidably receiving, and coupling with a corresponding fifth wheel guiding counterpart or locking pin, or kingpin 14 that extends from a bottom surface 50 of the trailer 12, the bottom surface 50 defined, in some embodiments, for example, by a base plate 51 of the trailer 12, which is received within a corresponding slot formed in the coupling plate of the fifth wheel coupling 15, the trailer 12 resting and pivoting on the coupling plate about the kingpin 14, such that a fifth wheel coupling relationship is established. While a fifth wheel coupling has been described in connection with the coupling of the trailer 12 to the towing vehicle 13, it will be understood that various other couplings may be used provided the coupling between the towing vehicle 13 and the trailer 12 is such that the trailer 12 displaces with the towing vehicle 13 while the towing vehicle 13 is in motion and can pivot relative to the towing vehicle 13 via the coupling for maneuverability. In some embodiments, for example, while the towing vehicle 13 and the trailer 12 are coupled, for example, via the co-operative configuration of the kingpin 14 and the fifth wheel 15, the towing vehicle 13 and the trailer 12 become disposed in an interaction-effective configuration, such that respective adapter counterparts 302 and 350 of the towing vehicle 13 and the trailer 12 are disposable in an alignment relationship for connection, for example, via a connection apparatus 100, as described in greater detail herein. In some embodiments, for example, while the towing vehicle 13 and the trailer 12 are decoupled, the towing vehicle 13 and the trailer 12 become disposed in an interaction-ineffective configuration, such that respective adapter counterparts 302 and 350 of the towing vehicle 13 and the trailer 12 are not connectible via the connection apparatus 100.

In some embodiments, for example, operable connections, for example, fluid, electrical, and data connections are established between the towing vehicle 13 and the trailer 12 for actuating a vehicular operation to operate a towing vehicle 13 to tow a trailer 12. The fluid connection is established to supply fluid energy, for example, pneumatic gas, from a fluid energy source or fluid energy storage device (e.g. pneumatic gas tank or reservoir) of the towing vehicle 13 to the fluid system of the trailer 12, which includes actuatable systems, for example, pneumatic gas systems such as the service and parking brakes of the trailer 12. In some embodiments, for example, the electrical connection is established to supply electrical energy from an electrical energy source or electrical energy storage device of the towing vehicle 13 to the electrical system of the trailer 12, which includes actuatable systems, for example, the ABS brakes and turn signals of the trailer 12. In some embodiments, for example, the data connection is established between the towing vehicle 13 and the trailer 12 to establish data communication between the data communication devices of the towing vehicle 13 and the data communication devices of the trailer 12, for controlling the actuation of the pneumatic gas system and electrical system of the trailer 12.

In some embodiments, for example, operable connections, for example, fluid, electrical, and data connections are established between the towing vehicle 13 and the trailer 12 for replenishing an energy storage device, energy source, or energy reservoir (e.g. battery, fuel tank, pneumatic gas tank, hydrogen fuel cell, natural gas tank, etc.) of the towing vehicle 13 by an energy storage device, energy source, or energy reservoir (e.g. source of electrical energy, solar panel, generator, fuel such as diesel, pneumatic gas, hydrogen, natural gas, etc.) of the trailer 12. The fluid connection is established to supply fluid energy, such as pneumatic gas or fuel, from a fluid energy source of the fluid system of the trailer 12 (e.g. pneumatic gas tank or reservoir, fuel tank or reservoir) to the fluid energy storage device of the towing vehicle 13 (e.g. pneumatic gas tank or fuel tank). In some embodiments, for example, the electrical connection is established to supply electrical energy from an electrical energy source of the electrical system of the trailer 12 (e.g. battery, generator, solar panel) to the electrical energy storage device of the towing vehicle 13 (e.g. battery). In some embodiments, for example, the data connection is established, for example, via a set of data connectors, to establish data communication between the data communication devices of the towing vehicle 13 and the data communication devices of the trailer 12, for controlling the replenishing of the energy storage device of the towing vehicle 13 by the energy source of the trailer 12.

In some embodiments, for example, connection or operable communication (e.g. electrical communication, fluid communication or fluid pressure communication or flow communication, data communication, etc.) is established between the towing vehicle 13 and the trailer 12 via connection of the first and second adapter counterparts 302 and 350, such that the fluid system and electrical system of the trailer 12 are actuatable and controllable, for example, by an operator of the towing vehicle 13.

In some embodiments, for example, connection or operable communication (e.g. electrical communication, fluid communication or fluid pressure communication or flow communication, data communication, etc.) is established between the towing vehicle 13 and the trailer 12 via connection of the first and second adapter counterparts 302 and 350, such that energy is transferrable from the energy source of the trailer 12 to the energy storage device of the towing vehicle 13, to replenish the energy storage device.

In some embodiments, for example, connection or operable communication (e.g. electrical communication, fluid communication or fluid pressure communication or flow communication, data communication, etc.) is established between the towing vehicle 13 and the trailer 12 via connection of the first and second adapter counterparts 302 and 350, such that energy and data are transferrable between the trailer 12 and the towing vehicle 13.

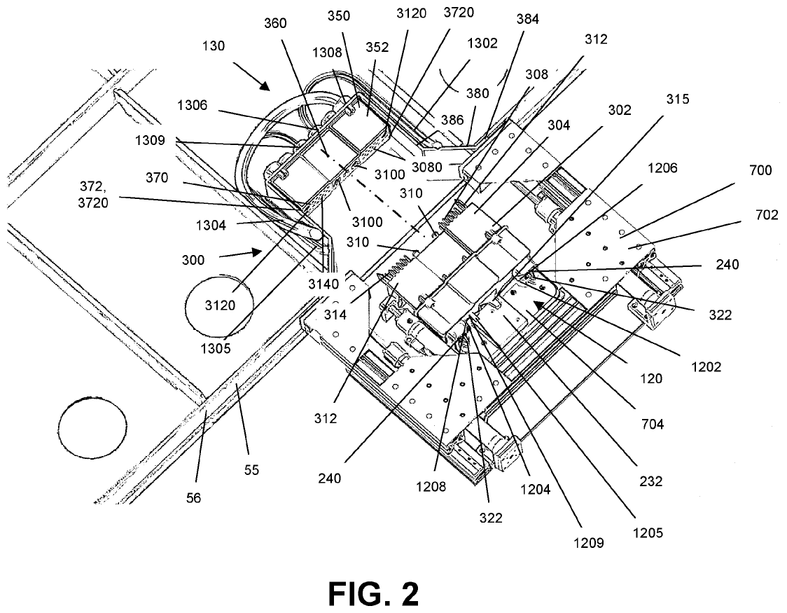

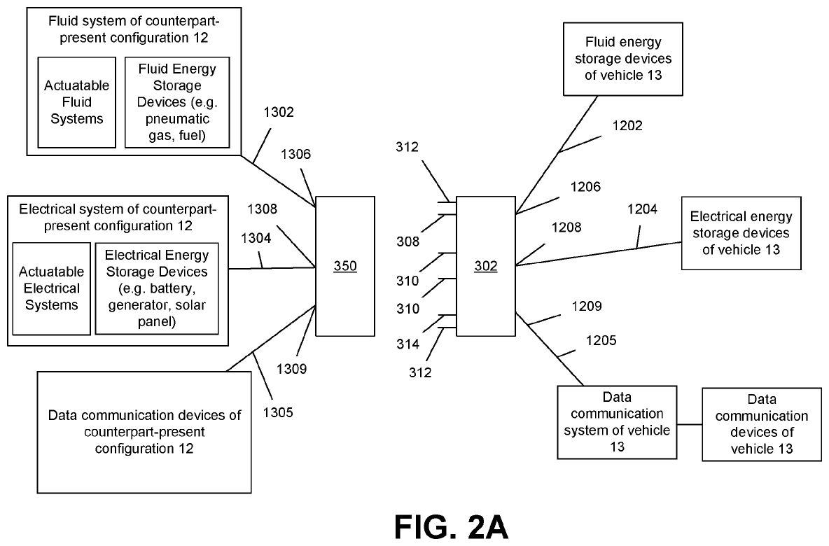

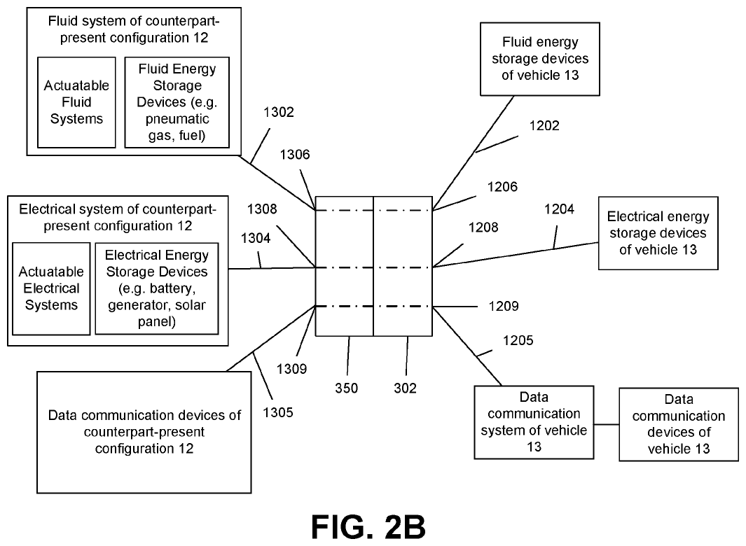

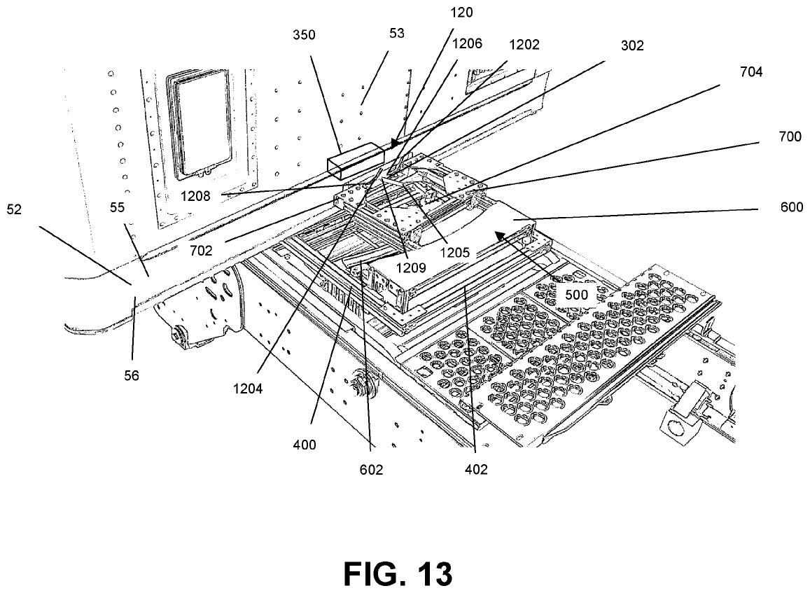

In this respect, in some embodiments, for example, as depicted in FIG. 2 and FIG. 13, the towing vehicle 13 includes a vehicle-defined communicator, towing vehicle-defined communicator, configuration communicator, or trailer communicator 120, and the trailer 12 includes a configuration-defined communicator, trailer-defined communicator, vehicle communicator, or towing vehicle communicator 130. In some embodiments, for example, the trailer communicator 120 is compliant with an ISO 13044-2 standard. In some embodiments, for example, the trailer communicator 120 includes one or more flexible cables. In some embodiments, for example, the towing vehicle communicator 130 is compliant with an ISO 13044-2 standard. In some embodiments, for example, the towing vehicle communicator 130 includes one or more flexible cables.

In some embodiments, for example, the trailer communicator 120 includes a configuration communicator-defined connector counterpart or trailer communicator-defined connector counterpart, and the towing vehicle communicator 130 includes a vehicle communicator-defined connector counterpart or towing vehicle communicator-defined connector counterpart. In some embodiments, for example, the trailer communicator-defined connector counterpart and the towing vehicle communicator-defined connector counterpart are co-operatively configured to effect the coupling of the trailer communicator 120 and the towing vehicle communicator 130 such that the trailer communicator 120 becomes disposed in the coupled relationship with the towing vehicle communicator 130. In some embodiments, for example, the trailer communicator-defined connector counterpart and the towing vehicle communicator-defined connector counterpart are co-operatively configured to effect the coupling of the trailer communicator 120 and the towing vehicle communicator 130 such that the trailer communicator 120 becomes disposed in operable communication, for example, fluid communication (for example, fluid pressure communication or flow communication), electrical communication, and data communication, with the towing vehicle communicator 130.

In some embodiments, for example, the trailer communicator 120 includes a vehicle defined fluid communication counterpart, towing vehicle defined fluid communication counterpart, or trailer communicator-defined fluid communication counterpart 1206, and the towing vehicle communicator 130 includes a configuration-defined fluid communication counterpart, trailer-defined fluid communication counterpart, or towing vehicle communicator-defined fluid communication counterpart 1306. In some embodiments, for example, the trailer communicator-defined fluid communication counterpart 1206 and the towing vehicle communicator-defined fluid communication counterpart 1306 are co-operatively configured to effect fluid communication between the trailer communicator 120 and the towing vehicle communicator 130 such that while the trailer communicator-defined fluid communication counterpart 1206 and the towing vehicle communicator-defined fluid communication counterpart 1306 are disposed in fluid communication, the trailer communicator 120 and the towing vehicle communicator 130 are disposed in fluid communication.

In some embodiments, for example, the trailer communicator 120 includes a vehicle-defined fluid conductor, towing vehicle-defined fluid conductor, or trailer communicator-defined fluid conductor 1202 that is disposed in fluid communication with the trailer communicator-defined fluid communication counterpart 1206, and the towing vehicle communicator 130 includes a configuration-defined fluid conductor, trailer-defined fluid conductor, or towing vehicle communicator-defined fluid conductor 1302 that is disposed in fluid communication with the towing vehicle communicator-defined fluid communication counterpart 1306. In some embodiments, for example, the trailer communicator-defined fluid communication counterpart 1206, the towing vehicle communicator-defined fluid communication counterpart 1306, the trailer communicator-defined fluid conductor 1202, and the towing vehicle communicator-defined fluid conductor 1302 are co operatively configured such that while the trailer communicator-defined fluid communication counterpart 1206 and the towing vehicle communicator-defined fluid communication counterpart 1306 are disposed in fluid communication, the trailer communicator-defined fluid conductor 1202 and the towing vehicle communicator-defined fluid conductor 1302 are disposed in fluid communication.

In some embodiments, for example, the trailer communicator-defined fluid conductor 1202 and the towing vehicle communicator-defined fluid conductor 1302 include pneumatic gas conductors (e.g. gas hoses), and the trailer communicator-defined fluid communication counterpart 1206 and the towing vehicle communicator-defined fluid communication counterpart 1306 include glad hands. In some embodiments, for example, the pneumatic gas includes pneumatic air, and the pneumatic gas conductors include air hoses. In some embodiments, for example, the trailer communicator-defined fluid conductor 1202 and the towing vehicle communicator-defined fluid conductor 1302 are configured for conducting diesel and the trailer communicator-defined fluid communication counterpart 1206 and the towing vehicle communicator-defined fluid communication counterpart 1306 are configured to connect the trailer communicator-defined fluid conductor 1202 and the towing vehicle communicator-defined fluid conductor 1302 for conducting diesel. In some embodiments, for example, the trailer communicator-defined fluid conductor 1202 and the towing vehicle communicator-defined fluid conductor 1302 are configured for conducting hydrogen, and the trailer communicator-defined fluid communication counterpart 1206 and the towing vehicle communicator-defined fluid communication counterpart 1306 are configured to connect the trailer communicator-defined fluid conductor 1202 and the towing vehicle communicator-defined fluid conductor 1302 for conducting hydrogen. In some embodiments, for example, the trailer communicator-defined fluid conductor 1202 and the towing vehicle communicator-defined fluid conductor 1302 are configured for conducting natural gas, and the trailer communicator-defined fluid communication counterpart 1206 and the towing vehicle communicator-defined fluid communication counterpart 1306 are configured to connect the trailer communicator-defined fluid conductor 1202 and the towing vehicle communicator-defined fluid conductor 1302 for conducting natural gas.

In some embodiments, for example, the trailer communicator 120 includes a vehicle defined electrical communication counterpart, towing vehicle defined electrical communication counterpart, or trailer communicator-defined electrical communication counterpart 1208, and the towing vehicle communicator 130 includes a configuration-defined electrical communication counterpart, trailer-defined electrical communication counterpart, or towing vehicle communicator-defined electrical communication counterpart 1308. In some embodiments, for example, the trailer communicator-defined electrical communication counterpart 1208 and the towing vehicle communicator-defined electrical communication counterpart 1308 are co-operatively configured to effect electrical communication between the trailer communicator 120 and the towing vehicle communicator 130 such that while the trailer communicator-defined electrical communication counterpart 1208 and the towing vehicle communicator-defined electrical communication counterpart 1308 are disposed in electrical communication, the trailer communicator 120 and the towing vehicle communicator 130 are disposed in electrical communication.

In some embodiments, for example, the trailer communicator 120 includes a vehicle-defined electrical conductor, towing vehicle-defined electrical conductor, or trailer communicator-defined electrical conductor 1204 that is disposed in electrical communication with the trailer communicator-defined electrical communication counterpart 1208, and the towing vehicle communicator 130 includes a configuration-defined electrical conductor, trailer-defined electrical conductor, or towing vehicle communicator-defined electrical conductor 1304 that is disposed in electrical communication with the towing vehicle communicator-defined electrical communication counterpart 1308. In some embodiments, for example, the trailer communicator-defined electrical communication counterpart 1208, the towing vehicle communicator-defined electrical communication counterpart 1308, the trailer communicator-defined electrical conductor 1204, and the towing vehicle communicator-defined electrical conductor 1304 are co operatively configured such that while the trailer communicator-defined electrical communication counterpart 1208 and the towing vehicle communicator-defined electrical communication counterpart 1308 are disposed in electrical communication, the trailer communicator-defined electrical conductor 1204 and the towing vehicle communicator-defined electrical conductor 1304 are disposed in electrical communication.

In some embodiments, for example, the trailer communicator-defined electrical conductor 1204 and the towing vehicle communicator-defined electrical conductor 1304 include electrical conductors (e.g. electrical cables), and the trailer communicator-defined electrical communication counterpart 1208 and the towing vehicle communicator-defined electrical communication counterpart 1308 include electrical connectors (e.g. multi-pin electrical connectors, such as 7-pin or 30-pin electrical connectors; fast charge adapter, etc.).

In some embodiments, for example, the trailer communicator 120 includes a vehicle defined data communication counterpart, a towing vehicle defined data communication counterpart, or a trailer communicator-defined data communication counterpart 1209, and the towing vehicle communicator 130 includes a configuration-defined data communication counterpart, trailer defined data communication counterpart, or towing vehicle communicator-defined data communication counterpart 1309. In some embodiments, for example, the trailer communicator-defined data communication counterpart 1209 and the towing vehicle communicator-defined data communication counterpart 1309 are co-operatively configured to effect data communication between the trailer communicator 120 and the towing vehicle communicator 130, such that while the trailer communicator-defined data communication counterpart 1209 and the towing vehicle communicator-defined data communication counterpart 1309 are disposed in data communication, the trailer communicator 120 and the towing vehicle communicator 130 are disposed in data communication.

In some embodiments, for example, the trailer communicator 120 includes a vehicle-defined data conductor, towing vehicle-defined data conductor, or trailer communicator-defined data conductor 1205 that is disposed in data communication with the trailer communicator-defined data communication counterpart 1209, and the towing vehicle communicator 130 includes a configuration-defined data conductor, trailer-defined data conductor, or towing vehicle communicator-defined data conductor 1305 that is disposed in data communication with the towing vehicle communicator-defined data communication counterpart 1309. In some embodiments, for example, the trailer communicator-defined data communication counterpart 1209, the towing vehicle communicator-defined data communication counterpart 1309, the trailer communicator-defined data conductor 1205, and the towing vehicle communicator-defined data conductor 1305 are co operatively configured such that while the trailer communicator-defined data communication counterpart 1209 and the towing vehicle communicator-defined data communication counterpart 1309 are disposed in data communication, the trailer communicator-defined data conductor 1205 and the towing vehicle communicator-defined data conductor 1305 are disposed in data communication.

In some embodiments, for example, the trailer communicator-defined data conductor 1205 and the towing vehicle communicator-defined data conductor 1305 include data conductors (e.g. data cables), and the trailer communicator-defined data communication counterpart 1209 and the towing vehicle communicator-defined data communication counterpart 1309 are data connectors.

In some embodiments, for example, as depicted in FIG. 2 and FIG. 13, the trailer communicator 120 includes the trailer communicator-defined fluid conductor 1202, the trailer communicator-defined electrical conductor 1204, and the trailer communicator-defined data conductor 1205, and the trailer communicator 120 is defined as separate communicators, in particular, the trailer communicator-defined fluid conductor 1202, the trailer communicator-defined electrical conductor 1204, and the trailer communicator-defined data conductor 1205 are separate conductors. In some embodiments, for example, the trailer communicator 120 includes the trailer communicator-defined fluid conductor 1202 the trailer communicator-defined electrical conductor 1204, and the trailer communicator-defined data conductor 1205, and the trailer communicator 120 is defined as a single communicator, for example, as a single cable, wherein the trailer communicator-defined fluid conductor 1202, the trailer communicator-defined electrical conductor 1204, and the and the trailer communicator-defined data conductor 1205 are disposed in the communicator.

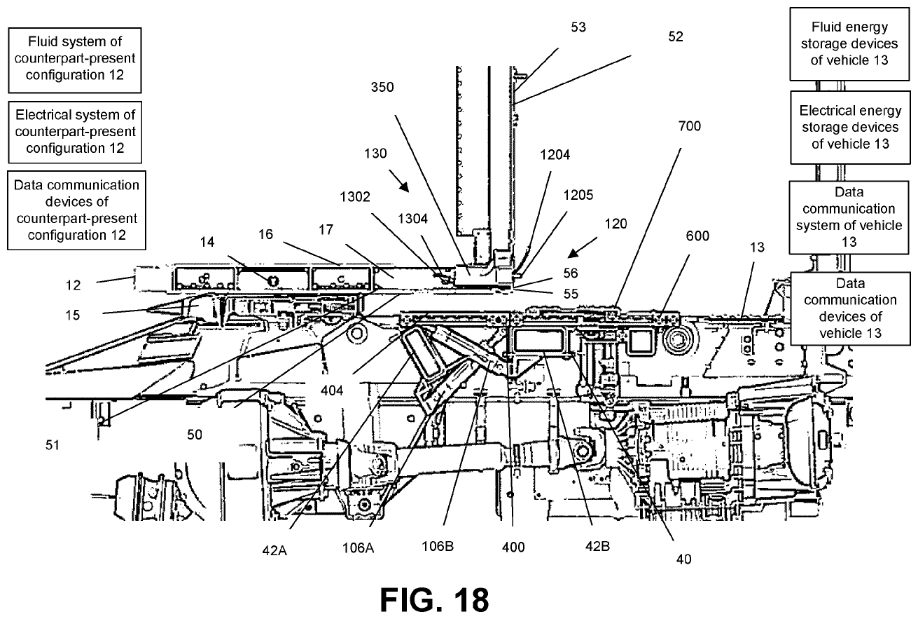

In some embodiments, for example, as depicted in FIG. 2A, FIG. 2B, and FIG. 18, the trailer communicator-defined fluid conductor 1202 is disposed in fluid communication with a fluid energy storage device (e.g. diesel, natural gas, hydrogen, pneumatic gas, etc.) of the towing vehicle 13, such that the trailer communicator-defined fluid communication counterpart 1206 is disposed in fluid communication with the fluid energy storage device of the towing vehicle 13 via the trailer communicator-defined fluid conductor 1202.

In some embodiments, for example, as depicted in FIG. 2A, FIG. 2B, and FIG. 18, the trailer communicator-defined electrical conductor 1204 is disposed in electrical communication with an electrical energy source (e.g. battery) of the towing vehicle 13, such that the trailer communicator-defined electrical communication counterpart 1208 is disposed in electrical communication with the electrical energy source (e.g. battery) of the towing vehicle 13 via the trailer communicator-defined electrical conductor 1204.

In some embodiments, for example, as depicted in FIG. 2A, FIG. 2B, and FIG. 18, the trailer communicator-defined data conductor 1205 is disposed in data communication with a data communication system, for example, a databus, of the towing vehicle 13, such that the trailer communicator-defined data communication counterpart 1209 is disposed in data communication with the databus of the towing vehicle 13 via the trailer communicator-defined data conductor 1205. The data communication system supports data communication between the data communication devices (e.g. sensors, valves, switches, controllers including the controller 102, pumps, actuators, energy storage devices, engine, etc.) of the towing vehicle 13. Example communication protocols supported by the data communication system include Controller Area Network (CAN), RS485, Automotive Ethernet, Gigabit Multimedia Serial Link (GMSL). In some embodiments, for example, wherein the towing vehicle 13 does not include a data communication system such as a databus, the trailer communicator-defined data conductor 1205 functions as a data communication system, such as a databus, and is configured for disposition in data communication with data communication devices of the towing vehicle 13, such that the data communication devices of the towing vehicle 13 are disposed in data communication via the trailer communicator-defined data conductor 1205.

In some embodiments, for example, the towing vehicle 13 includes more than one trailer communicator-defined fluid conductor 1202, for example, a plurality of trailer communicator-defined fluid conductors 1202 that are each, independently, disposed in fluid communication with the fluid energy storage device of the towing vehicle 13.

In some embodiments, for example, the towing vehicle 13 includes more than one trailer communicator-defined fluid conductor 1202, for example, a plurality of trailer communicator-defined fluid conductors 1202 that are each, independently, disposed in fluid communication with a respective one of a plurality of fluid energy storage devices (e.g. energy storage devices for diesel, natural gas, hydrogen, pneumatic gas, etc.) of the towing vehicle 13. In some embodiments, for example, the towing vehicle 13 includes a trailer communicator-defined fluid conductor 1202 for each fluid energy storage device of the towing vehicle 13. In such embodiments, for example, each one of a plurality of trailer communicator-defined fluid communication counterparts 1206, independently, is disposed in fluid communication with a respective fluid energy storage device of the towing vehicle 13 via a respective trailer communicator-defined fluid conductor 1202. For example, the towing vehicle 13 includes two trailer communicator-defined fluid conductors 1202. In some embodiments, for example, a first trailer communicator-defined fluid conductor 1202 is disposed in fluid communication with a first fluid energy storage device of the towing vehicle 13, and a second trailer communicator-defined fluid conductor 1202 is disposed in fluid communication with a second fluid energy storage device of the towing vehicle 13.

In some embodiments, for example, the towing vehicle 13 includes more than one trailer communicator-defined fluid conductor 1202, for example, a trailer communicator-defined fluid conductor 1202 for each of a diesel storage device, natural gas storage device, hydrogen storage device, or pneumatic gas storage device of the towing vehicle 13.

In some embodiments, for example, the towing vehicle 13 includes more than one trailer communicator-defined electrical conductor 1204, for example, a plurality of trailer communicator-defined electrical conductors 1204 that are each, independently, disposed in electrical communication with the electrical energy storage device of the towing vehicle 13.

In some embodiments, for example, the towing vehicle 13 includes more than one trailer communicator-defined electrical conductor 1204, for example, a plurality of trailer communicator-defined electrical conductors 1204 that are each, independently, disposed in electrical communication with a respective one of a plurality of electrical energy storage devices of the towing vehicle 13. In such embodiments, for example, each one of a plurality of trailer communicator-defined electrical communication counterparts 1208, independently, is disposed in electrical communication with a respective electrical energy storage device of the towing vehicle 13 via a respective trailer communicator-defined electrical conductor 1204. For example, the towing vehicle 13 includes two trailer communicator-defined electrical conductors 1204. A first trailer communicator-defined electrical conductor 1204 is disposed in electrical communication with a first electrical energy storage device of the towing vehicle 13, and a second trailer communicator-defined electrical conductor 1204 is disposed in electrical communication with a second electrical energy storage device of the towing vehicle 13.

In some embodiments, for example, the towing vehicle 13 includes more than one trailer communicator-defined electrical conductor 1204, for example, a trailer communicator-defined electrical conductor 1204 for each electrical energy storage device of the towing vehicle 13.

In some embodiments, for example, the towing vehicle 13 includes more than one trailer communicator-defined data conductor 1205, for example, a plurality of trailer communicator-defined data conductors 1205 that are each, independently, disposed in data communication with the data communication devices of the towing vehicle 13, for example, via the data communication system of the towing vehicle 13.

In some embodiments, for example, the towing vehicle 13 includes more than one trailer communicator-defined data conductor 1205, for example, a plurality of trailer communicator-defined data conductors 1205 that are each, independently, disposed in data communication with one or more data communication devices of the towing vehicle 13. In such embodiments, for example, each of a plurality of trailer communicator-defined data communication counterparts 1209, independently, is disposed in data communication with a respective one or more data communication devices of the towing vehicle 13 via a respective trailer communicator-defined data conductor 1205.

In some embodiments, for example, the towing vehicle 13 includes more than one trailer communicator-defined data conductor 1205, for example, a plurality of trailer communicator-defined data conductors 1205 for the data communication devices (e.g. sensors, valves, switches, controllers, actuators, etc.) of the towing vehicle 13.

In some embodiments, for example, as depicted in FIG. 2, the towing vehicle communicator 130 includes the towing vehicle communicator-defined fluid conductor 1302, the towing vehicle communicator-defined electrical conductor 1304, and the towing vehicle communicator-defined data conductor 1305, and the towing vehicle communicator 130 is defined as separate communicators, in particular, the towing vehicle communicator-defined fluid conductor 1302, the towing vehicle communicator-defined electrical conductor 1304, and the towing vehicle communicator-defined data conductor 1305 are separate conductors. In some embodiments, for example, the towing vehicle communicator 130 includes the towing vehicle communicator-defined fluid conductor 1302, the towing vehicle communicator-defined electrical conductor 1304, and the towing vehicle communicator-defined data conductor 1305, and the towing vehicle communicator 130 is defined as a single communicator, for example, as a single cable, wherein the towing vehicle communicator-defined fluid conductor 1302, and the towing vehicle communicator-defined data conductor 1305 the towing vehicle communicator-defined electrical conductor 1304 are disposed in the communicator.

In some embodiments, for example, as depicted in FIG. 2A, FIG. 2B, and FIG. 18, the towing vehicle communicator-defined fluid conductor 1302 is disposed in fluid communication with the fluid system which include, in some embodiments, for example, actuatable fluid systems such as pneumatic gas systems, fluid energy storage devices or sources such as pneumatic gas storage devices, natural gas storage devices, hydrogen storage devices, and fuel storage devices, of the trailer 12, such that the towing vehicle communicator-defined fluid communication counterpart 1306 is disposed in fluid communication with the fluid system of the trailer 12 via the towing vehicle communicator-defined fluid conductor 1302.

In some embodiments, for example, as depicted in FIG. 2A, FIG. 2B, and FIG. 18, the towing vehicle communicator-defined electrical conductor 1304 is disposed in electrical communication with the electrical system of the trailer 12, which include, in some embodiments, for example, actuatable electrical systems and electrical energy storage devices, such that the towing vehicle communicator-defined electrical communication counterpart 1308 is disposed in electrical communication with the electrical system of the trailer 12 via the towing vehicle communicator-defined electrical conductor 1304.

In some embodiments, for example, as depicted in FIG. 2A, FIG. 2B, and FIG. 18, the towing vehicle communicator-defined data conductor 1305 is disposed in data communication with a data communication system, for example, a databus, of the trailer 12, such that the towing vehicle communicator-defined data communication counterpart 1309 is disposed in data communication with the databus of the trailer 12 via the towing vehicle communicator-defined data conductor 1305. The data communication system supports data communication between the data communication devices (e.g. sensors, valves, switches, controllers, pumps, actuators, energy sources, etc.) of the trailer 12. Example communication protocols supported by the data communication system include Controller Area Network (CAN), RS485, Automotive Ethernet, Gigabit Multimedia Serial Link (GMSL). In some embodiments, for example, wherein the trailer 12 does not include a data communication system such as a databus, the towing vehicle communicator-defined data conductor 1305 functions as a data communication system, such as a databus, and is configured for disposition in data communication with data communication devices of the trailer 12, such that the data communication devices of the trailer 12 are disposed in data communication via the towing vehicle communicator-defined data conductor 1305.

In some embodiments, for example, the trailer 12 includes more than one towing vehicle communicator-defined fluid conductor 1302, for example, a plurality of towing vehicle communicator-defined fluid conductors 1302 that are each, independently, disposed in fluid communication with the fluid system of the trailer 12.

As depicted, in some embodiments, for example, the trailer 12 includes more than one towing vehicle communicator-defined fluid conductor 1302, for example, a plurality of towing vehicle communicator-defined fluid conductors 1302 that are each, independently, disposed in fluid communication with a respective one of a plurality of subsystems of the fluid system (e.g. actuatable systems such as service brakes and parking brakes, pneumatic gas source, fuel source, etc.) of the trailer 12. In such embodiments, for example, each of a plurality of towing vehicle communicator-defined fluid communication counterparts 1306, independently, is disposed in fluid communication with a respective subsystem of the fluid system of the trailer 12 via a respective towing vehicle communicator-defined fluid conductor 1302. For example, the trailer 12 includes two towing vehicle communicator-defined fluid conductors 1302. A first towing vehicle communicator-defined fluid conductor 1302 is disposed in fluid communication with the service brake, and a second towing vehicle communicator-defined fluid conductor 1302 is disposed in fluid communication with the service brake.

In some embodiments, for example, the trailer 12 includes more than one towing vehicle communicator-defined fluid conductor 1302, for example, a towing vehicle communicator-defined fluid conductor 1302 for each subsystem of the fluid system of the trailer 12.

In some embodiments, for example, the trailer 12 includes more than one towing vehicle communicator-defined electrical conductor 1304, for example, a plurality of towing vehicle communicator-defined electrical conductors 1304 that are each, independently, disposed in electrical communication with the electrical system of the trailer 12.

In some embodiments, for example, the trailer 12 includes more than one towing vehicle communicator-defined electrical conductor 1304, for example, a plurality of towing vehicle communicator-defined electrical conductors 1304 that are each, independently, disposed in electrical communication with a respective one of a plurality of subsystems of the electrical system (e.g. actuatable systems such as ABS brakes, turning signals, electrical energy source, etc.) of the trailer 12. In such embodiments, for example, each of a plurality of towing vehicle communicator-defined electrical communication counterparts 1308, independently, is disposed in electrical communication with a respective subsystem of the electrical system of the trailer 12 via a respective towing vehicle communicator-defined electrical conductor 1304. For example, the trailer 12 includes two towing vehicle communicator-defined electrical conductors 1304. A first towing vehicle communicator-defined electrical conductor 1304 is disposed in electrical communication with ABS brakes of the trailer 12, and a second towing vehicle communicator-defined electrical conductor 1304 is disposed in electrical communication with the turning signals of the trailer 12.

In some embodiments, for example, the trailer 12 includes more than one towing vehicle communicator-defined electrical conductor 1304, for example, a towing vehicle communicator-defined electrical conductor 1304 for each subsystem of the electrical system of the trailer 12.

In some embodiments, for example, the trailer 12 includes more than one towing vehicle communicator-defined data conductor 1305, for example, a plurality of towing vehicle communicator-defined data conductors 1305 that are each, independently, disposed in data communication with the data communication devices of the trailer 12, for example, via the data communication system of the trailer 12.

In some embodiments, for example, the trailer 12 includes more than one towing vehicle communicator-defined data conductor 1305, for example, a plurality of towing vehicle communicator-defined data conductors 1305 that are each, independently, disposed in data communication with one or more data communication devices of the trailer 12. In such embodiments, for example, each one of a plurality of towing vehicle communicator-defined data communication counterparts 1309, independently, is disposed in data communication with a respective one or more data communication devices of the trailer 12 via a respective towing vehicle communicator-defined electrical conductor 1305. For example, the trailer 12 includes two towing vehicle communicator-defined data conductors 1305. A first towing vehicle communicator-defined data conductor 1305 is disposed in data communication with a first data communication device of the trailer 12, and a second towing vehicle communicator-defined data conductor 1305 is disposed in data communication with a second data communication device of the trailer 12.

In some embodiments, for example, the trailer 12 includes more than one towing vehicle communicator-defined data conductor 1305, for example, a towing vehicle communicator-defined data conductor 1305 for each data communication device of the trailer 12.

In some embodiments, for example, the towing communicator-defined fluid conductor 1302 is disposed in fluid communication with a fluid connector 20 (e.g. a glad hand) of the trailer 12, as depicted in FIG. 1, which is disposed in fluid communication with the fluid system of the trailer 12, such that the towing vehicle communicator-defined fluid communication counterpart 1306 is disposable in fluid communication with the fluid system of the trailer 12 via the towing vehicle communicator-defined fluid conductor 1302 and the fluid connector 20.

In some embodiments, for example, the towing communicator-defined fluid conductor 1302 is disposed in fluid communication with a fuel connector 22 of the trailer 12, as depicted in FIG. 1, which is disposed in fluid communication with the fuel source of the fluid system of the trailer 12 (e.g. diesel fuel tank, etc.), such that the towing vehicle communicator-defined fluid communication counterpart 1306 is disposable in fluid communication with the fuel source of the trailer 12 via the towing vehicle communicator-defined fluid conductor 1302 and the fuel connector 22.

In some embodiments, for example, the towing communicator-defined electrical conductor 1304 is disposed in electrical communication with an electrical connector 30 (e.g. pin connector, quick charge connector, etc.) of the trailer 12, as depicted in FIG. 1, which is disposed in electrical communication with the electrical system of the trailer 12, such that the towing vehicle communicator-defined electrical communication counterpart 1308 is disposed in electrical communication with the electrical system of the trailer 12 via the towing vehicle communicator-defined electrical conductor 1304 and the electrical connector 30.

In some embodiments, for example, the towing communicator-defined data conductor 1305 is disposed in data communication with a data connector 40 (e.g. pin connector) of the trailer 12, as depicted in FIG. 1, which is disposed in data communication with data communication devices of the trailer 12, such that the towing vehicle communicator-defined data communication counterpart 1309 is disposed in data communication with the data communication devices of the trailer 12 via the towing vehicle communicator-defined data conductor 1305 and the data connector 40.

In some embodiments, for example, as depicted in FIG. 2, the connection between the trailer communicator 120 and the towing vehicle communicator 130 is effectible by an adapter 300. The adapter 300 is configured to reduce the complexity of the establishing of operable communication, for example, fluid communication, electrical communication, and data communication, between the trailer communicator 120 and the towing vehicle communicator 130. In some embodiments, for example, the adapter 300 is configured to reduce the complexity of the establishing of operable communication between the towing vehicle 13 and the trailer 12. The adapter 300 includes a vehicle-defined adapter counterpart, vehicle-defined connection counterpart, towing vehicle-defined adapter counterpart, or towing vehicle-defined connection counterpart, for example, a first adapter counterpart 302, and a configuration-defined adapter counterpart, configuration-defined connection counterpart, trailer-defined adapter counterpart, or trailer-defined connection counterpart, for example, a second adapter counterpart 350. The first adapter counterpart 302 is configured for connection, for example, coupling, to the second adapter counterpart 350. In some embodiments, for example, the first adapter counterpart 302 and the second adapter counterpart 350 are co-operatively configured for connection, for example, coupling.

In some embodiments, for example, the connection of the first adapter counterpart 302 and the second adapter counterpart 350 is with effect that operable communication between the towing vehicle 13 and the trailer 12 is established for actuating a vehicular operation.

In some embodiments, for example, the connection of the first adapter counterpart 302 and the second adapter counterpart 350 is with effect that operable communication between the energy storage device of the towing vehicle 13 and the actuatable system of the trailer 12 is established, for transfer of energy from the energy storage device of the towing vehicle 13 to the actuatable system of the trailer 12, for actuating and controlling the vehicular operation. In some embodiments, for example, the connection of the first adapter counterpart 302 with the second adapter counterpart 350 effectuates connection between the energy storage device of the towing vehicle 13 and the actuatable system of the trailer 12, such that energy is transferrable from the energy storage device to the actuatable system, for actuating and controlling the vehicular operation.

In some embodiments, for example, the communication established between the towing vehicle 13 and the trailer 12, in response to the connection of the first adapter counterpart 302 and the second adapter counterpart 350, includes fluid communication.

In some embodiments, for example, the vehicular operation that is actuatable, in response to the establishment of communication between the towing vehicle 13 and the trailer 12, is actuation of service brakes of the trailer 12.

In some embodiments, for example, the vehicular operation that is actuatable, in response to the establishment of communication between the towing vehicle 13 and the trailer 12, is actuation of parking brakes of the trailer 12.

In some embodiments, for example, the actuatable system of the trailer 12 is a fluid energy-actuatable system or actuatable fluid system, the energy storage device of the towing vehicle 13 is a fluid energy, and the connection of the first adapter counterpart 302 and the second adapter counterpart 350 is with effect that the fluid energy-actuatable system of the trailer 12 is disposed in fluid pressure communication with the fluid energy storage device of the towing vehicle 13, for transfer of fluid energy to the fluid energy-actuatable system of the trailer 12 from the fluid energy storage device of the towing vehicle 13. In some embodiments, for example, the fluid energy includes pneumatic gas, such as pneumatic air.

In some embodiments, for example, the communication established between the towing vehicle 13 and the trailer 12, in response to the connection of the first adapter counterpart 302 and the second adapter counterpart 350, includes electrical communication.

In some embodiments, for example, the vehicular operation that is actuatable, in response to the establishment of communication between the towing vehicle 13 and the trailer 12, is actuation of ABS brakes of the trailer 12.

In some embodiments, for example, the vehicular operation that is actuatable, in response to the establishment of communication between the towing vehicle 13 and the trailer 12, is actuation of turn signals of the trailer 12.

In some embodiments, for example, the actuatable system of the trailer 12 is an electrical energy actuatable system or actuatable electrical system, the energy storage device of the towing vehicle 13 is an electrical energy storage device, and the connection of the first adapter counterpart 302 and the second adapter counterpart 350 is with effect that the electrical energy actuatable system of the trailer 12 is disposed in electrical communication with the electrical energy storage device of the towing vehicle 13, for transfer of electrical energy to the electrical energy actuatable system of the trailer 12 from the electrical energy storage device of the towing vehicle 13.

In some embodiments, for example, the communication established between the towing vehicle 13 and the trailer 12, in response to the connection of the first adapter counterpart 302 and the second adapter counterpart 350, includes data communication.

In some embodiments, for example, the trailer 12 includes one or more data communication devices, the towing vehicle 13 includes a data communication system (e.g. a databus) that is disposed in data communication with data communication devices of the towing vehicle 13, and the connection of the first adapter counterpart 302 and the second adapter counterpart 350 is with effect that the data communication devices of the trailer 12 are disposed in data communication with the data communication devices of the towing vehicle 13, for controlling the actuation of the fluid system or electrical system of the trailer 12.

In some embodiments, for example, the connection of the first adapter counterpart 302 and the second adapter counterpart 350 is with effect that operable communication between the energy storage device of the towing vehicle 13 and the energy source of the trailer 12 is established, for transfer of energy from the energy source of the trailer 12 to the energy storage device of the towing vehicle 13. In some embodiments, for example, the connection of the first adapter counterpart 302 with the second adapter counterpart 350 effectuates connection between the energy source of the trailer 12 and the energy storage device of the towing vehicle 13, such that energy is transferrable from the energy source of the trailer 12 to the energy storage device of the towing vehicle 13.

In some embodiments, for example, the energy source of the trailer 12 is a fluid energy source of the fluid system of the trailer 12, the energy storage device of the towing vehicle 13 is a fluid energy storage device, and the connection of the first adapter counterpart 302 and the second adapter counterpart 350 is with effect that the fluid energy source of the trailer 12 is disposed in fluid pressure communication with the fluid energy storage device of the towing vehicle 13, for transfer of fluid energy from the fluid energy source of the trailer 12 to the fluid energy storage device of the towing vehicle 13. In some embodiments, for example, the fluid energy includes pneumatic gas. In some embodiments, for example, the fluid energy includes hydrogen. In some embodiments, for example, the fluid energy includes natural gas.

In some embodiments, for example, the energy source of the trailer 12 is a fuel source of the fluid system of the trailer 12, the energy storage device of the towing vehicle 13 is a fuel storage device, and the connection of the first adapter counterpart 302 and the second adapter counterpart 350 is with effect that the fuel source of the trailer 12 is disposed in fluid pressure communication with the fuel storage device of the towing vehicle 13, for transfer of fuel from the fuel source of the trailer 12 to the fuel storage device of the towing vehicle 13. In some embodiments, for example, the fuel includes diesel fuel.

In some embodiments, for example, the energy source of the trailer 12 is an electrical energy source of the electrical system of the trailer 12, the energy storage device of the towing vehicle 13 is an electrical energy storage device, and the connection of the first adapter counterpart 302 and the second adapter counterpart 350 is with effect that the electrical energy source of the trailer 12 is disposed in electrical communication with the electrical energy storage device of the towing vehicle 13, for transfer of electrical energy from the electrical energy source of the trailer 12 to the electrical energy storage device of the towing vehicle 13.

In some embodiments, for example, the trailer 12 includes one or more data communication devices, the towing vehicle 13 includes a data communication system (e.g. a databus) that is disposed in data communication with data communication devices of the towing vehicle 13, and the connection of the first adapter counterpart 302 and the second adapter counterpart 350 is with effect that the data communication devices of the trailer 12 are disposed in data communication with the data communication devices of the towing vehicle 13, for controlling the transfer of energy from the one or more energy sources of the trailer 12 to the one or more energy storage devices of the towing vehicle 13.

In some embodiments, for example, as depicted in FIG. 2, the first adapter counterpart 302 (e.g. a male counterpart 302) is disposed in operable communication, for example, fluid communication, electrical communication, and data communication, with the trailer communicator 120.

In some embodiments, for example, as depicted in FIG. 2A, FIG. 2B, and FIG. 18, the first adapter counterpart 302 is disposed in fluid communication with the one or more trailer communicator-defined fluid conductors 1202 which are disposed in fluid communication with the fluid energy storage devices (e.g. pneumatic gas storage device and fuel storage device) of the towing vehicle 13. In some embodiments, for example, for each one of the one or more trailer communicator-defined fluid conductors 1202, the first adapter counterpart 302 is disposed in fluid communication with the trailer communicator-defined fluid conductor 1202 via a respective trailer communicator-defined fluid communication counterpart 1206. In this respect, in some embodiments, for example, for each one of the fluid energy storage devices of the towing vehicle 13, the first adapter counterpart 302 and the fluid energy storage device of the towing vehicle 13 are disposed in fluid communication via a respective trailer communicator-defined fluid conductor 1202. In some embodiments, for example, the fluid energy storage devices of the towing vehicle 13 are disposed in fluid communication with the first adapter counterpart 302 via the trailer communicator-defined fluid conductor 1202 and the trailer communicator-defined fluid communication counterpart 1206.

In some embodiments, for example, as depicted in FIG. 2A, FIG. 2B, and FIG. 18, the first adapter counterpart 302 is disposed in electrical communication with the one or more trailer communicator-defined electrical conductors 1204, which are disposed in electrical communication with the electrical energy storage devices (e.g. battery) of the towing vehicle 13. In some embodiments, for example, for each one of the one or more trailer communicator-defined electrical conductors 1204, the first adapter counterpart 302 is disposed in electrical communication with the trailer communicator-defined electrical conductor 1204 via a respective trailer communicator-defined electrical communication counterpart 1208. In this respect, in some embodiments, for example, for each one of the electrical energy storage devices of the towing vehicle 13, the first adapter counterpart 302 and the electrical energy storage device of the towing vehicle 13 are disposed in electrical communication via a respective trailer communicator-defined electrical conductor 1204. In some embodiments, for example, the electrical energy storage devices of the towing vehicle 13 are disposed in electrical communication with the first adapter counterpart 302 via the trailer communicator-defined electrical conductor 1204 and the trailer communicator-defined electrical communication counterpart 1208.

In some embodiments, for example, as depicted FIG. 2A, FIG. 2B, and FIG. 18, the first adapter counterpart 302 is disposed in data communication with the one or more trailer communicator-defined data conductors 1205, which are disposed in data communication with the data communication devices of the towing vehicle 13 via the data communication system of the vehicle 13. In some embodiments, for example, the first adapter counterpart 302 is disposed in data communication with the one or more trailer communicator-defined data conductors 1205 via a respective trailer communicator-defined data communication counterpart 1209. In this respect, in some embodiments, for example, for each one of the data communication devices of the towing vehicle 13, the first adapter counterpart 302 and the data communication device are disposed in data communication via a respective trailer communicator-defined data conductor 1205. In some embodiments, for example, the data communication devices of the towing vehicle 13 are disposed in data communication with the first adapter counterpart 302 via the data communication system (e.g. databus), the trailer communicator-defined data conductor 1205, and the trailer communicator-defined data communication counterpart 1209.

In some embodiments, for example, as depicted in FIG. 2, the second adapter counterpart 350 (e.g. a female counterpart 350) is disposed in operable communication, for example, fluid communication, electrical communication, and data communication, with the towing vehicle communicator 130.

In some embodiments, for example, as depicted in FIG. 2A, FIG. 2B, and FIG. 18, the second adapter counterpart 350 is disposed in fluid communication with the one or more towing vehicle communicator-defined fluid conductors 1302, which are disposed in fluid communication with the fluid system of the trailer 12 (e.g. subsystems such as actuatable fluid systems, fluid energy source such as a pneumatic gas source and a fuel source, etc.). In some embodiments, for example, for each one of the one or more towing vehicle communicator-defined fluid conductors 1302, the second adapter counterpart 350 is disposed in fluid communication with the towing vehicle communicator-defined fluid conductor 1302 via a respective towing vehicle communicator-defined fluid communication counterpart 1306. In this respect, in some embodiments, for example, for each one of the subsystems of the fluid system the trailer 12, the second adapter counterpart 350 and the subsystem of the fluid system of the trailer 12 are disposed in fluid communication via a respective towing vehicle communicator-defined fluid conductor 1302. In some embodiments, for example, the fluid system of the trailer 12 is disposed in fluid communication with the second adapter counterpart 350 via the towing vehicle communicator-defined fluid conductor 1302 and the towing vehicle communicator-defined fluid communication counterpart 1306.

In some embodiments, for example, as depicted in FIG. 2A, FIG. 2B, and FIG. 18, the second adapter counterpart 350 is disposed in electrical communication with the one or more towing communicator-defined electrical conductors 1304, which are disposed in electrical communication with the electrical system of the trailer 12 (e.g. subsystems such as actuatable electrical systems, electrical energy source, etc.). In some embodiments, for example, for each of the one or more towing vehicle communicator-defined electrical conductors 1304, the second adapter counterpart 350 is disposed in electrical communication with the towing vehicle communicator-defined electrical conductor 1304 via a respective towing vehicle communicator-defined electrical communication counterpart 1308. In this respect, in some embodiments, for example, for each one of the subsystems of the electrical system of the trailer 12, the second adapter counterpart 350 and the subsystem of the electrical system of the trailer 12 are disposed in electrical communication via a respective towing vehicle communicator-defined electrical conductor 1304. In some embodiments, for example, the electrical system of the trailer 12 is disposed in electrical communication with the second adapter counterpart 350 via the towing vehicle communicator-defined electrical conductor 1304 and the towing vehicle communicator-defined electrical communication counterpart 1308.

In some embodiments, for example, as depicted in FIG. 2A, FIG. 2B, and FIG. 18, the second adapter counterpart 350 is disposed in data communication with the one or more towing vehicle communicator-defined data conductors 1305, which are disposed in data communication with the data communication devices of the trailer 12. In some embodiments, for example, the second adapter counterpart 350 is disposed in data communication with the one or more towing vehicle communicator-defined data conductors 1305 via a respective towing vehicle communicator-defined data communication counterpart 1309. In this respect, in some embodiments, for example, for each one of the data communication devices of the trailer 12, the second adapter counterpart 350 and the data communication device are disposed in data communication via a respective towing vehicle communicator-defined data conductor 1305. In some embodiments, for example, the data communication devices of the trailer 12 are disposed in data communication with the second adapter counterpart 350 via the towing vehicle communicator-defined data conductor 1305 and the towing vehicle communicator-defined data communication counterpart 1309.

In some embodiments, for example, the first adapter counterpart 302 and the second adapter counterpart 350 are configured to be disposed in operable communication via connection of the first adapter counterpart 302 and the second adapter counterpart 350, for example, fluid communication, electrical communication, and data communication. In some embodiments, for example, the disposition of the first adapter counterpart 302 and the second adapter counterpart 350 in operable communication is effected by connection, for example, coupling, of the first adapter counterpart 302 and the second adapter counterpart 350.

In some embodiments, for example, in response to disposition of the first adapter counterpart 302 and the second adapter counterpart 350 in operable communication, the trailer communicator 120 and the towing vehicle communicator 130 are disposed in operable communication via the adapter 300. In this respect, in some embodiments, for example, in response to disposition of the first adapter counterpart 302 and the second adapter counterpart 350, the towing vehicle 13 and the trailer 12 are disposed in operable communication via the adapter 300, the trailer communicator 120, and the towing vehicle communicator 130.

In some embodiments, for example, as depicted in FIG. 2B, in response to disposition of the first adapter counterpart 302 and the second adapter counterpart 350 in operable communication, for example, fluid communication, via connection of the first adapter counterpart 302 and the second adapter counterpart 350, the one or more trailer communicator-defined fluid conductors 1202 and the corresponding towing vehicle communicator-defined fluid conductors 1302 become disposed in fluid communication via the adapter 300. In this respect, in some embodiments, for example, in response to disposition of the first adapter counterpart 302 and the second adapter counterpart 350 in fluid communication, the one or more fluid energy storage devices, such as pneumatic gas storage devices, of the towing vehicle 13 and the fluid system of the trailer 12 become disposed in fluid communication via the adapter 300, the trailer communicator-defined fluid conductor 1202, and the towing vehicle communicator-defined fluid conductor 1302, such that the actuatable fluid system of the fluid system of the trailer 12 is actuatable by the one or more fluid energy storage devices of the vehicle 13, and such that fluid energy is transferrable from the fluid energy source of the trailer 12, such as the pneumatic gas source, to the one or more fluid energy storage devices of the towing vehicle 13, such as the pneumatic gas storage device.

In some embodiments, for example, as depicted in FIG. 2B, in response to disposition of the first adapter counterpart 302 and the second adapter counterpart 350 in operable communication, for example, fluid communication, via connection of the first adapter counterpart 302 and the second adapter counterpart 350, the one or more trailer communicator-defined fluid conductors 1202 and the corresponding one or more towing vehicle communicator-defined fluid conductors 1302 are disposed in fluid communication via the adapter 300. In this respect, in some embodiments, for example, in response to disposition of the first adapter counterpart 302 and the second adapter counterpart 350 in fluid communication, the one or more fuel storage devices of the towing vehicle 13 and the corresponding fuel energy source of the trailer 12 are disposed in fluid communication via the adapter 300, the one or more trailer communicator-defined fluid conductors 1202, and the one or more towing vehicle communicator-defined fluid conductors 1302, such that fuel is transferrable from the fuel source of the trailer 12 to the one or more fuel storage devices of the towing vehicle 13.

In some embodiments, for example, as depicted in FIG. 2B, in response to disposition of the first adapter counterpart 302 and the second adapter counterpart 350 in operable communication, for example, electrical communication, via connection of the first adapter counterpart 302 and the second adapter counterpart 350, the one or more trailer communicator-defined electrical conductor 1204 and the corresponding towing vehicle communicator-defined electrical conductors 1304 become disposed in electrical communication via the adapter 300. In this respect, in some embodiments, for example, in response to disposition of the first adapter counterpart 302 and the second adapter counterpart 350 in electrical communication, the one or more electrical energy storage devices of the towing vehicle 13 and the electrical system of the trailer 12 are disposed in electrical communication via the adapter 300, the trailer communicator-defined electrical conductor 1204, and the towing vehicle communicator-defined electrical conductor 1304, such that the actuatable electrical systems of the electrical system of the trailer 12 is actuatable by the one or more electrical energy storage devices of the towing vehicle 13, and such that electrical energy is transferrable from the electrical energy source of the trailer 12 to the one or more electrical energy storage devices of the towing vehicle 13.

In some embodiments, for example, as depicted in FIG. 2B, in response to disposition of the first adapter counterpart 302 and the second adapter counterpart 350 in operable communication, for example, data communication, via connection of the first adapter counterpart 302 and the second adapter counterpart 350, the trailer communicator-defined data conductor 1205 and the towing vehicle communicator-defined data conductor 1305 are disposed in data communication via the adapter 300. In this respect, in some embodiments, for example, in response to disposition of the first adapter counterpart 302 and the second adapter counterpart 350 in data communication, the data communication devices of the towing vehicle 13 and the data communication devices of the trailer 12 are disposed in data communication via the adapter 300, the trailer communicator-defined data conductor 1205, and the towing vehicle communicator-defined data conductor 1305. In this respect, in some embodiments, for example, the adapter 300, the trailer communicator-defined data conductor 1205, and the towing vehicle communicator-defined data conductor 1305 are configured to support data communication between the towing vehicle 13 and the trailer 12, in particular, the data communication devices of the towing vehicle 13 and the data communication devices of the trailer 12. Example communication protocols supported by the the adapter 300, the trailer communicator-defined data conductor 1205, and the towing vehicle communicator-defined data conductor 1305 include Controller Area Network (CAN), RS485, Automotive Ethernet, Gigabit Multimedia Serial Link (GMSL).

As depicted in FIG. 2, the first adapter counterpart 302 includes a housing 304. As depicted, the first adapter counterpart 302 includes one or more electrical communicators, for example, electrical connectors 308, for example, electrical connector pins, one or more fluid pressure communicators, for example, fluid connectors 310, for example, fluid connector pins, one or more guide pins 312, and one or more data connectors 314, for example, data connector pins. In some embodiments, for example, the electrical connectors 308, the fluid connectors 310, data connectors 314, and the guide pins 312 extend from the housing 304. In some embodiments, for example, the electrical connectors 308, the fluid connectors 310, and the guide pins 312 are housed in the housing 304. In some embodiments, for example, the first adapter counterpart 302 defines an electro-pneumatic interface, wherein the electro-pneumatic interface includes the one or more electrical connectors 308, the one or more fluid connectors 310, and the one or more data connectors 314. In some embodiments, for example, the electro-pneumatic interface further includes the one or more guide pins 312. In some embodiments, for example, at least one of the one or more fluid connectors 310 are disposed in fluid communication with the trailer communicator-defined fluid conductor 1202. In some embodiments, for example, at least one of the one or more electrical connectors 308 are disposed in electrical communication with the trailer communicator-defined electrical conductor 1204. In some embodiments, for example, at least one of the one or more data connectors 314 are disposed in data communication with the trailer communicator-defined data conductor 1205.

In some embodiments, for example, for each one of the one or more trailer communicator-defined fluid conductors 1202, the trailer communicator-defined fluid conductors 1202 is disposed in operable communication, for example, fluid communication, with at least one of the one or more fluid connectors 310, for operably communicating fluid energy (e.g. diesel, natural gas, hydrogen, pneumatic gas). In some embodiments, for example, a first fluid connector 310 is disposed in fluid communication with a first trailer communicator-defined fluid conductor 1202, and a second fluid connector 310 is disposed in fluid communication with a second towing communicator-defined fluid conductor 1202. In some embodiments, for example, for each one of the one or more trailer communicator-defined electrical conductors 1204, the trailer communicator-defined electrical conductor 1204 is disposed in electrical communication with at least one of the one or more electrical connectors 308, for operably communicating electrical energy. In some embodiments, for example, a first electrical connector 308 is disposed in electrical communication with a first trailer communicator-defined electrical conductor 1204, and a second electrical connector 308 is disposed in electrical communication with a second towing communicator-defined electrical conductor 1204. In some embodiments, for example, for each one of the one or more trailer communicator-defined data conductors 1205, the trailer communicator-defined data conductor 1205 is disposed in data communication with at least one of the one or more data connectors 314, for operably communicating data (e.g. data signals). In some embodiments, for example, a first data connector 314 is disposed in data communication with a first trailer communicator-defined data conductor 1205, and a second data connector 308 is disposed in data communication with a second towing communicator-defined data conductor 1205.

The first adapter counterpart 302 includes a second connector counterpart 315 that is configured to co-operate with a first connector counterpart 232 of a coupler 704 of a connection apparatus 100 for releasably coupling the first adapter counterpart 302 and the coupler 704. The first connector counterpart 232 is configured to releasably couple with second connector counterpart 315 such that, while the first connector counterpart 232 is releasably coupled to the second connector counterpart 315, the coupler 704 is releasably coupled to the first adapter counterpart 302. In some embodiments, for example, the releasable coupling of the first connector counterpart 232 and the second connector counterpart 315 is effected by a latch, for example, one or more spring-loaded latches. In some embodiments, for example, the spring-loaded latch is disposed in one of the first connector counterpart 232 and the second connector counterpart 315, for example, the first connector counterpart 232. In some embodiments, for example, a spring-loaded latch is disposed in both of the first connector counterpart 232 and the second connector counterpart 315.

In some embodiments, for example, one or more guide pins 322 extend from the housing 304, and are configured to be received by one or more guide ports 240 of the coupler 704. The one or more guide pins 322 and the one or more guide ports 240 are co-operatively configured to guide the relative displacement of the first adapter counterpart 302 and the coupler 704, to effect the releasable coupling of the first adapter counterpart 302 and the coupler 704, such that, while the guide pins 322 are received in the ports 240, releasable coupling of the first connector counterpart 232 and the second connector counterpart 315, and therefore, the first adapter counterpart 302 and the coupler 704, is effectible, in response to displacement of the first connector counterpart 232 towards the second connector counterpart 315. The guide pins 322 and the ports 240 are co-operatively configured such that, while the guide pins 322 are received in the ports 240, the first adapter counterpart 302 and the coupler 704 are disposed in alignment, for example, along an alignment axis.

In some embodiments, for example, the first adapter counterpart 302 defines the guide ports 240, and the coupler 704 includes the guide pins 322.

As depicted in FIG. 2, the second adapter counterpart 350 includes a housing 352. The second adapter counterpart 350 includes one or more electrical ports 3080, one or more fluid ports 3100, one or more data ports 3140, and one or more guide ports 3120. In some embodiments, for example, the second adapter counterpart 350 defines an electro-pneumatic interface, wherein the electro-pneumatic interface includes the one or more electrical connector ports 3080, the one or more fluid connector ports 3100, and the one or more data connector ports 3140. In some embodiments, for example, the electro-pneumatic interface further includes the one or more guide ports 3120. In some embodiments, for example, at least one of the one or more fluid ports 3100 are disposed in fluid communication with the towing communicator-defined fluid conductor 1302. In some embodiments, for example, a first fluid port 3100 is disposed in fluid communication with a first towing communicator-defined fluid conductor 1302, and a second fluid port 3100 is disposed in fluid communication with a second towing communicator-defined fluid conductor 1302. In some embodiments, for example, at least one of the one or more electrical ports 3080 are disposed in electrical communication with the towing communicator-defined electrical conductor 1304. In some embodiments, for example, a first electrical port 3080 is disposed in electrical communication with a first towing communicator-defined electrical conductor 1304, and a second electrical port 3080 is disposed in electrical communication with a second towing communicator-defined electrical conductor 1304. In some embodiments, for example, at least one of the one or more data ports 3140 are disposed in data communication with the towing communicator-defined data conductor 1305. In some embodiments, for example, a first data port 3140 is disposed in data communication with a first towing communicator-defined data conductor 1305, and a second data port 3140 is disposed in data communication with a second towing communicator-defined data conductor 1305. In some embodiments, for example, for each one of the one or more towing vehicle communicator-defined fluid conductors 1302, the towing vehicle communicator-defined fluid conductor 1302 is disposed in operable communication, for example, fluid communication, with at least one of the one or more fluid ports 3100, for operably communicating fluid energy (e.g. diesel, natural gas, hydrogen, pneumatic gas). In some embodiments, for example, for each one of the one or more towing vehicle communicator-defined electrical conductors 1304, the towing vehicle communicator-defined electrical conductor 1304 is disposed in electrical communication with at least one of the one or more electrical ports 3080, for operably communicating electrical energy. In some embodiments, for example, for each one of the one or more towing vehicle communicator-defined data conductors 1305, the towing vehicle communicator-defined data conductor 1305 is disposed in data communication with at least one of the one or more data ports 3140, for operably communicating data.

As depicted, in some embodiments, for example, while the second adapter counterpart 350 is mounted on the trailer 12, and while the towing vehicle 13 and the trailer 12 are coupled, the electrical ports 3080, fluid ports 3100, data ports 3140, and guide ports 3120 are facing towards the towing vehicle 13. In some embodiments, for example, while the second adapter counterpart 350 is mounted on the trailer 12, the electrical ports 3080, fluid ports 3100, data ports 3140, and guide ports 3120 are facing forwards towards the front surface 52 of the trailer 12. In some embodiments, for example, while the second adapter counterpart 350 is mounted on the trailer 12, the electrical ports 3080, fluid ports 3100, data ports 3140, and guide ports 3120 are disposed in alignment with the roll axis (e.g. of the trailer 12).

In some embodiments, for example, the bottom surface 50 is disposed below the front surface 52. In some embodiments, for example, a normal axis defined by the front surface 52 and a normal axis defined by the bottom surface 50 are disposed in a non-parallel relationship. In some embodiments, for example, a normal axis defined by the front surface 52 and a normal axis defined by the bottom surface 50 are disposed in a perpendicular relationship.

In some embodiments, for example, the second adapter counterpart 350 includes an internal configuration 370. In some embodiments, for example, the electrical ports 3080, fluid ports 3100, data ports 3140, and guide ports 3120 are defined by the internal configuration 370. As depicted, the internal configuration 370 is disposed in the housing 352.

In some embodiments, for example, the internal configuration 370 is biased to a center position, relative to the housing 352. The biasing is effectuated by a spring assembly 372. In some embodiments, for example, the spring assembly 372 comprises two springs 3720. In this respect, in some embodiments, for example, the housing 352, the internal configuration 370, and the spring assembly 372 are co-operatively configured such that relative displacement is effectuatable between the housing 352 and the internal configuration 370 via the spring assembly 372. In some embodiments, the relative displacement includes lateral displacement (e.g. left-right displacement). In some embodiments, for example, while the first adapter counterpart 302 is displaced towards the second adapter counterpart 350, for effectuating the connection between the first adapter counterpart 302 and the second adapter counterpart 350, the internal configuration 370 is displaceable, relative to the housing 352, in response to a force applied to the internal configuration 370, for example, the guide ports 3120, by the first adapter counterpart 302, for example, the guide pins 312, to align the first adapter counterpart 302 and the second adapter counterpart 350, for effectuating the connection between the first adapter counterpart 302 and the second adapter counterpart 350.

The electrical connectors 308 of the first adapter counterpart 302 and the electrical ports 3080 of the second adapter counterpart 350 are co-operatively configured such that, in response to insertion of the electrical connectors 308 into the electrical ports 3080, the first adapter counterpart 302 and the second adapter counterpart 350 become disposed in electrical communication, with effect that, for each one of the one or more trailer communicator-defined electrical conductors 1204, the trailer communicator-defined electrical conductor 1204 and a respective towing vehicle communicator-defined electrical conductor 1304 become disposed in electrical communication. In this respect, in response to insertion of the electrical connectors 308 into the electrical ports 3080, the electrical energy storage device of the towing vehicle 13 becomes disposed in electrical communication with the electrical system of the trailer 12 via the adapter 300, the trailer communicator-defined electrical conductor 1204, and the towing vehicle communicator-defined electrical conductor 1304, such that the actuatable electrical system is actuatable, and such that electrical energy is transferrable from the electrical energy source of the trailer 12 to the electrical energy storage device of the towing vehicle 13.

The fluid connectors 310 of the first adapter counterpart 302 and the fluid ports 3100 of the second adapter counterpart 350 are co-operatively configured such that, in response to insertion of the fluid connectors 310 into the fluid ports 3100, the first adapter counterpart 302 and the second adapter counterpart 350 become disposed in fluid communication, with effect that, for each one of the one or more trailer communicator-defined fluid conductors 1202, the trailer communicator-defined fluid conductor 1202 and a respective towing vehicle communicator-defined fluid conductor 1302 become disposed in fluid communication. In this respect, in response to insertion of the fluid connectors 310 into the fluid ports 3100, the fluid energy storage device of the towing vehicle 13 becomes disposed in fluid communication with the fluid system of the trailer 12 via the adapter 300, the trailer communicator-defined fluid conductor 1202, and the towing vehicle communicator-defined fluid conductor 1302, such that the actuatable fluid system is actuatable, and such that fluid energy (e.g. pneumatic gas, fuel) is transferrable from the fluid energy source of the trailer 12 to the fluid energy storage device of the towing vehicle 13.

The data connectors 314 of the first adapter counterpart 302 and the data ports 3140 of the second adapter counterpart 350 are co-operatively configured such that, in response to insertion of the data connectors 314 into the data ports 3140, the first adapter counterpart 302 and the second adapter counterpart 350 become disposed in data communication, with effect that, for each one of the one or more trailer communicator-defined data conductors 1205, the trailer communicator-defined data conductor 1205 and a corresponding towing vehicle communicator-defined data conductor 1305 become disposed in data communication. In this respect, in response to insertion of the data connectors 314 into the data ports 3140, for each one of the one or more data communication devices of the towing vehicle 13, the data communication device becomes disposed in data communication with one or more of the data communication devices of the trailer 12 via the adapter 300, the trailer communicator-defined data conductor 1205, and the towing vehicle communicator-defined data conductor 1305, for controlling the actuation of the actuatable energy system (e.g. fluid energy system such as pneumatic gas system, electrical energy system, etc.) of the trailer 12, and for controlling the transfer of energy from the energy source of the trailer 12 to the energy storage device of the towing vehicle 13.

In some embodiments, for example, connection of the first adapter counterpart 302 and the second adapter counterpart 350, for disposition of the first adapter counterpart 302 and the second adapter counterpart 350 in operable communication, is effected by establishment of: (i) electrical communication between the electrical connectors 308 and the electrical ports 3080, (ii) fluid communication between the fluid connectors 310 and the fluid ports 3100, and (iii) data communication between the data connectors 314 and the data ports 3140. In some embodiments, for example, establishment of electrical communication between the electrical connectors 308 and the electrical ports 3080 is effected by insertion of the electrical connectors 308 into the electrical ports 3080. In some embodiments, for example, establishment of fluid communication between the fluid connectors 310 and the fluid ports 3100 is effected by insertion of the fluid connectors 310 into the fluid ports 3100. In some embodiments, for example, establishment of data communication between the data connectors 314 and the data ports 3140 is effected by insertion of the data connectors 314 into the data ports 3140.

In some embodiments, for example, the guide pins 312 of the first adapter counterpart 302 and the guide ports 3120 of the second adapter counterpart 350 are co-operatively configured to guide the relative displacement of the first adapter counterpart 302 and the second adapter counterpart 350 for effecting the coupling of the first adapter counterpart 302 and the second adapter counterpart 350, such that the first adapter counterpart 302 and the second adapter counterpart 350 become disposed in operable communication.

In some embodiments, for example, the first adapter counterpart 302 defines the guide ports 3120, and the second adapter counterpart 350 defines the guide pins 312.

In some embodiments, for example, the first adapter counterpart 302 and the second adapter counterpart 350 are compliant with ISO 13044-2 standard.

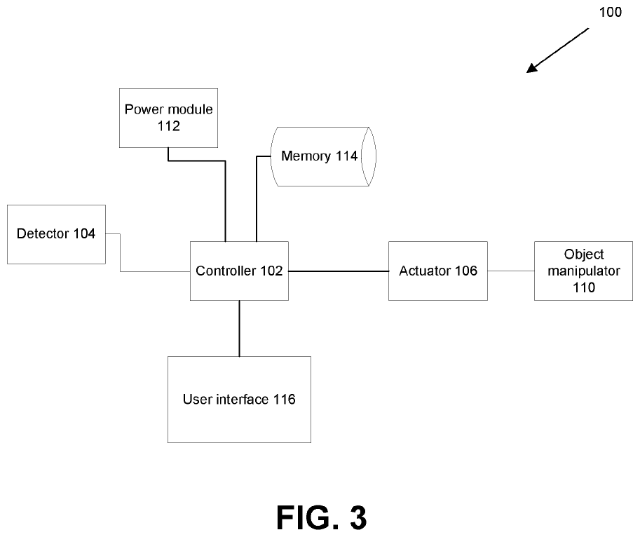

FIG. 3 depicts a block diagram of an example embodiment of an apparatus 100 that is configured to operably communicate the first adapter counterpart 302 and the second adapter counterpart 350, for example, connect, the first adapter counterpart 302 and the second adapter counterpart 350, to effect operable communication of the trailer communicator 120 of the towing vehicle 13 and the towing vehicle communicator 130 of the trailer 12. As depicted, in some embodiments, for example, the apparatus 100 includes a controller 102, a detector 104, an actuator assembly 106, an object manipulator 110, a power module 112, and a memory 114. In some embodiments, for example, the apparatus 100 further includes a user interface 116. The object manipulator 110 is configured to automatically connect the first adapter counterpart 302 and the second adapter counterpart 350 to establish operable communication between the first adapter counterpart 302 and the second adapter counterpart 350, thereby establishing connection, for example, operable communication, between the energy storage device of the towing vehicle 13 and the energy system of the trailer 12, such that the energy system of the trailer 12 is actuatable, and such that energy is transferrable from the energy source of the energy system the trailer 12 to the energy storage device of the towing vehicle 13.

In some embodiments, for example, the apparatus 100 is configured to displace the first adapter counterpart 302 towards the second adapter counterpart 350 for effecting an alignment relationship-obtaining displacement between the first adapter counterpart 302 and the second adapter counterpart 350, such that the first adapter counterpart 302 and the second adapter counterpart 350 become disposed in an alignment relationship, and for disposing the first adapter counterpart 302 and the second adapter counterpart 350 in operable communication.

In some embodiments, for example, the apparatus 100 is configured to dispose the first adapter counterpart 302 and the second adapter counterpart 350 in operable communication. In some embodiments, for example, the disposition of the first adapter counterpart 302 and the second adapter counterpart 350 in operable communication is effected by insertion of the electrical, fluid, and data connectors 308, 310, and 314 of the first adapter counterpart 302 into the corresponding ports 3080, 3100, and 3140 of the second adapter counterpart 350.

In some embodiments, for example, the apparatus 100 is configured to decouple from the first adapter counterpart 302, and displace away from the first adapter counterpart 302 and the second adapter counterpart 350, after effecting the disposition of the first adapter counterpart 302 and the second adapter counterpart 350 in operable communication (e.g. after connecting the first adapter counterpart 302 and the second adapter counterpart 350).

In some embodiments, for example, while the first adapter counterpart 302 and the second adapter counterpart 350 are connected, the apparatus 100 is configured to defeat the connection between the first adapter counterpart 302 and the second adapter counterpart 350.

In some embodiments, the controller 102 includes a processor or a central processing unit (CPU), a memory 114 such as a ROM, RAM, persistent memory, or flash memory for storing data, and input or output peripherals. In some embodiments, for example, the controller 102 acts as a central controller for controlling all of the communications of the apparatus 100, and between the apparatus 100 and an external server or user equipment, such as a computer, laptop, smart device, a control panel in a control room, a control panel in the towing vehicle 13, a controller of the towing vehicle 13, and the like.

The controller 102 communicates with the detector 104, the actuator assembly 106, the user interface 116, the power module 112, and the memory 114. In some embodiments, the controller 102 receives data, saves the data to a memory, and processes the received data. The data may be real time data or historical data. In some embodiments, the controller 102 or detector 104 processes the data by, for example, comparing data with one or more preset thresholds. In some embodiments, the controller 102 or detector 104 processes the data to, for example, determine whether the towing vehicle 13 and trailer 12 are coupled or uncoupled, determine whether the first adapter counterpart 302 and the second adapter counterpart 350 are coupled or uncoupled, determine whether the first adapter counterpart 302 and the second adapter counterpart 350 are disposed in operable communication, determine whether a coupler 704 of an end effector 700 and the first adapter counterpart 302 are coupled or uncoupled, determine whether the object manipulator 110 is disposed outside a swing path of the trailer 12, and determine the configuration of the object manipulator 110, for initiating the next step in the process for aligning and coupling the first adapter counterpart 302 and the second adapter counterpart 350 to establish operable communication between the first adapter counterpart 302 and the second adapter counterpart 350, or for uncoupling the first adapter counterpart 302 and the second adapter counterpart 350 to defeat the operable communication between the first adapter counterpart 302 and the second adapter counterpart 350. Based on said determinations, in some embodiments, for example, the controller 102 is configured to activate the actuator assembly 106 to effect coupling of the end effector 700 of the object manipulator 110 with the first adapter counterpart 302, and to displace the first adapter counterpart 302 relative to the second adapter counterpart 350, to operably connect the first adapter counterpart 302 with the second adapter counterpart 350. In some embodiments, for example, the controller 102 determines that the towing vehicle 13 has stopped operating for a threshold period of time and that the towing vehicle 13 and the trailer 12 are coupled, and then the controller 102 is configured to activate the actuator assembly 106 to effect coupling of the end effector 700 of the object manipulator 110 with the first adapter counterpart 302, and to displace the first adapter counterpart 302 relative to the second adapter counterpart 350, to operably connect the first adapter counterpart 302 with the second adapter counterpart 350. Based on said determinations, in some embodiments, for example, the controller 102 is configured to activate the actuator assembly 106 to effect coupling of the end effector 700 of the object manipulator 110 and the first adapter counterpart 302 that is operably connected with the second adapter counterpart 350, and to displace the first adapter counterpart 302, relative to the second adapter counterpart 350, to operably disconnect from the second adapter counterpart 350, such that operable communication between the first adapter counterpart 302 and the second adapter counterpart 350 becomes defeated. In some embodiments, for example, the controller 102 determines that the towing vehicle 13 has stopped operating for a threshold period of time and that the towing vehicle 13 and the trailer 12 are coupled, and then the controller 102 is configured to activate the actuator assembly 106 to effect coupling of the end effector 700 of the object manipulator 110 110 and the first adapter counterpart 302 that is operably connected with the second adapter counterpart 350, and to displace the first adapter counterpart 302, relative to the second adapter counterpart 350, to operably disconnect from the second adapter counterpart 350, such that operable communication between the first adapter counterpart 302 and the second adapter counterpart 350 becomes defeated.

In some embodiments, the controller 102 is configured to control the functioning or operation of the apparatus 100. For example, based on the data from the detector 104 or the actuator assembly 106, the controller 102 sends a control command to the user interface 116 to render a graphic representative of the data, or sends a control command to the actuator assembly 106 to operate the object manipulator 110.

In some embodiments, for example, the controller 102 is mounted to the towing vehicle 13 such that the controller 102 is protected from the elements. In some embodiments, for example, the controller 102 is mounted under the cab of the towing vehicle 13. In some embodiments, for example, the controller 102 is mounted on the frame of the towing vehicle 13, for example, a crossbar 42B.

In some embodiments, for example, the detector 104 is operably coupled to the controller 102, for example, via wired or wireless communication, to transmit the detected data to the controller 102. In some embodiments, for example, the detector 104 includes a sensor subsystem, which includes one or more sensors, for example, sensors 104A to 104D. In some embodiments, for example, the detector 104 is configured to detect, independently: (i) the coupling or uncoupling of the towing vehicle 13 and the trailer 12, (ii) the coupling or uncoupling of the end effector 700 and the first adapter counterpart 302, (iii) the disposition of the end effector 700 and the first adapter counterpart 302 in a relative movement interference relationship or relative movement effectible relationship, (iv) the coupling or uncoupling of the first adapter counterpart 302 and the second adapter counterpart 350, (v) the disposition of the first adapter counterpart 302 and the second adapter counterpart 350 in a relative movement interference relationship or relative movement effectible relationship, (vi) the establishment or defeating of operable communication of the first adapter counterpart 302 and the second adapter counterpart 350, (vii) establishment or defeating of abutting engagement of the trailer engaging surface 404 to the bottom surface 51 of the trailer 12, (viii) the vertical displacement of the end effector alignment effector 500 tor transitioning the end effector alignment effector 500 to the alignment effector extended configuration, (ix) establishment or defeating of abutting engagement of the engagement surface 706A or the engagement surface 706B to the front surface 52 of the trailer 12, and (x) the capacity of the one or more energy storage devices of the towing vehicle 13. In some embodiments, for example, the detector 104 is configured to detect whether the first adapter counterpart 302 and the second adapter counterpart 350 are disposed in operable communication. In some embodiments, for example, the detector 104 is configured to detect whether the end effector 700 and the first adapter counterpart 302, for example, the coupler 704 and the first adapter counterpart 302, are releasably coupled via the first connector counterpart 232 and the second connector counterpart 315.

In some embodiments, one or more of the sensors of the detector 104 are wireless sensors that are configured for wireless communication with the controller 102.

In some embodiments, the apparatus 100 is configured to be in electrical communication with a power source, such as a battery or fuel cell. In some embodiments, the apparatus 100 is disposable in electrical communication with an external power source, such as a portable battery, portable generator, external battery, and the like. In some embodiments, for example, the apparatus 100 is wirelessly connectable to the external power source for wirelessly energizing the apparatus 100. In some embodiments, for example, the apparatus 100 is powered by the electrical energy storage device of the towing vehicle 13, such as the battery of the towing vehicle 13.

In some embodiments, the apparatus 100 includes a user interface 116 that is configured to enable the controller 102 to interconnect with one or more input devices, such as user equipment, a keyboard, mouse, camera, touch screen and a microphone, or with one or more output devices such as a display screen and a speaker. In some embodiments, the controller 102 is configured to send a control command to the user interface 116 for displaying a graphical representation of data that is detected or sensed by the detector 104. In some embodiments, the user interface 116, via input from a user, is configured to send a control command to the controller 102 for controlling the apparatus 100. In some embodiments, for example, a user can input a control command to the controller 102 to via the user interface 116 to begin or end operation of the apparatus 100.

In some embodiments, for example, the controller 102 sends a control command to the user interface 116 to generate a graphical representation of the operating status of the apparatus 100. In some embodiments, for example, the controller 102 sends a control command to the user interface 116 to generate a graphical representation of a menu of options, and the user can input a control command using the user interface 116 to select an option from the menu, and the user interface 116 sends the control command to the controller 102 to control the operation of the apparatus 100.

The apparatus 100 includes an actuator assembly 106 that is disposed in operable communication with the controller 102. In some embodiments, for example, the actuator assembly 106 includes one or more actuators 106A to 106E and 808. The actuator assembly 106 is activatable to displace the object manipulator 110 and to effect releasable coupling and releasing of the first adapter counterpart 302 by the end effector 700 of the object manipulator 110. In some embodiments, while the end effector 700 and the first adapter counterpart 302 are coupled, the actuator assembly 106 is activatable to displace the first adapter counterpart 302 via the object manipulator 110. In some embodiments, for example, the controller 102 is configured to activate one or more actuators of the actuator assembly 106 to coordinate the displacement of the object manipulator 110 and to effect the releasable coupling and releasing of the first adapter counterpart 302 by the end effector 700 of the object manipulator 110, and to defeat the releasable coupling of the first adapter counterpart 302 and the second adapter counterpart 350.

In some embodiments, for example, the actuator assembly 106 includes a linear actuator. In some embodiments, for example, the actuator assembly 106 includes a rotating actuator. In some embodiments, for example, the actuator assembly 106 includes an electrical actuator. In some embodiments, for example, the actuator assembly 106 includes a pneumatic actuator. In some embodiments, for example, the actuator assembly 106 includes a hydraulic actuator. In some embodiments, for example, the displacement of the object manipulator 110 via activation of the actuator assembly 106 includes extension, retraction, displacement, rotation, and pivoting of the object manipulator 110.

In some embodiments, for example, each one of the actuators of the actuator assembly 106, independently, is configured to send data representative of its operational state (e.g. activated, deactivated, or degree of activation) to the controller 102 for the controller 102 to control the operation of the object manipulator 110.

In some embodiments, for example, the actuators of the actuator assembly 106 of the apparatus 100 are mounted on the object manipulator 110 and are disposed in operable communication with the object manipulator 110.

In some embodiments, for example, as depicted in FIG. 1, the connection apparatus 100 includes an object manipulator 110.

In some embodiments, for example, the object manipulator 110 includes a movable or pivotable platform 400 and an end effector alignment effector 500. In some embodiments, for example, the end effector alignment effector 500 includes an end effector supporter 600 and an end effector 700. The end effector 700 includes a coupler supporter 702 that supports a coupler 704, which is configured to releasably couple with the first adapter counterpart 302. The platform 400 is configured to support the end effector alignment effector 500. The supporting of the end effector alignment effector 500 by the platform 400 is such that the end effector alignment effector 500 is disposed within a frame 402 of the platform 400. The end effector supporter 600 is configured to support the end effector 700.

As depicted in FIG. 1, the coupler 704 is couplable or connectible to the first adapter counterpart 302, such that, while the coupler 704 and the first adapter counterpart 302 are coupled or connected, a coupled object manipulator 110 is established. In some embodiments, for example, the coupler 704 is coupled to the first adapter counterpart 302 such that a coupled end effector 700 is established. In some embodiments, for example, while the first adapter counterpart 302 is coupled to the coupler 704 of the object manipulator 110, the object manipulator 110 is configured to dispose the first adapter counterpart 302 and the second adapter counterpart 350 in an operable communication-effectible alignment, as depicted in FIG. 2, wherein the first adapter counterpart 302 and the second adapter counterpart 350 are disposed in an alignment relationship. In the aligned relationship, the first adapter counterpart 302 is disposed in alignment with the second adapter counterpart 350, for establishing connection between the first adapter counterpart and the second adapter counterpart 350, via displacement of the first adapter counterpart 302 towards the second adapter counterpart 350. Operable communication between the first adapter counterpart 302 and the second adapter counterpart 350 is effected in response to connection of the first adapter counterpart 302 and the second adapter counterpart 350. In some embodiments, for example, while first adapter counterpart 302 and the second adapter counterpart 350 are disposed in the operable communication-effectible alignment, the first adapter counterpart 302 and the second adapter counterpart 350 are aligned along an axis 360 that is parallel to the central longitudinal axis 18 of the trailer 12. In some embodiments, for example, the axis 360 is a linear axis.

In some embodiments, for example, the coupler 704 and the first adapter counterpart 302 are connectible, and the connection of the coupler 704 and the first adapter counterpart 302 is retainable, via the first connector counterpart 232 of the coupler 704 and the second connector counterpart 315 of the first adapter counterpart 302. In some embodiments, for example, the retention of the connection between the coupler 704 and the first adapter counterpart 302 is defeatable, such that the connection between the coupler 704 and the first adapter counterpart 302 is defeatable. In some embodiments, for example, the first adapter counterpart 302 and the second adapter counterpart 350 are connectible, and the connection of the first adapter counterpart 302 and the second adapter counterpart 350 is retainable, via friction established between: (i) the electrical connectors 308 of the first adapter counterpart 302 and the electrical ports 3080 of the second adapter counterpart 350, (ii) the fluid connectors 310 of the first adapter counterpart 302 and the fluid ports 3100 of the second adapter counterpart 350, and (iii) data connectors 314 of the first adapter counterpart 302 and the data ports 3140 of the second adapter counterpart 350. In some embodiments, for example, the first adapter counterpart 302 and the second adapter counterpart 350 are further connectible, and the connection of the first adapter counterpart 302 and the second adapter counterpart 350 is further retainable, via friction established between the guide pins 312 of the first adapter counterpart 302 and the guide ports 3120 of the second adapter counterpart 350. In some embodiments, for example, the retention of the connection between the first adapter counterpart 302 and the second adapter counterpart 350 is defeatable, such that the connection between the first adapter counterpart 302 and the second adapter counterpart 350 is defeatable.

FIG. 1 depicts the towing vehicle 13 connected to the trailer 12 via the fifth wheel 15 and kingpin 14. As depicted, the object manipulator 110 is mounted to the frame 40 of the towing vehicle 13, wherein the object manipulator 110 is disposed in a manipulator retracted configuration, the end effector alignment effector 500 is disposed in an alignment effected retracted configuration, the end effector 700 is disposed in an end effector retracted configuration, and the coupler 704 is disposed in an coupler retracted configuration. While the object manipulator 110 is disposed in the manipulator retracted configuration, the object manipulator 110 is disposed within the frame 40 of the towing vehicle 13, below of the swing radius 21 of the trailer 12, for example, the swing radius 21 of the front corners of the trailer 12, and there is an absence of engagement between the platform 400 and a bottom surface 50 of the trailer 12, wherein the bottom surface 50 is defined by the base plate 51 of the trailer 12.

In some embodiments, for example, while the object manipulator 110 is disposed in the manipulator retracted configuration, the disposition of the platform 400 within the frame 40 of the towing vehicle 13 is such that the platform 400 is nested within the frame 40 of the towing vehicle 13. While the object manipulator 110 is disposed in the manipulator retracted configuration, the disposition of the platform 400 within the frame 40 of the towing vehicle 13 is such that the platform 400 is nested within a recess 41 within the frame 40 of the towing vehicle 13. While the end effector alignment effector 500 is disposed in the alignment effector retracted configuration, the end effector alignment effector 500 is disposed within the frame 402 of the platform 400, in particular, within an alignment effector receiving space 406 defined by the frame 402, such that the end effector alignment effector 500 is nested within the alignment effector receiving space 406. While the end effector 700 is disposed in the end effector retracted configuration, the end effector 700 is disposed forwardly of a front surface 52 of the trailer 12, the front surface 52 defined by a front wall 53 of the trailer 12, and there is an absence of contact engagement between the end effector 700 and the front surface 52 of the trailer 12. While the coupler 704 is disposed in the coupler retracted configuration, and while the coupler 704 is coupled to the first adapter counterpart 302, there is an absence of operable communication between the first adapter counterpart 302 and the second adapter counterpart 350. While the coupler 704 is disposed in the coupler retracted configuration, the coupler 704 is disposed at a front end of the coupler supporter 702.

In some embodiments, for example, while the object manipulator 110 is mounted to the frame 40 of the towing vehicle 13, at least a portion of the platform 400 is disposed below the base plate 51 of the trailer 12, and the end effector alignment effector 500 is disposed forward of the front surface 52 of the trailer 12.

In some embodiments, for example, the object manipulator 110 is mounted to the frame 40 such that it is disposed forwardly of the fifth wheel 15 of the towing vehicle 13, and between the fifth wheel 15 and the cab of the towing vehicle 13.

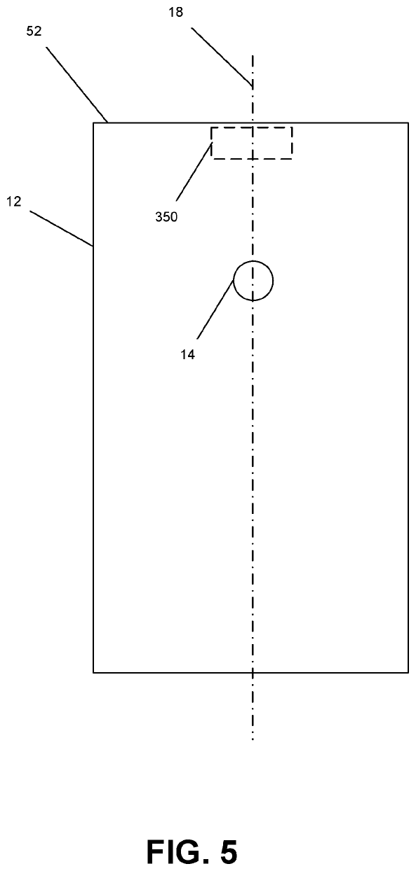

As depicted in FIG. 5 and FIG. 18, the second adapter counterpart 350 is mounted under the floor 16 and disposed within the subfloor 17 of the trailer 12. In some embodiments, for example, the subfloor 17 of the trailer 12 is defined between: a floor 16 of the trailer defining a support surface that is configured to support cargo disposed within the trailer 12, and the base plate 51. As depicted in FIG. 5, the mounting of the second adapter counterpart 350 (drawn in dashed line) is such that the second adapter counterpart 350 is aligned with the center of the kingpin 14 along the central longitudinal axis 18 of the trailer 12. In this respect, as depicted in FIG. 5, the central longitudinal axis 18 of the trailer 12 is coincident with the center of the second adapter counterpart 350, and also coincident with the center of the kingpin 14. In some embodiments, for example, a central longitudinal axis of the second adapter counterpart 350, and the central longitudinal axis 18 of the trailer 12 are disposed in a parallel relationship.

In some embodiments, for example, it is desirable to mount the second adapter counterpart 350 under the floor 16 of the trailer 12 and within the subfloor 17 of the trailer 12, as it is relatively easy to retrofit existing trailers 12 to mount the second adapter counterpart 350 under the floor 16 and within the subfloor 17. In some embodiments, for example, it is relative easy to design a new trailer 12 to mount the second adapter counterpart 350 under the floor 16 and within the subfloor 17. Furthermore, in some embodiments, for example, by mounting the second adapter counterpart 350 under the floor 16 and within the subfloor 17, support structures disposed on the front wall 53 of the trailer 12, for supporting the cargo disposed within the trailer 12 in the event of a sudden stoppage of the trailer 12, do not have to be removed, adjusted, or re-designed. In addition, by mounting the second adapter counterpart 350 under the floor 16 and within the subfloor 17, the second adapter counterpart 350 is protected from the elements. In some embodiments, for example, it is undesirable to mount the second adapter counterpart 350 on the floor 16 of the trailer 12, as the second adapter counterpart 350 would be disposed within the trailer 12, wherein collision between the cargo of the trailer 12 and the second adapter counterpart 350 is effectible. Such collision between the cargo of the trailer 12 and the second adapter counterpart 350 is undesirable as it can damage the second adapter counterpart 350.

In some embodiments, for example, while the second adapter counterpart 350 is mounted to the trailer 12, the second adapter counterpart 350 is facing in a forward direction, towards the front surface 52 of the trailer 12. In some embodiments, it is desirable to mount the second adapter counterpart 350 to the trailer 12 such that the second adapter counterpart 350 is facing in a forward direction, as it is relatively easy to cut a bottom portion of the front wall 53 of the trailer 12 to define an opening 54, through which the first adapter counterpart 302 is displaceable for establishing operable communication between the first adapter counterpart 302 and the second adapter counterpart 350. In some embodiments, for example, the bottom portion of the front wall 53 of the trailer 12 includes a panel 55 that conceals the subfloor 17, as depicted in FIG. 1. In some embodiments, for example, it is relatively easy to cut the panel 55 to define the opening 54. In some embodiments, for example, the front surface 52 of the trailer 12 includes the front surface 56 of the panel 55. In some embodiments, for example, the connection of the second adapter counterpart 350 to the first adapter counterpart 302 is effectible via the opening 54 defined on the front surface 52 of the trailer 12. In some embodiments, for example, the opening 54 is configured for receiving the first adapter counterpart 302 for effectuating the connection of the second adapter counterpart 350 and the first adapter counterpart 302. In some embodiments, for example, it is undesirable to mount the second adapter counterpart 350 to the trailer 12 such that the second adapter counterpart 350 is facing in a downward direction, as it is undesirable to cut the base plate 51 of the trailer 12 to define the opening 54. In some embodiments, for example, the base plate 51 of the trailer 12 is the thickest part of the trailer 12. In some embodiments, for example, the base plate 51 of the trailer 12 is defined by a steel plate that has a thickness, for example, of ⅝″.

In some embodiments, for example, the mounting of the second adapter counterpart 350 to the trailer 12 is such that the second adapter counterpart 350 is disposed rearwardly of the front surface 52 of the towing vehicle 12, and there is an absence of disposition of at least a portion of the second adapter counterpart 350 forwardly of the front surface 52 of the trailer 12. In some embodiments, for example, the mounting of the second adapter counterpart 350 to the trailer 12 is such that the entirety of the second adapter counterpart 350 is disposed rearwardly of the front surface 52 of the towing vehicle 12.

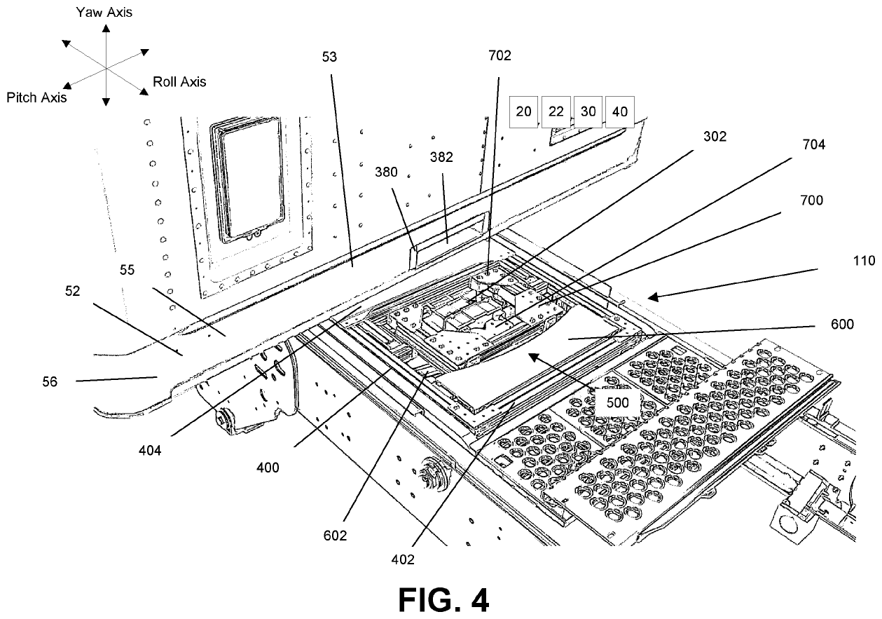

In some embodiments, for example, the mounting of the second adapter counterpart 350 under the floor 16 and within the subfloor 17, is effectuated by a counterpart frame 380, as depicted in FIG. 2 and FIG. 4. The frame 380 defines an opening 382, through which the first adapter counterpart 302 is displaceable for establishing operable communication between the first adapter counterpart 302 and the second adapter counterpart 350. In some embodiments, for example, the opening 382 and the opening 54 are disposed in alignment, for example, axial alignment. In some embodiments, for example, the connection of the second adapter counterpart 350 to the first adapter counterpart 302 is effectible via the opening 382. In some embodiments, for example, the opening 382 is configured for receiving the first adapter counterpart 302 for effectuating the connection of the second adapter counterpart 350 and the first adapter counterpart 302.

In some embodiments, for example, the frame 380 includes flanges 384 that are configured to connect to the front surface 52 of the trailer 12. While the flanges 384 are connected to the front surface 52 of the trailer 12, the flanges 384 are flush with the front surface 52 of the trailer 12.

In some embodiments, for example, the frame 380 includes an extended portion 386 that is configured to extend through the opening 54 and be disposed within the subfloor 17. The second adapter counterpart 350 is configured to connect to the extended portion 386, for example, via mechanical fasteners. While the second adapter counterpart 350 is connected to the extended portion 386, the second adapter counterpart 350 is aligned with the center of the kingpin 14 along the central longitudinal axis 18 of the trailer 12, with the electrical ports 3080, fluid connectors 310, data ports 3140, and guide ports 3140 are facing the front surface 52 and aligned with the central longitudinal axis 18 of the trailer 12, as depicted in FIG. 2.

In some embodiments, for example, the extended portion 386 defines openings to allow the towing vehicle communicator-defined fluid conductors 1302, towing vehicle communicator-defined electrical conductors 1304, and the towing vehicle communicator-defined data conductors 1305 to extend out of the extended portion 386.

In some embodiments, for example, the extended portion 386 defines one or more drain ports for draining liquid and debris that enters the extended portion 386.

In some embodiments, for example, the frame 380 includes a protective cover for selectively establishing communication through the opening 382. In some embodiments, for example, the cover is coupled to the extended portion 386. In some embodiments, for example, the protective cover is configured to protect the second adapter counterpart 350 from the elements or unintentional engagement through the opening 382. In some embodiments, for example, the protective cover is transitionable between a closed configuration and an open configuration. In some embodiments, for example, while the object manipulator 110 is disposed in the manipulator retracted configuration 110, the cover is disposed in the closed configuration, wherein communication through the opening 382 is occluded by the cover. In some embodiments, for example, while the object manipulator 110 is disposed in the manipulator extended configuration 110, such that the trailer engaging surface 404 is disposed in abutting engagement with the bottom surface 52 of the trailer 12, the cover is disposed in the open configuration, wherein occlusion of the opening 382 by the cover is defeated, such that communication through the opening 382 with the second adapter counterpart 350 is effectible. In some embodiments, for example, the abutting engagement of the trailer engaging surface 404 with the bottom surface 51 of the trailer 12 is with effect that an actuator, for example, a lever arm, is actuated, for transitioning the protective cover from the closed configuration to the open configuration.

In some embodiments, for example, the cover is pivotably coupled to the extended portion 386 about a pivot. In some embodiments, for example, a spring 394 is coupled to cover 390, and biases the cover 390 to the closed configuration, to protect the second adapter counterpart 350 from the elements or unintentional engagement through the opening 382. In some embodiments, for example, while the first adapter counterpart 302 is aligned with the second adapter counterpart 350, and is being displaced towards the second adapter counterpart 350 to effectuate the connection between the first adapter counterpart 302 and the second adapter counterpart 350, the first adapter counterpart 302 applies a force to the cover, which overcomes the spring force applied to the cover by the spring, such that the cover is transitioned to the open configuration.

FIG. 4 depicts the towing vehicle 13 connected to the trailer 12 via the fifth wheel 15 and kingpin 14, such that a connected towing vehicle 13 and trailer 12 is established, with the towing vehicle 13 misaligned, relative to the trailer 12, for example, angularly misaligned, relative to the trailer 12, about the pitch axis (lateral axis; left-to-right axis), and also angularly misaligned about the yaw axis (vertical axis). In some embodiments, for example, the connection of the towing vehicle 13 connected to the trailer 12 via the fifth wheel 15 and kingpin 14 is with effect that the towing vehicle 13 and the trailer 12 are angularly aligned about the roll axis (longitudinal axis, such that the first adapter counterpart 302 and the second adapter counterpart 302 are disposed in angular alignment about the roll axis. As depicted, the object manipulator 110 is disposed in the manipulator retracted configuration, the end effector alignment effector 500 is disposed in the alignment effector retracted configuration, the end effector 700 is disposed in the end effector retracted configuration, and the coupler 704 is disposed in the coupler retracted configuration. As depicted, there is an absence of connection between the first adapter counterpart 302 and the second adapter counterpart 350.

In some embodiments, for example, the misalignment between the towing vehicle 13 and the trailer 12 is due to surface grade, pit docks, the models of the towing vehicle 13 and the trailer 12, trailer's landing gear, tire pressure of the towing vehicle 13 or the trailer 12, parked position of the trailer 12, access position of the towing vehicle 13 to the trailer 12, and the like.

As depicted in FIG. 4, the object manipulator 110 is releasably coupled the first adapter counterpart 302, for example, via the coupler 704, such that the coupled object manipulator 110 is established. As depicted, the coupled object manipulator 110 is disposed in the coupled object manipulator retracted configuration. The towing vehicle 13 is configured to co-operate with the trailer 12 such that, while the coupled object manipulator 110 is disposed in the coupled object manipulator retracted configuration, the first adapter counterpart 302 and the second adapter counterpart 350 are co-operatively disposed in a misaligned relationship, wherein, in the misaligned relationship, there is an absence of alignment between the first adapter counterpart 302 and the second adapter counterpart 350. In some embodiments, for example, said misalignment of the first adapter counterpart 302 and the second adapter counterpart 350 is due, in part, by the misalignment of the towing vehicle 13 and the trailer 12.

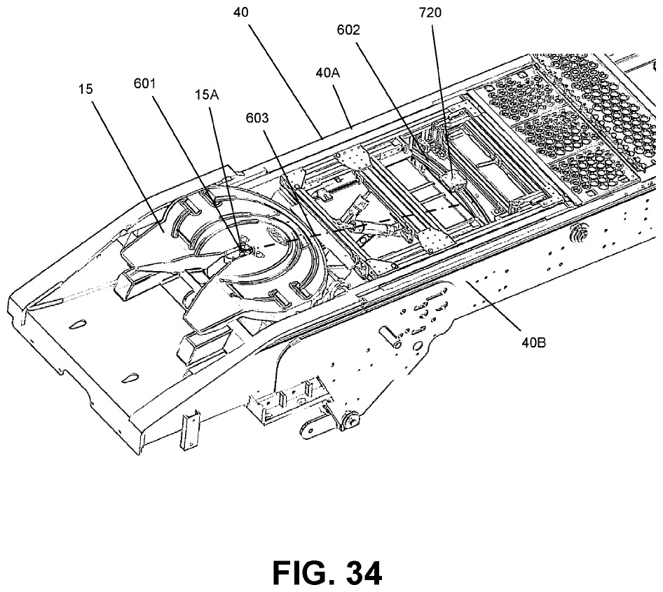

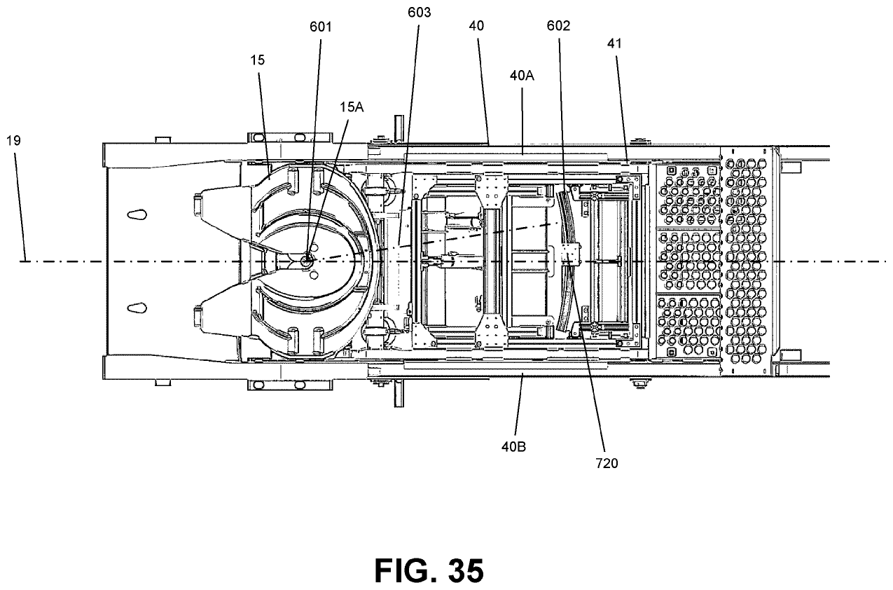

In some embodiments, for example, the towing vehicle 13 is configured to co-operate with the trailer 12 such that, while the coupled object manipulator 110 is disposed in the coupled object manipulator retracted configuration, the coupled object manipulator 110 is nested within the frame 40 of the towing vehicle 13. In some embodiments, for example, while the coupled object manipulator 110 is disposed in the coupled object manipulator retracted configuration, the nesting of the object manipulator within the frame of the vehicle is such that the coupled object manipulator 110 is nested within the recess 41 defined within the frame 40 of the towing vehicle. In some embodiments, for example, the recess 41 is defined between opposing frame members 40A and 40B of the frame 40, as depicted in FIG. 34 and FIG. 35.

In some embodiments, for example, the towing vehicle 13 is configured to co-operate with the trailer 12 such that, while the coupled object manipulator 110 is disposed in the coupled object manipulator retracted configuration, the coupled object manipulator 110 is disposed below a swing radius 21 of the trailer 12, for example, the swing radius 21 of the trailer corners.

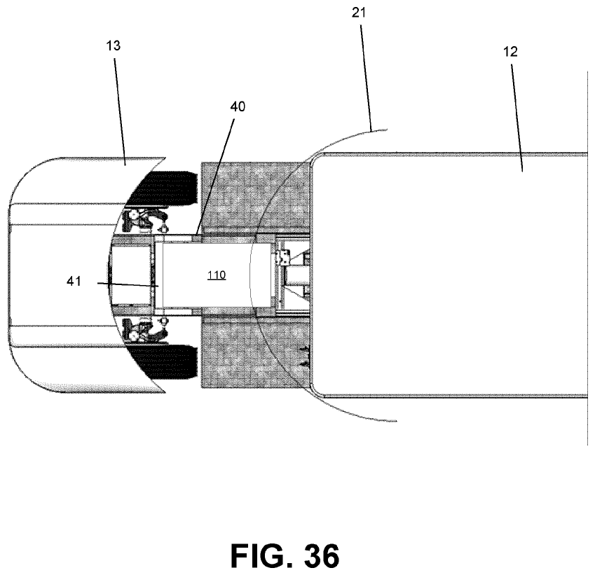

In some embodiments, for example, as depicted in FIG. 36, while the towing vehicle 13 and the trailer 12 are connected, for example, via the fifth wheel 15 and kingpin 14, the towing vehicle 13 and the trailer 12 are rotatable, relative to each other, about the connection of the towing vehicle 13 and trailer 12. In some embodiments, for example, the towing vehicle 13 and trailer 12 rotate, relative to each other, as the towing vehicle 13 turns in a left or right direction during operation of the towing vehicle 13. In some embodiments, for example, while the towing vehicle 13 and the trailer 12 are connected, and during operation of the towing vehicle 13, one of the front corners of the trailer 12 overlaps the frame 40 of the towing vehicle 13, to which the object manipulator 110 is mounted. Accordingly, while the towing vehicle 13 and the trailer 12 are connected, and during operation of the towing vehicle 13, it is desirable for the coupled object manipulator 110 to be disposed in the coupled object manipulator retracted configuration, such that there will be an absence of collision between the object manipulator 110 and the trailer 12, to prevent damage to the object manipulator 110.

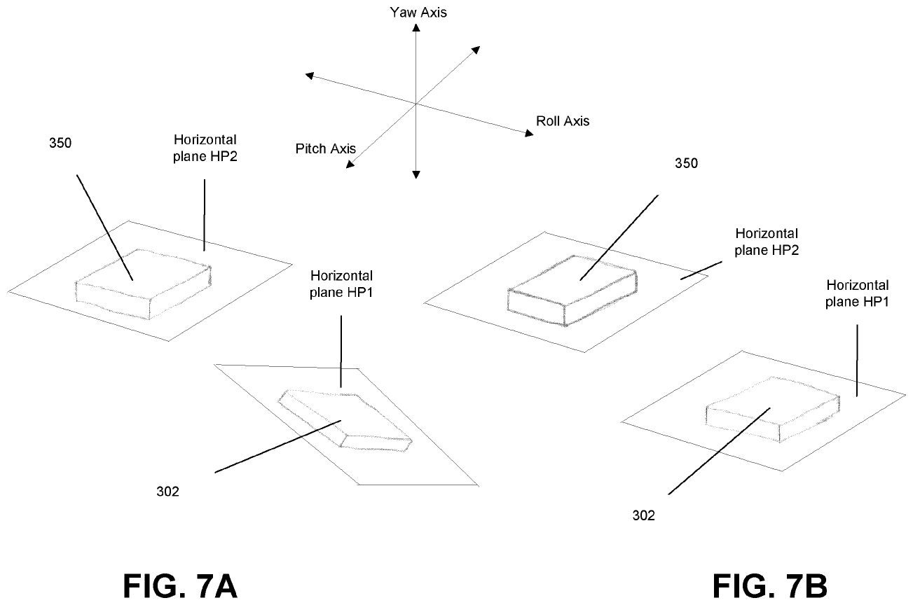

The misalignment between the connected towing vehicle 13 and trailer 12 is such that, while: (i) the object manipulator 110 is disposed in the manipulator retracted configuration, (ii) the effector alignment effector 500 is disposed in the alignment effector retracted configuration, (iii) the end effector 700 is disposed in the end effector retracted configuration, (iv) the coupler 704 is disposed in an coupler retracted configuration, and (v) the first adapter counterpart 302 is coupled to the coupler 704, the first adapter counterpart 302 and the second adapter counterpart 350 are angularly misaligned, for example, about the pitch axis (lateral axis; left-to-right axis), axially misaligned about the pitch axis, and angularly misaligned about the yaw axis (vertical axis). As depicted in FIG. 7A, while: (i) the towing vehicle 13 is connected to the trailer 12, wherein the towing vehicle 13 angular misaligned, relative to the trailer 12, about the pitch axis (lateral axis; left-to-right axis), and also about the yaw axis (vertical axis), (ii) the object manipulator 110 is disposed in the manipulator retracted configuration, (iii) the end effector alignment effector 500 is disposed in the alignment effector retracted configuration, (iv) the end effector 700 is disposed in the end effector retracted configuration, (v) the coupler 704 is disposed in an coupler retracted configuration, and (vi) the first adapter counterpart 302 is coupled to the coupler 704, the first adapter counterpart 302 is disposed on a horizontal plane HP1 and the second adapter counterpart 350 is disposed on a horizontal plane HP2, wherein the horizontal plane HP1 and the horizontal plane HP2 are non-parallel.

In some embodiments, for example, the connection of the towing vehicle 13 and the trailer 12 via the fifth wheel 15 and the kingpin 14 is such that the frame 40 of the towing vehicle 13 is disposed below the trailer 12. In this respect, in some embodiments, for example, while: (i) the towing vehicle 13 and the trailer 12 are connected via the fifth wheel 15 and the kingpin 14, (ii) the object manipulator 110 is disposed in the manipulator retracted configuration, (iii) the effector alignment effector 500 is disposed in the alignment effector retracted configuration, (iv) the end effector 700 is disposed in the end effector retracted configuration, (v) the coupler 704 is disposed in an coupler retracted configuration, and (vi) the first adapter counterpart 302 is coupled to the coupler 704, the first adapter counterpart 302 and the second adapter counterpart 350 are axially misaligned about the yaw axis (vertical axis).

In some embodiments, for example, the connection of the towing vehicle 13 and the trailer 12 via the fifth wheel 15 and the kingpin 14 is such that the end effector alignment effector 500 is disposed forward of the front surface 52 of the trailer 12. In this respect, in some embodiments, for example, while: (i) the towing vehicle 13 and the trailer 12 are connected via the fifth wheel 15 and the kingpin 14, (ii) the object manipulator 110 is disposed in the manipulator retracted configuration, (iii) the effector alignment effector 500 is disposed in the alignment effector retracted configuration, (iv) the end effector 700 is disposed in the end effector retracted configuration, (v) the coupler 704 is disposed in an coupler retracted configuration, and (vi) the first adapter counterpart 302 is coupled to the coupler 704, the first adapter counterpart 302 and the second adapter counterpart 350 are axially misaligned about the roll axis (longitudinal axis; front to back axis).

In some embodiments, for example, as described in greater detail below, while the coupled end effector 700 is established, the platform 400 and the end effector alignment effector 500, which includes the end effector supporter 600, function as a guide to guide the displacement of the coupled end effector 700 to align the first adapter counterpart 302 and the second adapter counterpart 350, such that the first adapter counterpart 302 and the second adapter counterpart 350 become disposed in an alignment relationship for establishing connection between the first adapter counterpart 302 and the second adapter counterpart 350.

In some embodiments, for example, the towing vehicle 13 is configured to co-operate with the trailer 12 such that: while: (i) the coupled end effector 700 is established, (ii) the first adapter counterpart 302 and the second adapter counterpart 350 are co-operatively disposed in a misaligned relationship, wherein, in the misaligned relationship, there is an absence of alignment between the first adapter counterpart 302 and the second adapter counterpart 350, and (iii) the object manipulator 110 is disposed in a guiding-effective relationship with the trailer 12, wherein, in the guiding-effective relationship, contact engagement between the object manipulator 110 and the trailer 12 is effectible, for example, contact engagement between the object manipulator 110 and the front surface 52 and the bottom surface 50 of the trailer 12:
while the object manipulator 110 is disposed in contact engagement with the trailer 12, for example, the surface 52 and the bottom surface 50, in response to a force applied to the object manipulator 110 for urging displacement of the object manipulator 110 towards the trailer 12, for example, the front wall 53 and base plate 51, an alignment reaction force is applied by the trailer 12, for example, the front surface 52 and bottom surface 50, to the object manipulator 110 to urge displacement of the object manipulator 110, with effect that an alignment relationship-obtaining displacement of the coupled end effector 700, relative to the second adapter counterpart 350, is effectuated by the alignment reaction force, wherein the alignment relationship-obtaining displacement is guided by the guide (e.g. the platform 400 and end effector supporter 600), wherein the guided displacement is effective for emplacing the first adapter counterpart 302 in alignment with the second adapter counterpart 350, such that the first adapter counterpart 302 and the second adapter counterpart 350 become disposed in an alignment relationship for establishing connection between the first adapter counterpart 302 and the second adapter counterpart 350. In some embodiments, for example, the alignment reaction force includes a platform-urging reaction force and an end effector-urging reaction force, as described in greater detail herein.

In some embodiments, for example, the object manipulator 110 is disposed in the guiding-effective relationship with the trailer 12 while the fifth wheel coupling 15 and the kingpin 14 are coupled.

To angularly align the first adapter counterpart 302 and the second adapter counterpart 350 about the pitch axis, the object manipulator 110 is transitioned from the manipulator retracted configuration to a manipulator extended configuration.

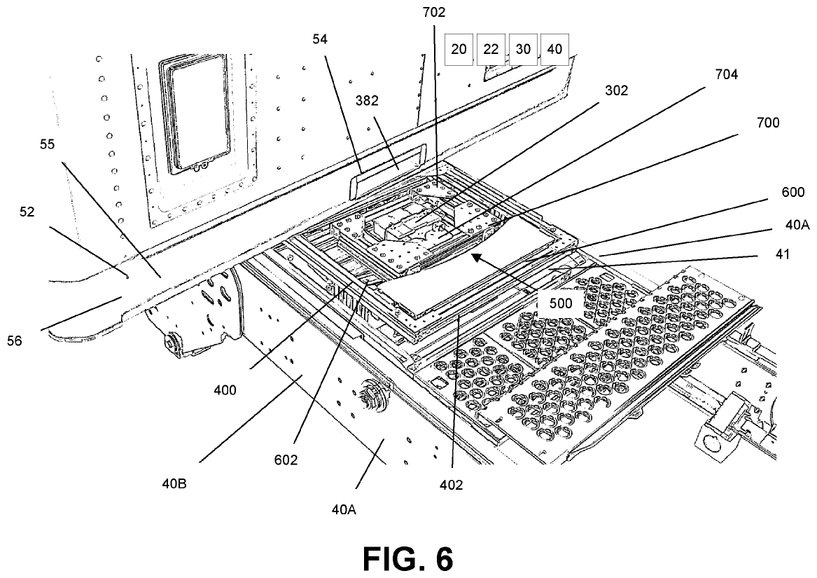

FIG. 6 depicts the object manipulator 110 disposed in the manipulator extended configuration. In some embodiments, for example, while the object manipulator 110 is disposed in the manipulator extended configuration, the first adapter counterpart 302 and the second adapter counterpart 350 are angularly aligned about the pitch axis.

In some embodiments, for example, the towing vehicle 13 is configured to co-operate with the trailer 12 such that: while: (i) the coupled end effector 700 is established, (ii) the first adapter counterpart 302 and the second adapter counterpart 350 are co-operatively disposed in a misaligned relationship, wherein, in the misaligned relationship, there is an absence of alignment between the first adapter counterpart 302 and the second adapter counterpart 350, and (iii) the object manipulator 110 is disposed in a guiding-effective relationship with the trailer 12, wherein, in the guiding-effective relationship, contact engagement between the pivotable platform 400 and the trailer 12, for example, the bottom surface 50 defined by the base plate 51, is effectible: the object manipulator 110 is displaced towards the trailer 12, for example, in an upwards direction towards the bottom surface 50. In some embodiments, for example, the displacement of the object manipulator 110 in the upward direction is such that the platform 400 and end effector alignment effector 500 (which includes the end effector supporter 600 and end effector 700), together, displace in the upwards direction. The displacement of the object manipulator 110 towards the trailer 12, for example, in an upwards direction towards the bottom surface 50, is with effect that the platform 400 becomes disposed in contact engagement with the bottom surface 50.

The pivotable platform 400 and the trailer 12 are co-operatively configured such that, while the pivotable platform 400 is disposed in contact engagement with the trailer 12, for example, the bottom surface 50, in response to a platform-displacement force applied to the pivotable platform 400, for example, by actuators 106A and 106B, to urge displacement of the pivotable platform 400 towards the trailer 12, for example, the bottom surface 50, a platform-urging reaction force is applied by the trailer 12, for example, the bottom surface 50, to the pivotable platform 400 to urge pivoting of the object manipulator 110, with effect that a pivoting of the coupled end effector 700, relative to the second adapter counterpart 350, is effectuated by the platform-urging reaction force. In some embodiments, for example, the pivoting is effective for emplacing the first adapter counterpart 302 in angular alignment with the second adapter counterpart 350 about a pitch axis. In some embodiments, for example, the pivoting of the coupled end effector 700 is for emplacing the first adapter counterpart 302 in alignment with the second adapter counterpart 350, such that the first adapter counterpart 302 and the second adapter counterpart 350 become disposed in an alignment relationship for establishing connection between the first adapter counterpart 302 and the second adapter counterpart 350.

In some embodiments, for example, the guide of the object manipulator 110 includes the pivotable platform 400.

In some embodiments, for example, the displacement of the first adapter counterpart 302, relative to the second adapter counterpart 350, for emplacing the first adapter counterpart 302 in alignment with the second adapter counterpart 350, such that the first adapter counterpart 302 and the second adapter counterpart 350 become disposed in the alignment relationship for establishing connection between the first adapter counterpart 302 and the second adapter counterpart 350, includes the displacement of the coupled end effector 700, for example, the pivoting and the vertical displacement of the coupled end effector 700, that is effectuated via the transitioning of the object manipulator 110 from the manipulator-retracted configuration to the manipulator extended configuration.

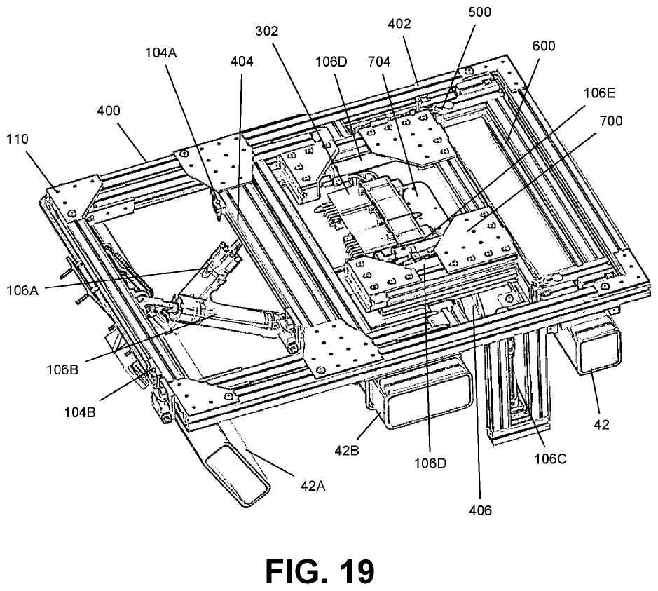

In some embodiments for example, while the object manipulator 110 is disposed in the manipulator extended configuration, the platform 400 is disposed in contact engagement, for example, abutting engagement with the base plate 51 of the trailer, for example, the bottom surface 50 of the trailer 12. In this respect, in some embodiments, for example, as depicted in FIG. 4 and FIG. 19, the platform 400 includes a trailer engaging surface 404. The trailer engaging surface 404 is configured to become disposed in contact engagement, for example, abutting engagement with the base plate 51 of the trailer 12. In some embodiments for example, while the object manipulator 110 is disposed in the manipulator extended configuration, the trailer engaging surface 404 is disposed in abutting engagement with the bottom surface 50 of the trailer 12. In some embodiments, for example, while the trailer engaging surface 404 is disposed in abutting engagement with the bottom surface 50 of the trailer 12, the trailer engaging surface 404 is parallel with the bottom surface 50 of the trailer 12. In some embodiments, for example, while the trailer engaging surface 404 is parallel with the bottom surface 50 of the trailer 12, the frame 402 is parallel with the bottom surface 50 of the trailer 12.

While the object manipulator 110 is disposed in the manipulator extended configuration, the trailer engaging surface 404 is disposed in abutting engagement with the base plate 51 of the trailer 12. The disposition of the trailer engaging surface 404 in abutting engagement with the base plate 51 of the trailer 12 is with effect that the platform 400 becomes disposed in parallel with the bottom surface 50 of the trailer 12, such that the first adapter counterpart 302 and the second adapter counterpart 350 become angularly aligned about the pitch axis (lateral axis; left-to-right axis).

In some embodiments, for example, while the object manipulator 110 is mounted to the frame 40 of the towing vehicle 13, at least a portion of the trailer engaging surface 404 and the bottom surface 50 of the trailer 12 are disposed in opposing relationship. In some embodiments, for example, while the object manipulator 110 is mounted to the frame 40 of the towing vehicle 13, at least a portion of the trailer engaging surface 404 is disposed below the bottom surface 50 of the trailer 12.

In some embodiments for example, while the object manipulator 110 is disposed in the manipulator extended configuration, relative to its disposition in the manipulator-retracted configuration, the object manipulator 110 is disposed at a higher vertical position.

In some embodiments, for example, transitioning of the object manipulator 110 from the manipulator-retracted configuration to the manipulator extended configuration includes displacement of the object manipulator 110, relative to the frame 40 of the towing vehicle 13, in an upward direction. In this respect, in some embodiments, for example, the mounting of the object manipulator 110 to the frame 40 of the towing vehicle 13 is such that the object manipulator 110 is vertically displaceable, relative to the frame 40.

In some embodiments, for example, transitioning of the object manipulator 110 from the manipulator-retracted configuration to the manipulator extended configuration includes rotation of the object manipulator 110 about the pitch axis. In this respect, in some embodiments, for example, the mounting of the object manipulator 110 to the frame 40 of the towing vehicle 13 is such that the object manipulator 110 is rotatable, relative to the frame 40, about the pitch axis.

In some embodiments, for example, transitioning of the object manipulator 110 from the manipulator retracted configuration to the manipulator extended configuration includes displacement of the object manipulator 110, relative to the frame 40 of the towing vehicle 13, in a direction towards the trailer 12, for example, along the roll axis. In some embodiments, for example, the displacement of the object manipulator 110 towards the trailer 12, for example, along the roll axis, for effecting the transitioning of the object manipulator 110 from the manipulator retracted configuration to the manipulator extended configuration, is due to the angular misalignment of the towing vehicle 13 and the trailer 12 about the pitch axis. In this respect, in some embodiments, for example, the mounting of the object manipulator 110 to the frame 40 of the towing vehicle 13 is such that the object manipulator 110 is displaceable, relative to the frame 40, in a direction towards the trailer 12, for example, along the roll axis.

As depicted in FIG. 7B, while the object manipulator 110 is disposed in the manipulator extended configuration, the first adapter counterpart 302 is disposed on the horizontal plane HP1 and the second adapter counterpart 350 is disposed on the horizontal plane HP2, wherein the horizontal plane HP1 and the horizontal plane HP2 are parallel.

In some embodiments, for example, while the object manipulator 110 is transitioning from the manipulator retracted configuration to the manipulator extended configuration, the end effector alignment effector 500 remains disposed in the alignment effector retracted configuration, wherein the end effector alignment effector 500 is disposed within the frame 402 of the platform 400.

In some embodiments, for example, the displacement of the platform 400 towards the trailer 12, for example, towards the bottom surface 50, for example, to effectuate the transition of the object manipulator 110 from the manipulator retracted configuration to the manipulator extended configuration, is effected by actuation of an actuator 106A and an actuator 106B of the actuator assembly 106. In some embodiments, for example, the actuator 106A and 106B are pneumatic actuators. In some embodiments, for example, object manipulator 110 includes more than one actuator 106A, for example, two actuators 106A, and more than one actuator 106B, for example, two actuators 106B. In some embodiments, for example, the actuator 106A and 106B are actuated by the controller 102, in response to a process initiation signal, for example, a signal provided by an operator of the towing vehicle 13, or a signal representative of the coupling of the towing vehicle 13 and the trailer 12, or a signal representative of an absence of operable communication between the first adapter counterpart 302 and the second adapter counterpart 350. As depicted in FIG. 18 and FIG. 19, the actuator 106A is connected, at a first end, to a crossbar 42A of the frame 40, and at a second end, to the platform 400, such that relative displacement between the frame 40 and the platform 400 is effectuatable. Similarly, the actuator 106B is connected, at a first end, to a crossbar 42B of the frame 40, and at a second end, to the platform 400, such that relative displacement between the frame 40 and the platform 400 is effectuatable.

In some embodiments, for example, as depicted in FIG. 18, the connection of the actuators 106A and 106B to the crossbars 42 of the frame 40 and to the platform 400 is such that the actuators 106A and 106B are disposed in a scissor configuration, such that the transition of the object manipulator 110 from the manipulator retracted configuration to the manipulator extended configuration includes a scissor lift displacement, the scissor lift displacement effected by the actuators 106A and 106B.

In some embodiments, for example, while the object manipulator 110 is disposed in the manipulator retracted configuration, the platform 400 is rested on the crossbar 42A and the crossbar 42B.

In some embodiments, for example, as depicted in FIG. 19, sensors 104A and 104B, for example, proximity sensors, mounted to the platform 400, are configured to collect data representative of the proximity of the trailer engaging surface 404 relative to the bottom surface 50 of the trailer 12. Based on the data from the sensors 104A and 104B, the controller 102 determines that the trailer engaging surface 404 is disposed in abutting engagement with the bottom surface 50, for example, the base plate 51, of the trailer 12.

In some embodiments, for example, the apparatus 100 includes a displacement restrictor 900, configured to resist the rotation of the platform 400, relative to the frame 40 of the towing vehicle 13, about the roll axis, and also about the yaw axis. In some embodiments, for example, a first end of the displacement restrictor 900 is connected to the frame 40 of the towing vehicle 13, and a second end of the displacement restrictor 900 is connected to the platform 400.

To axially align the first adapter counterpart 302 and the second adapter counterpart 350 about the yaw axis (e.g. vertical axis), while the object manipulator 110 is disposed in the manipulator extended configuration, the end effector alignment effector 500 is transitioned from the alignment effector retracted configuration to an alignment effector extended configuration.

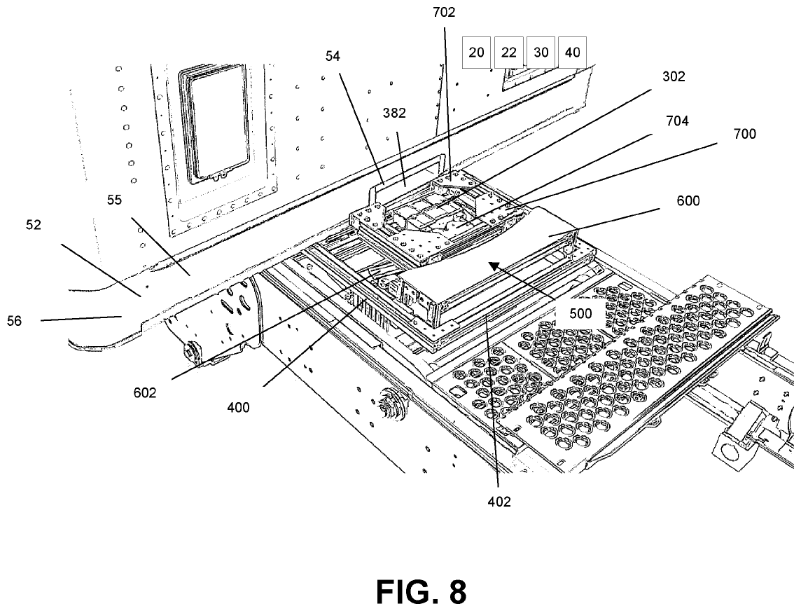

FIG. 8 depicts the end effector alignment effector 500 disposed in the alignment effector extended configuration. In some embodiments, for example, while the end effector alignment effector 500 is disposed in the alignment effector extended configuration, the first adapter counterpart 302 and the second adapter counterpart 350 are axially aligned about the yaw axis (e.g. vertical axis).

In some embodiments, for example, while the end effector alignment effector 500 is disposed in the alignment effector extended configuration, the end effector alignment effector 500 and the front surface 52 of the trailer 12 are disposed in opposing relationship.

In some embodiments, for example, while the end effector alignment effector 500 is disposed in the alignment effector extended configuration, relative to its disposition in the alignment effector retracted configuration, the end effector alignment effector 500 is disposed at a higher vertical position.

In some embodiments, for example, transitioning of the end effector alignment effector 500 from the alignment effector retracted configuration to the alignment effector extended configuration includes displacement of the end effector alignment effector 500, relative to the platform 400, in an upward direction. In this respect, in some embodiments, for example, the supporting of the end effector alignment effector 500 by the platform 400 is such that the end effector alignment effector 500 is displaceable, relative to the platform 400. In some embodiments, for example, the displaceability of the end effector alignment effector 500, relative to the platform 400, includes a vertical displaceability.

In some embodiments, for example, the displacement of the first adapter counterpart 302, relative to the second adapter counterpart 350, for emplacing the first adapter counterpart 302 in alignment with the second adapter counterpart 350, such that the first adapter counterpart 302 and the second adapter counterpart 350 become disposed in the alignment relationship for establishing connection between the first adapter counterpart 302 and the second adapter counterpart 350, includes the displacement of the coupled end effector 700, for example, the vertical displacement of the coupled end effector 700, that is effectuated via the transitioning of the end effector alignment effector 500 from the alignment effector retracted configuration to the alignment effector extended configuration.

In some embodiments, for example, the vertical displacement of the end effector alignment effector 500, for transitioning from the alignment effector retracted configuration to the alignment effector extended configuration, is predetermined, based on the mounting of the second adapter counterpart 350 to the trailer 12. In this respect, in some embodiments, for example, the mounting of the second adapter counterpart 350 to each one of a plurality of trailers 12 is such that, for each one of the plurality of trailers 12, the minimum spacing distance between the second adapter counterpart 350 and the bottom surface 50 of the trailer 12 is consistent. Such mounting is with effect that the vertical displacement of the end effector alignment effector 500, for transitioning from the alignment effector retracted configuration to the alignment effector extended configuration, is the same, for different models of towing vehicle 13 and trailer 12, for which the apparatus 100 is used to operable communicate the first adapter counterpart 302 and the second adapter counterpart 350. In some embodiments, for example, based on the determination by the controller 102 that the end effector alignment effector 500 is displaced by the predetermined vertical displacement, the controller 102 determines that the end effector alignment effector 500 is disposed in the alignment effector extended configuration.

In some embodiments, for example, the vertical displacement of the end effector alignment effector 500, for transitioning from the alignment effector retracted configuration to the alignment effector extended configuration, is predetermined, based on the specifications (e.g. dimensions) of the models of the towing vehicle 13 and the trailer 12 for which the apparatus 100 is used to operable communicate the first adapter counterpart 302 and the second adapter counterpart 350. In some embodiments, for example, based on the determination by the controller 102 that the end effector alignment effector 500 is displaced by the predetermined vertical displacement, the controller 102 determines that the end effector alignment effector 500 is disposed in the alignment effector extended configuration.

In some embodiments, for example, the vertical displacement of the end effector alignment effector 500, for transitioning from the alignment effector retracted configuration to the alignment effector extended configuration, is determined based on detection of a feature of the front surface 52 of the trailer 12, for example, a marker disposed on the front surface 52 of the trailer 12, on the flange 384 of the frame 380, or on the edge of the opening 382 defined by the frame 380 that is mounted to the front surface 52 of the trailer 12, through which the towing-defined adapter counterpart 350 is displaceable for effecting communication with the second adapter counterpart 350, by a sensor, for example, an optical sensor. In some embodiments, for example, based on data from the sensor, the controller 102 determines that the end effector alignment effector 500 is disposed in the alignment effector extended configuration.

In some embodiments, for example, the vertical displacement of the end effector alignment effector 500, for transitioning from the alignment effector retracted configuration to the alignment effector extended configuration, is effected by vertical displacement of the end effector supporter 600 together with the end effector 700.

In some embodiments, for example, the transition of the end effector alignment effector 500 from the alignment effector retracted configuration to the alignment effector extended configuration is effected by actuation of the actuator 106C. In some embodiments, for example, the actuator 106C is a pneumatic actuator. In some embodiments, for example, the object manipulator 110 includes more than one actuator 106C, for example, two actuators 106C. In some embodiments, for example, the actuator 106C is actuated by the controller 102, in response to determination by the controller 102 that the object manipulator 110 is disposed in the manipulator extended configuration, for example, in response to determination that the trailer engaging surface 404 is disposed in abutting engagement with the bottom surface 51 of the trailer 12. As depicted in FIG. 19, the actuator 106C is connected to the frame 402 of the platform 400 and also to the end effector supporter 600, such that relative displacement between the platform 400 and the end effector alignment effector 500 is effectuatable.

To: (i) angularly align the first adapter counterpart 302 and the second adapter counterpart 350 about the yaw axis (e.g. vertical axis), (ii) axially align the first adapter counterpart 302 and the second adapter counterpart 350 about the pitch axis (e.g. lateral axis; left to right axis), and (iii) axially align the first adapter counterpart 302 and the second adapter counterpart 350 about the roll axis (e.g. longitudinal axis; front to back axis) such that the first adapter counterpart 302 and the second adapter counterpart 350 become disposed in the operable communication-effectible alignment, while the end effector alignment effector 500 is disposed in the alignment effector extended configuration, the end effector 700 is transitioned from an end effector retracted configuration to an end effector alignment-ready configuration, and then transitioned from the end effector alignment-ready configuration to an end effector alignment-effective configuration.

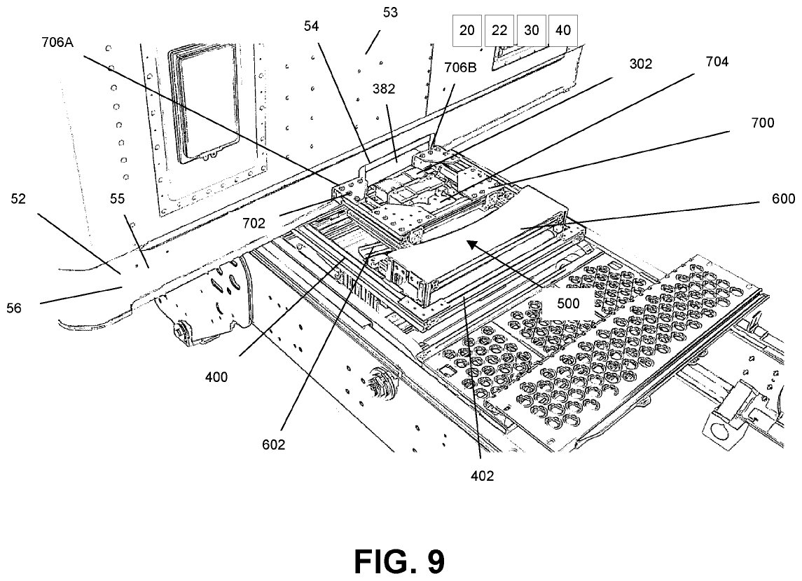

FIG. 8 depicts the end effector 700 disposed in the end effector retracted configuration, and FIG. 9 depicts the end effector 700 disposed in the end effector alignment-ready configuration. In some embodiments, for example, while the end effector 700 is disposed in the end effector retracted configuration, there is an absence of contact engagement between the end effector 700 and the front surface 52 of the trailer 12. In some embodiments, for example, while the end effector 700 is disposed in the end effector alignment-ready configuration, the coupler supporter 702 is disposed in contact engagement with the front wall 53 of the trailer 12, for example, disposed in contact engagement with the front surface 52 of the trailer 12.

In some embodiments, for example, transitioning of the end effector 700 from the end effector retracted configuration to the end effector alignment-ready configuration includes displacement of the coupler supporter 702, relative to the end effector supporter 600, towards the trailer 12. In some embodiments, for example, the transitioning of the end effector 700 from the end effector retracted configuration to the end effector alignment-ready configuration includes displacement of the coupler supporter 702, relative to the end effector supporter 600, and along an axis that is parallel to a longitudinal axis of the towing vehicle 13, towards the trailer 12. In this respect, in some embodiments, for example, the supporting of the end effector 700 by the end effector supporter 600 is such that the coupler supporter 702 is displaceable, relative to the end effector supporter 600, towards the trailer 12.

In some embodiments, for example, the displacement of the first adapter counterpart 302, relative to the second adapter counterpart 350, for emplacing the first adapter counterpart 302 in alignment with the second adapter counterpart 350, such that the first adapter counterpart 302 and the second adapter counterpart 350 become disposed in the alignment relationship for establishing connection between the first adapter counterpart 302 and the second adapter counterpart 350, includes the displacement of the coupled end effector 700, for example, the displacement of the coupler supporter 702 towards the trailer 12, that is effectuated via the transitioning of the end effector 700 from the end effector retracted configuration to the end effector alignment-ready configuration.

In some embodiments, for example, transitioning of the end effector 700 from the end effector retracted configuration to the end effector alignment-ready configuration includes displacement of the coupler supporter 702, relative to the end effector supporter 600, away from the end effector supporter 600, and towards the front surface 52 of the trailer 12, which, in some embodiments, for example, is defined by the front wall 53 of the trailer 12. In this respect, in some embodiments, for example, the supporting of the end effector 700 by the end effector supporter 600 is such that the coupler supporter 702 is displaceable, relative to the end effector supporter 600, away from the end effector supporter 600, and towards the front surface 52 of the trailer 12.

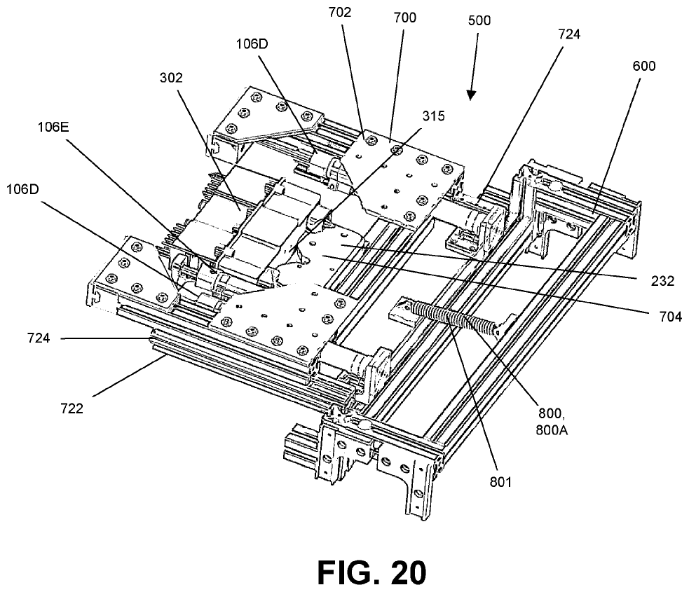

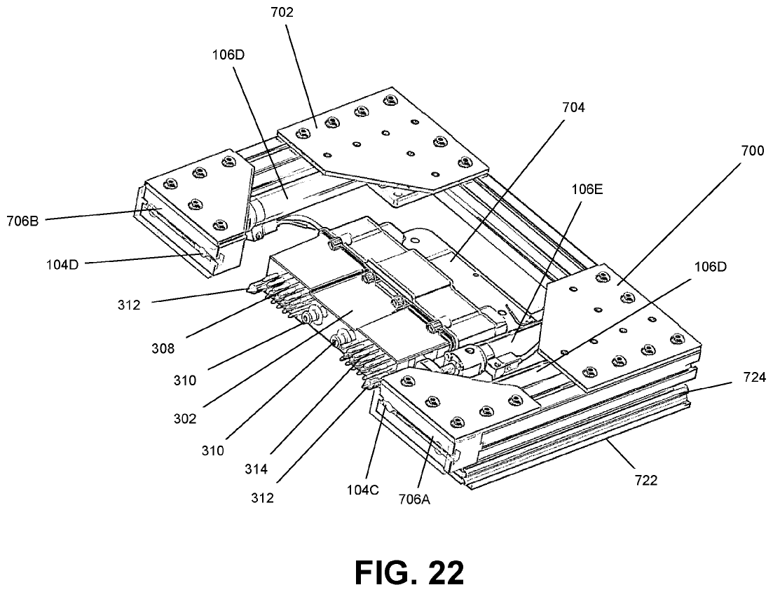

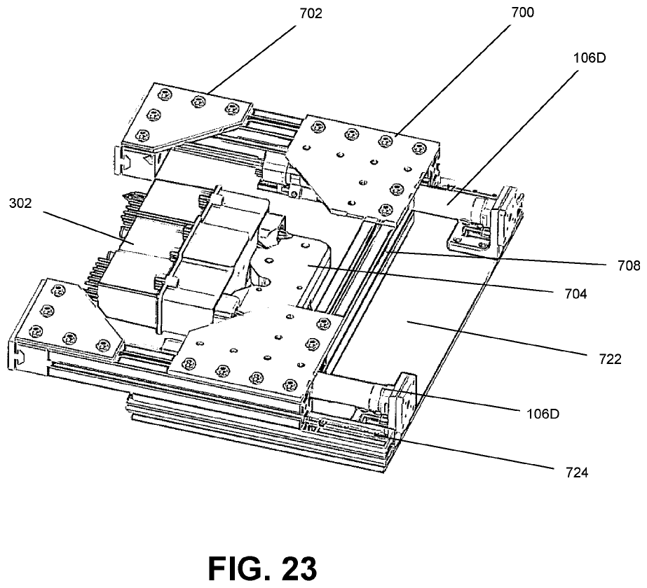

In some embodiments, for example, as depicted in FIG. 20, FIG. 22, and FIG. 23, to effect the displaceability of the coupler supporter 702, relative to the end effector supporter 600, away from the end effector supporter 600, and towards the front wall 53 of the trailer 12, the end effector 700 includes a mounting plate 722 that includes rails 724, wherein the coupler supporter 702 is slidably coupled to the rails 724 of the mounting plate 722. In some embodiments, for example, the rails 724 are configured to guide the displacement of the coupler supporter 702, relative to the mounting plate 722.

In some embodiments, for example, the displacement of the coupler supporter 702, relative to the end effector supporter 600, towards the front surface 52 of the trailer 12 for transitioning the end effector 700 from the end effector retracted configuration to the end effector alignment-ready configuration, includes displacement of the coupler supporter 702, relative to the mounting plate 722, towards the front surface 52 of the trailer 12. In some embodiments, for example, the displacement of the coupler supporter 702, relative to the mounting plate 722, is guided by the rails 724.

In some embodiments, for example, the displacement of the coupler supporter 702, relative to the end effector supporter 600, away from the end effector supporter 600, and towards the front surface 52 of the trailer 12, for transitioning the end effector 700 from the end effector retracted configuration to the end effector alignment-ready configuration, includes displacement of the coupler supporter 702, relative to the mounting plate 722 away from the end effector supporter 600, and towards the front surface 52 of the trailer 12. In some embodiments, for example, the displacement of the coupler supporter 702, relative to the mounting plate 722, is guided by the rails 724.

In some embodiments, for example, while the end effector 700 is disposed in the end effector alignment-ready configuration, relative to its disposition in the end effector retracted configuration, the coupler supporter 702 is disposed further from the end effector supporter 600 and closer to the front surface 52 of the trailer 12.

The transition of the end effector 700 from the end effector retracted configuration to the end effector alignment-ready configuration is effected by actuation of the actuators 106D. In some embodiments, for example, the actuators 106D are pneumatic actuators. In some embodiments, for example, the actuators 106D actuated by the controller 102, in response to determination by the controller 102 that the end effector alignment effector 500 is disposed in the alignment effector extended configuration. As depicted in FIG. 23, each one of the actuators 106D, independently, is connected, at a first end, to the mounting plate 722 of the end effector 700, and at a second end, to the coupler supporter 702 of the end effector 700, such that relative displacement between the coupler supporter 702 and the mounting plate 722 is effectuatable.

To transition the end effector 700 from the end effector retracted configuration to the end effector alignment-ready configuration, while the end effector 700 is disposed in the end effector retracted configuration, the actuators 106D are actuated to displace the coupler supporter 702, relative to the mounting plate 722, towards the front surface 52 of the trailer 12. The displacement of the coupler supporter 702, relative to the mounting plate 722, towards the front surface 52 of the trailer 12, is with effect that the coupler supporter 702 becomes disposed in contact engagement with the front wall 53 of the trailer 12, for example, the front surface 52 of the trailer 12. In this respect, in some embodiments, for example, the coupler supporter 702 defines a first engagement surface 706A and a second engagement surface 706B, as depicted in FIG. 22. In some embodiments, for example, the displacement of the coupler supporter 702, relative to the mounting plate 722, towards the front wall 53 of the trailer 12, is with effect that at least one of the first engagement-ready surface 706A and the second engagement-ready surface 706B of the end effector 700 becomes disposed in contact engagement with the front wall 53 of the trailer 12. As depicted in FIG. 9, in some embodiments, for example, due to the angular misalignment of the trailer 12 and towing vehicle 13 about the yaw axis (vertical axis), the displacement of the coupler supporter 702, relative to the mounting plate 722, towards the front wall 53 of the trailer 12 is with effect that the first engagement-ready surface 706A becomes disposed in contact engagement with the front wall 53 of the trailer 12. In other embodiments, for example, due to the angular misalignment of the trailer 12 and towing vehicle 13 about the yaw axis (vertical axis), the displacement of the coupler supporter 702, relative to the mounting plate 722, towards the front wall 53 of the trailer 12 is with effect that the second engagement-ready surface 706B becomes disposed in contact engagement with the front wall 53 of the trailer 12.

In some embodiments, for example, each one of the first engagement surface 706A and the second engagement surface 706B, independently, is a planar surface.

In some embodiments, for example, the end effector 700 includes rollers. In some embodiments, for example, the first engagement surface 706A is defined by a first roller, and the second engagement surface 706B is defined by a second roller,

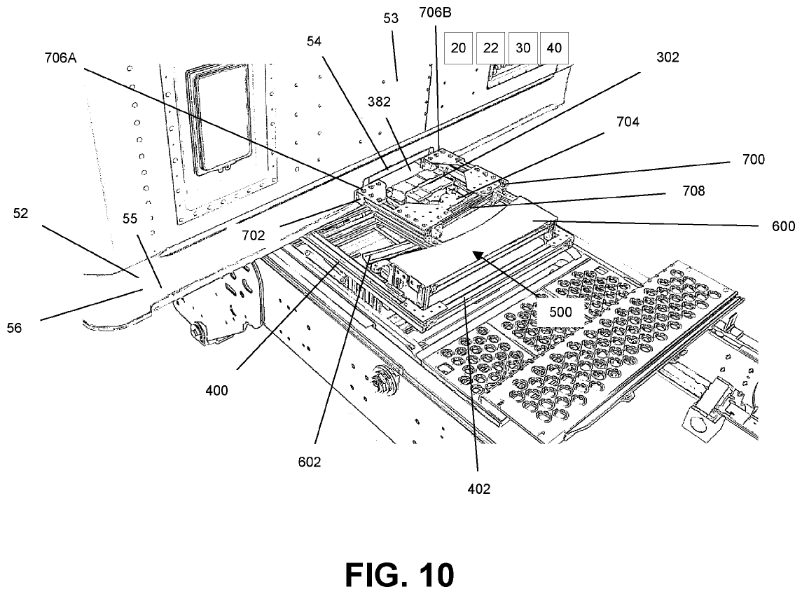

FIG. 10 depicts the end effector 700 disposed in the end effector alignment-effective configuration. In some embodiments, for example, while the end effector 700 disposed in the end effector alignment-effective configuration, the first adapter counterpart 302 and the second adapter counterpart 350 are (i) angularly aligned about the yaw axis (e.g. vertical axis), (ii) axially aligned about the pitch axis (e.g. lateral axis; left to right axis), (iii) axially aligned about the roll axis (e.g. longitudinal axis; front to back axis), and (iv) axially aligned about the yaw axis (e.g. vertical axis), such that the first adapter counterpart 302 and the second adapter counterpart 350 are disposed in the operable communication-effectible alignment.

In some embodiments for example, while the end effector 700 is disposed in the end effector alignment-effective configuration, the end effector 700 is disposed in abutting engagement with the front wall 53 of the trailer 12, for example, the front surface 52 of the trailer 12. In this respect, in some embodiments, for example, as depicted in FIG. 22, each one of the first engagement-ready surface 706A and the second engagement-ready surface 706B, independently, is configured to become disposed in abutting engagement with the front surface 52 of the trailer 12. In some embodiments for example, while the end effector 700 is disposed in the end effector alignment-effective configuration, each one of the first engagement-ready surface 706A and the second engagement-ready surface 706B, independently, is disposed in abutting engagement with the front surface 52 of the trailer 12. In some embodiments, for example, while the first engagement-ready surface 706A and the second engagement-ready surface 706B are disposed in abutting engagement with the front surface 52 of the trailer 12, each one of the first engagement-ready surface 706A and the second engagement-ready surface 706B, independently, is parallel with the front surface 52 of the trailer 12.

While the end effector 700 is disposed in the end effector alignment-effective configuration, the first engagement-ready surface 706A and the second engagement-ready surface 706B are disposed in abutting engagement with the front surface 52 of the trailer 12. The abutting engagement of the of the first engagement-ready surface 706A and the second engagement-ready surface 706B with the front surface 52 of the trailer 12 is with effect that, while the fist adapter counterpart 302 is coupled to the coupler 704, the first adapter counterpart 302 and the second adapter counterpart 350 become (i) angularly aligned about the yaw axis (vertical axis) (ii) axially aligned about the pitch axis (e.g. lateral axis; left to right axis), and (iii) axially aligned about the roll axis (e.g. longitudinal axis; front to back axis), such that the first adapter counterpart 302 and the second adapter counterpart 350 are disposed in the operable communication-effectible alignment.

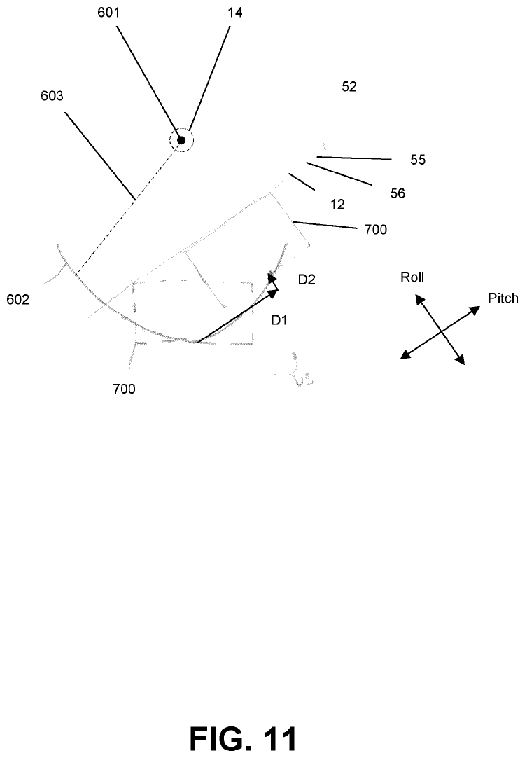

In some embodiments, for example, as depicted in FIG. 11, transitioning of the end effector 700 from the end effector alignment-ready configuration (drawn in broken line in FIG. 11) to the end effector alignment-effective configuration (drawn in solid line in FIG. 11) includes (i) displacement of the end effector 700, relative to the end effector supporter 600, in a direction parallel to the front surface 52 of the trailer 12, for example, in a lateral direction, for example, along the pitch axis (displacement D1), (ii) displacement of the end effector 700, relative to the end effector supporter 600, towards the front surface 52 of the trailer 12, in a longitudinal direction, for example, along the roll axis (displacement D2), and (iii) rotation of the end effector 700, relative to the end effector supporter 600, about the yaw axis (vertical axis) (displacement D3). In this respect, in some embodiments, for example, the supporting of the end effector 700 by the end effector supporter 600 is such that the end effector 700 is: (i) displaceable, relative to the end effector supporter 600, away from the front surface 52 of the trailer 12, in a direction, for example, along the pitch axis of the towing vehicle 13, (ii) displaceable, relative to the end effector supporter 600, towards the front surface 52 of the trailer 12, in a direction, for example, along the roll axis of the towing vehicle 13, and (iii) rotatable, relative to the end effector supporter 600, about the yaw axis of the towing vehicle 13.

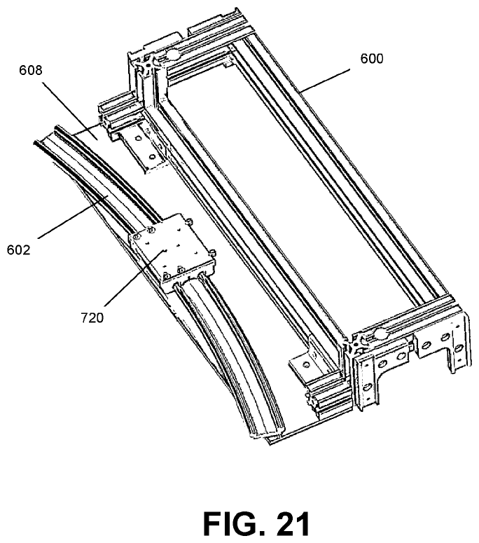

In some embodiments, for example, as depicted in FIG. 20 to FIG. 23, to effect: (i) displacement of the end effector 700, relative to the end effector supporter 600, in a direction parallel to the front wall 53 of the trailer 12, in a direction, for example, along the pitch axis, (ii) displacement of the end effector 700, relative to the end effector supporter 600, towards from the front wall 53 of the trailer 12, in a direction, for example, along the roll axis, and (iii) rotation of the end effector 700, relative to the end effector supporter 600, about the yaw axis (vertical axis), for transitioning the end effector 700 from the end effector alignment-ready configuration to the end effector alignment-effective configuration, the end effector supporter 600 includes a guide assembly 606, which, in some embodiments, for example, includes a curved guide or a curved track 602, and the end effector 700 includes a mounting bracket 720 that is slidably couplable with the curved guide 602, wherein the mounting plate 722 is mounted to the mounting bracket 720. In some embodiments, for example, while the mounting bracket 720 is slidably coupled with the curved guide 602, the end effector 700 is slidable, relative to the curved guide 602, such that the end effector 700 is displaceable relative to the curved guide 602 along a curvilinear path defined by the curved guide 602.

In some embodiments, for example, the guide assembly 606 further includes a displacement guiding configuration 610.

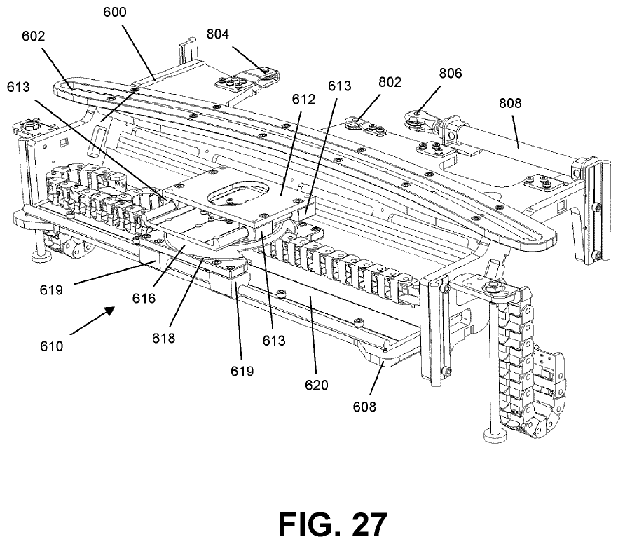

The displacement guiding configuration 610 is configured to guide the displacement of the end effector 700, relative to the end effector supporter 600. In some embodiments, for example, as depicted in FIG. 27 to FIG. 30, the displacement guiding configuration 610 includes a first guide bracket 612, a first rail 614, a slew ring 616, a second guide bracket 618, and a second rail 620.

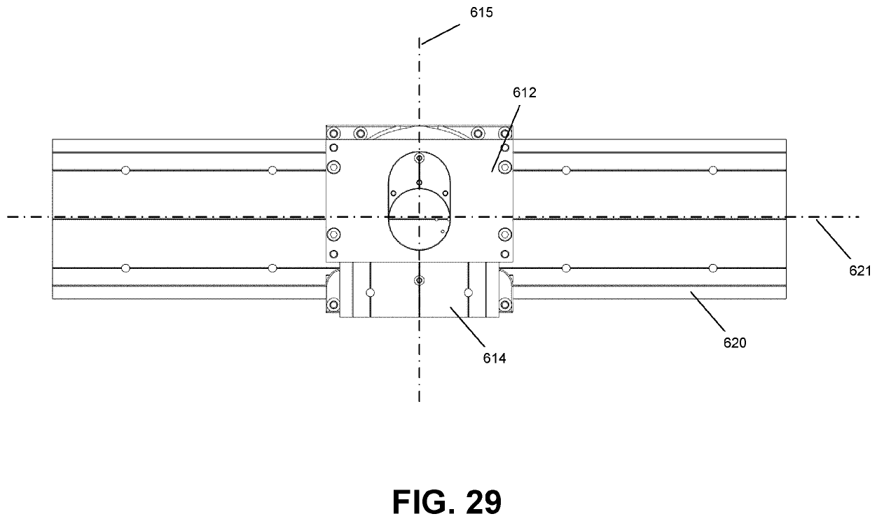

The first guide bracket 612 is configured to be connected to the mounting plate 722 of the end effector 700. In some embodiments, for example, the first guide bracket 612 is configured to be connected to a first mounting plate portion 722A of the end effector 700. The first guide bracket 612 and the first rail 614 are co-operatively configured such that the first guide bracket 612 is slidably connected to the first rail 614, such that the first guide bracket 612 is displaceable relative to the first rail 614. In this respect, in some embodiments, for example, the first guide bracket 612 includes couplings 613 that are coupled to the first rail 614. In some embodiments, for example, the first guide bracket 612 and the first rail 614 are co-operatively configured such that the displacement of the first guide bracket 612, relative to the first rail 614, is guided by the first rail 614. In some embodiments, for example, the guided displacement of the first guide bracket 612, relative to the first rail 614, is a longitudinal displacement (e.g. front to back or back to front displacement). In some embodiments, for example, the guided displacement of the first guide bracket 612, relative to the first rail 614, is along an axis that is parallel to a longitudinal axis 615 of the first rail 614. In some embodiments, for example, the longitudinal axis 615 of the first rail 614 extends along the length of the first rail 614, as depicted in FIG. 29. In some embodiments, for example, the longitudinal axis 615 of the first rail 614 is a linear axis.

The second guide bracket 618 is configured to be connected to a support plate 608 of the end effector supporter 600, such that, while the second guide bracket 618 is connected to the support plate 608, the second guide bracket 618 is supported by the support plate 608. The second guide bracket 618 and the second rail 620 are co-operatively configured such that the second guide bracket 618 is slidably connected to the second rail 620, such that the second guide bracket 618 is displaceable relative to the second rail 620. In this respect, in some embodiments, for example, the second guide bracket 618 includes couplings 619 that are coupled to the second rail 620. In some embodiments, for example, the second guide bracket 618 and the second rail 620 are co-operatively configured such that the displacement of the second guide bracket 618, relative to the second rail 620, is guided by the second rail 620. In some embodiments, for example, the guided displacement of the second guide bracket 618, relative to the second rail 620, is a lateral displacement (e.g. side to side displacement). In some embodiments, for example, the guided displacement of the second guide bracket 618, relative to the second rail 620, is along an axis that is parallel to a longitudinal axis 621 of the second rail 620. In some embodiments, for example, the longitudinal axis 621 of the second rail 620 extends along the length of the second rail 620, as depicted in FIG. 29. In some embodiments, for example, the longitudinal axis 621 of the second rail 620 is a linear axis. In some embodiments, for example, the connection of the second guide bracket 618 to the support plate 608 is such that the longitudinal axis 621 of the second rail 620 is parallel to the pitch axis (e.g. lateral axis) of the towing vehicle 13.

In some embodiments, for example, the longitudinal axis 615 of the first rail 614 and the longitudinal axis 621 of the second rail 620 are disposed in a non-parallel relationship.

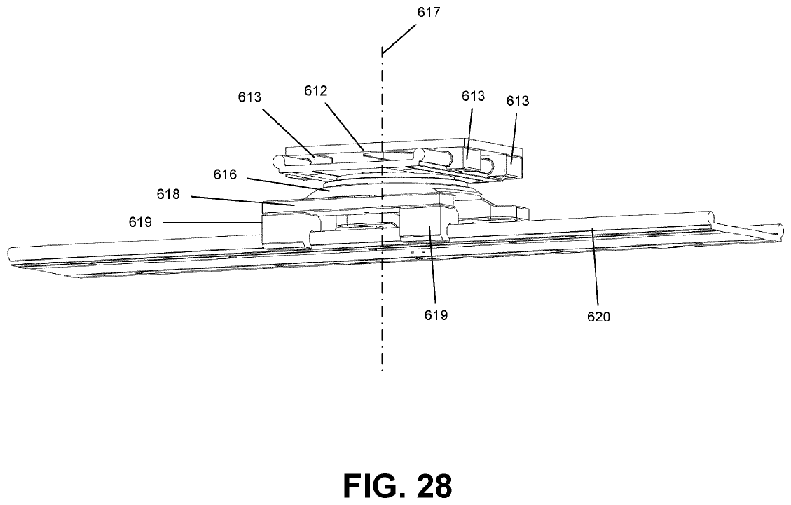

The slew ring 616 is configured to be connected to the first rail 614 and to the second guide bracket 618. In some embodiments, for example, the slew ring 616, the first rail 614, and the second guide bracket 618 are co-operatively configured such that relative rotational displacement between the first rail 614 and the second guide bracket 618 is effectuatable via the slew ring 616. In this respect in some embodiments, for example, the displacement guiding configuration 610 is configured such that relative rotational displacement between: (i) the first guide bracket 612 and the first rail 614, and (ii) the second guide bracket 618 and the second rail 620, is effectuatable via the slew ring 616. In some embodiments, for example, said relative rotational displacement is along a rotational axis 617 of the slew ring 616 that is perpendicular to both the longitudinal axis 615 of the first rail 614 and the longitudinal axis 621 of the second rail 620, as depicted in FIG. 28. In some embodiments, for example, the axis 617 is a linear axis. In some embodiments, for example, the connection of the displacement guiding configuration 610, for example, the second guide bracket 618, to the support plate 608 is such that the axis 617 is parallel to the yaw axis (e.g. vertical axis) of the towing vehicle 13.

In some embodiments, for example, the end effector 700, the displacement guiding configuration 610, and the end effector supporter 600 are co-operatively configured such that the end effector 700 is: (i) displaceable, relative to the end effector supporter 600, in a direction along the longitudinal axis 615 of the first rail 614, (ii) displaceable, relative to the end effector supporter 600, in a direction along the longitudinal axis 621 of the second rail 620, and (iii) rotatable, relative to the end effector supporter 600, about the axis 617 of the slew ring 616.

In some embodiments, for example, the displacement of the end effector 700, relative to the end effector supporter 600, that is effectuatable by the displacement guiding configuration 610, is constrained by the curved guide 602.

The curved guide 602 is configured to be connected to a support plate 608 of the end effector supporter 600, such that, while the curved guide 602 is connected to the support plate 608, the curved guide 602 is supported by the support plate 608. The curved guide 602 is further configured to be connected to the mounting plate 722 of the end effector 700. In some embodiments, for example, the curved guide 602 is configured to be connected to a second mounting plate portion 722B of the end effector 700. The curved guide 602 and the mounting plate 722 are co-operatively configured such that the mounting plate 722 is slidably connected to the curved guide 602, such that the mounting plate 722 is displaceable relative to the curved guide 602 along a curvilinear path defined by the curved guide 602.

In some embodiments, for example, the end effector 700, the displacement guiding configuration 610, the curved guide 602, and the end effector supporter 600 are co-operatively configured such that: (i) the displaceability, of the end effector 700, relative to the end effector supporter 600, in a direction along the longitudinal axis 615 of the first rail 614, is constrained by the curvature of the curved guide 602, (ii) the displaceability, of the end effector 700, relative to the end effector supporter 600, in a direction along the longitudinal axis 621 of the second rail 620, is constrained by the curvature of the curved guide 602, and (iii) the rotatability, of the end effector 700, relative to the end effector supporter 600, about the axis 617 of the slew ring 616, is constrained by the curvature of the curved guide 602.

In some embodiments, for example, the end effector 700, the displacement guiding configuration 610, the curved guide 602, and the end effector supporter 600 are co-operatively configured such that: (i) the forwardmost and rearmost positions, of the end effector 700, relative to the end effector supporter 600, defined on the longitudinal axis 615 of the first rail 614, is defined by the curvature of the curved guide 602, (ii) the leftmost and rightmost positions, of the end effector 700, relative to the end effector supporter 600, defined on the longitudinal axis 621 of the second rail 620, is defined by the curvature of the curved guide 602, and (iii) the limits of rotation, of the end effector 700, relative to the end effector supporter 600, about the axis 617 of the slew ring 616, is defined by the curvature of the curved guide 602

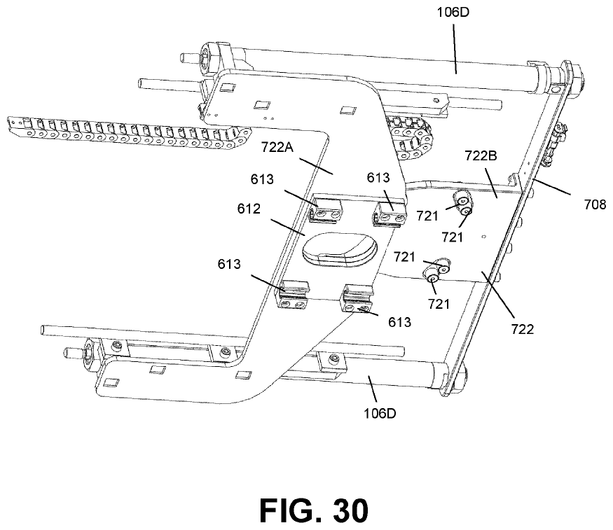

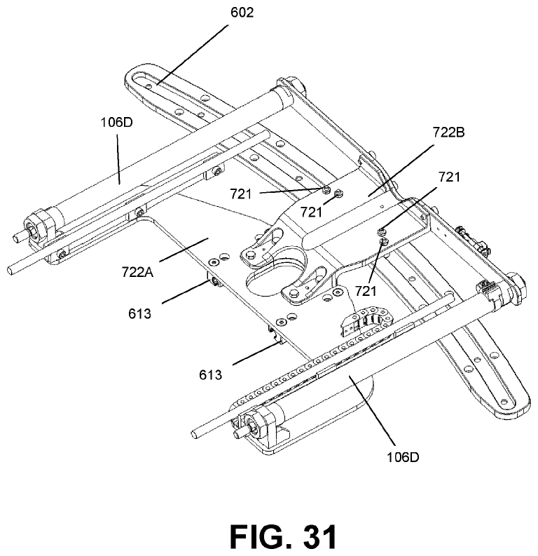

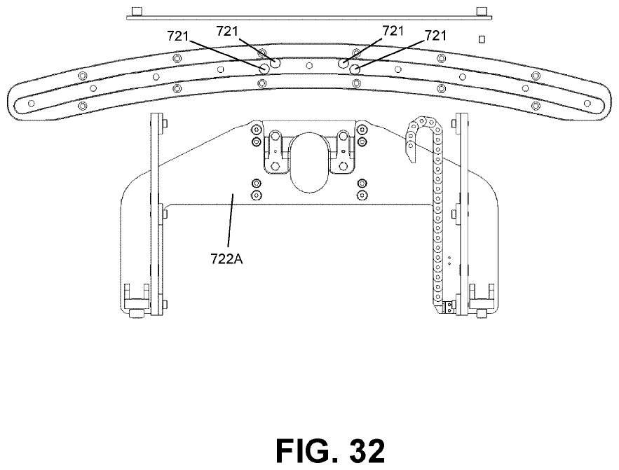

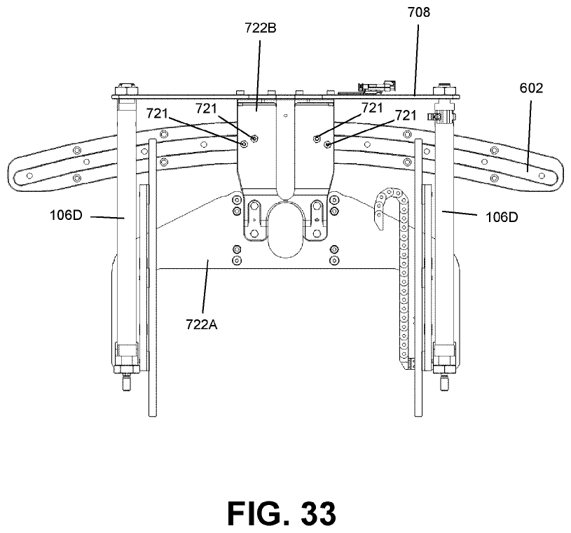

In some embodiments, for example, the end effector 700 includes bearings 721 that are receivable in the curved guide 602, wherein the bearings 721 are mounted to the mounting plate 722. In some embodiments, for example, the bearings 721 are cam followers or rollers. As depicted in FIG. 30 to FIG. 33, in some embodiments, for example, the end effector 700 includes four bearings 721. While the bearings 721 are received in the curved guide 602, the end effector 700 is slidably coupled to the curved guide 602. In some embodiments, for example, the bearings 721 are connected to a second mounting plate portion 722B of the end effector 700.

While the mounting plate 722 is slidably coupled to the curved guide 602, via the mounting bracket 720 or the bearings 721, the end effector 700 is supported by the guide 602. In some embodiments, for example, the supporting of the end effector 700 by the curved guide 602 is such that the end effector 700 is slidable along the curved guide 602. In some embodiments, for example, the end effector 700 and the curved guide 602 are co-operatively configured such that the coupler 704 is facing the center 601 of the curved guide 602. In this respect, in some embodiments, for example, as depicted in FIG. 11, while the end effector 700 is coupled to the curved guide 602 and disposed at a first position of the curved guide 602, the coupler 704 is facing the center 601 of the curved guide 602, and while the end effector 700 is coupled to the curved guide 602 and disposed at a second position of the curved guide 602 that is different from the first position, the coupler 704 is also facing the center 601 of the curved guide 602. In some embodiments, for example, while the end effector 700 is being displaced, relative to the curved guide 602, the end effector 700 is facing the center 601 of the curved guide 602.

In some embodiments, for example, as depicted in FIG. 34 and FIG. 35, while the object manipulator 110 is mounted to the frame 40 of the towing vehicle 13, the center 601 of the curved guide 602 is coincident with a center 15A of the fifth wheel 15. In some embodiments, for example, the coupling of the fifth wheel 15 and the kingpin 14 is effectuated at the center 15A of the fifth wheel 15. In this respect, while the object manipulator 110 is mounted to the frame 40 of the towing vehicle 13, the length of the radius of curvature 603 of the curved guide 602 is the same as the minimum spacing distance from the curved guide 602 to the center 15A of the fifth wheel 15.

In some embodiments, for example, the displacement of the first adapter counterpart 302, relative to the second adapter counterpart 350, for emplacing the first adapter counterpart 302 in alignment with the second adapter counterpart 350, such that the first adapter counterpart 302 and the second adapter counterpart 350 become disposed in the alignment relationship for establishing connection between the first adapter counterpart 302 and the second adapter counterpart 350, includes the displacement of the coupled end effector 700, for example, the displacement of the coupled end effector 700 that is guided by the guide assembly 606, that is effectuated via the transitioning of the end effector 700 from the end effector alignment-ready configuration to the end effector alignment-effective configuration.

In some embodiments, for example, the (i) displacement of the end effector 700, relative to the end effector supporter 600, parallel to the front surface 52 of the trailer 12, in a direction, for example, along the pitch axis, (ii) displacement of the end effector 700, relative to the end effector supporter 600, towards from the front surface 52 of the trailer 12, in a direction, for example, along the roll axis, and (iii) rotation of the end effector 700, relative to the end effector supporter 600, about the yaw axis, for transitioning the end effector 700 from the end effector alignment-ready configuration to the end effector alignment-effective configuration, is a guided displacement of the end effector 700, relative to the end effector supporter 600, wherein the guided displacement of the end effector 700, relative to the end effector supporter 600, is guided by the guide assembly 606. In some embodiments, for example, the supporting of the end effector 700 to the guide assembly 606, for example, the curved guide 602, or the displacement guiding configuration 610 and the curved guide 602, is such that, while the end effector 700 is guidedly displaced, relative to the end effector supporter 600, via the guide assembly 606, the coupler 704, which is supported by the coupler supporter 702, is facing the center 601 of the curved guide 602 during the guided displacement of the end effector 700.

In some embodiments, for example, while the object manipulator 110 is mounted to the frame 40 of the towing vehicle 13, and while the end effector 700 is supported on the guide assembly 606 and disposed at a first position of the curved guide 602, the coupler 704 is facing the center 15A of the fifth wheel 15, and while the end effector 700 is supported on the guide assembly 606 and disposed at a second position of the curved guide 602 that is different from the first position, the coupler 704 is also facing the center 15A of the fifth wheel 15.

In some embodiments, for example, the supporting of the end effector 700 on the guide assembly 606 is such that, while the end effector 700 is guidedly displaced, relative to the end effector supporter 600, via the curved guide 602, the coupler 704 is facing the center 15A of the fifth wheel 15 during the guided displacement.

In some embodiments, for example, while the object manipulator 110 is mounted to the frame 40 of the towing vehicle 13 and the towing vehicle 13 and the trailer 12 are coupled via the fifth wheel 15 and the kingpin 14, the center 601 of the curved guide 602 is coincident with the kingpin 14, as depicted in FIG. 11. In some embodiments, for example, while the object manipulator 110 is mounted to the frame 40 of the towing vehicle 13 and disposed in the manipulator extended configuration, the center 601 of the curved guide 602 is coincident with the central longitudinal axis of the kingpin 14 (e.g. the central longitudinal axis is parallel to a vertical axis, for example, the yaw axis).

In some embodiments, for example, the curved guide 602 has an arc length of 600 millimeters. In some embodiments, for example, the radius of curvature 603 of the curved guide 602 has a value of 1.25 meters.

In some embodiments, for example, while the end effector 700 is disposed in the end effector retracted configuration, the end effector 700 is disposed, relative to the curved track 602, at an engagement-absent position, wherein there is an absence of engagement between the end effector 700 and the front surface 52 of the trailer 12. In some embodiments, for example, the engagement-absent position is defined at the middle of the curved guide 602.

In some embodiments, for example, while the end effector 700 is disposed in the end effector alignment-ready configuration, the end effector 700 is disposed, relative to the curved guide 602, at an urging-absent position, wherein there is an absence of urging of displacement of the end effector 700 by the front surface 52 of the trailer 12. In some embodiments, for example, the urging-absent position is defined at the middle of the curved guide 602.

The transition of the end effector 700 from the end effector alignment-ready configuration to the end effector alignment-effective configuration is effected by actuation of the actuators 106D. In some embodiments, for example, the actuators 106D are actuated by the controller 102, in response to determination by the controller 102 that the end effector 700 is disposed in the end effector alignment-ready configuration. In some embodiments, for example, the controller 102 determines that the end effector 700 is disposed in the end effector alignment-ready configuration, in response to detection that displacement of the end effector supporter 702, towards the front surface 52 of the trailer 12, is being opposed, for example, by the front surface 52 of the trailer 12.

Actuation of the actuators 106D, while the end effector 700 is disposed in the end effector alignment-ready configuration, is with effect that the end effector supporter 702 is urged to displace towards the front surface 52 of the trailer 12. In response to actuation of the actuators 106D, while the end effector 700 is disposed in the end effector alignment-ready configuration, the first engagement-ready surface 706A applies a force to the front surface 52 of the trailer 12, and the front surface 52 of the trailer 12 applies a reaction force to the first engagement-ready surface 706A. The supporting of the end effector 700 on the guide assembly 606 is such that the application of the reaction force from the front surface 52 of the trailer 12 to the first engagement-ready surface 706A is with effect that the end effector 700 is guidedly displaced, relative to the end effector supporter 600, by the guide 602, and, in some embodiments, for example, by the displacement guiding configuration 610 of the guide assembly 606, such that the second engagement-ready surface 706B becomes disposed in contact engagement with the surface 52 of the trailer 12, and that the end effector 700 become disposed in the end effector alignment-ready configuration.

In some embodiments, for example, wherein the end effector 700 includes rollers, the rollers are configured to reduce interference (e.g. friction between the front surface 52 of the trailer 12 and the first engagement-ready surface 706A of the end effector 700) to the guided displacement of the end effector 700, relative to the end effector supporter 600.

In some embodiments, for example, as depicted in FIG. 10, while the first engagement-ready surface 706A and the second engagement-ready surface 706B are disposed in contact engagement with the front surface 52 of the trailer 12, the first engagement-ready surface 706A and the second engagement-ready surface 706B are disposed in abutting engagement with the front surface 52 of the trailer 12.

In some embodiments, for example, the guide of the object manipulator 110 includes the curved guide 602, wherein the coupled end effector 700 and the curved guide 602 are co-operatively configured such that displacement of the coupled end effector 700 is guided by the curved guide 602 along a curvilinear path defined by the curved guide 602. In some embodiments, for example, the guide of the object manipulator 110 includes the displacement guiding configuration 610.

In some embodiments, for example, the towing vehicle 13 is configured to co-operate with the trailer 12 such that: while: (i) the coupled end effector 700 is established, (ii) the first adapter counterpart 302 and the second adapter counterpart 350 are co-operatively disposed in a misaligned relationship, wherein, in the misaligned relationship, there is an absence of alignment between the first adapter counterpart 302 and the second adapter counterpart 350, and (iii) the object manipulator 110 is disposed in a guiding-effective relationship with the trailer 12, wherein, in the guiding-effective relationship, contact engagement between the coupled end effector 700 and the trailer 12, for example, the front surface 52, is effectible: the coupled end effector 700 is displaced towards the trailer 12, for example, in a direction towards the front guide 52, with effect that the coupled end effector 700 becomes disposed in contact engagement with the front guide 52 (e.g. transitioning the coupled end effector 700 from the end effector retracted configuration to the end effector extended alignment-ready configuration).

The guide assembly 606, the coupled end effector 700, and the trailer 12 are co-operatively configured such that, while the coupled end effector 700 is disposed in contact engagement with the trailer 12, for example, the front surface 52, in response to an end effector-displacement force applied to the coupled end effector 700, for example, by the actuators 106D, to urge displacement of the coupled end effector 700 towards the trailer 12, for example, the front surface 52, an end effector-urging reaction force is applied by the trailer 12, for example, the front surface 52, to the coupled end effector 700 to urge displacement of the 700 end effector, with effect that a curvilinear displacement of the coupled end effector 700, relative to the second adapter counterpart 350, is effectuated by the end effector-urging reaction force, wherein the curvilinear displacement is guided by the guide assembly 606 along the curved path, which, in some embodiments, for example, is defined by the curved guide 602. In some embodiments, for example, the curvilinear displacement is effective for emplacing the first adapter counterpart 302 in angular alignment with the second adapter counterpart 350 about a yaw axis. In some embodiments, for example, the curvilinear displacement of the coupled end effector 700 is for emplacing the first adapter counterpart 302 in alignment with the second adapter counterpart 350, such that the first adapter counterpart 302 and the second adapter counterpart 350 become disposed in an alignment relationship for establishing connection between the first adapter counterpart 302 and the second adapter counterpart 350.

In some embodiments, for example, the: (i) the connection of the towing vehicle 13 and the trailer 12 via the fifth wheel 15 and the kingpin 14, (ii) the mounting of the second adapter counterpart 350 such that the center of the second adapter counterpart 350 is aligned with the center of the kingpin 14 along the central longitudinal axis 18 of the trailer 12, (iii) the supporting of the end effector 700 on the guide assembly 606 such that the coupler 704 is facing the center 601 of the curved track 602, (iv) the mounting of the object manipulator 110 on the frame 40 of the towing vehicle 13 such that the center 601 of the curved guide 602 is disposed at the center 15A of the fifth wheel 15, and (v) the supporting of the coupler 704 by the coupler supporter 702, is with effect that, while the end effector 700 is disposed in the end effector extended configuration, and while the first adapter counterpart 302 is releasably coupled to the coupler 704 (e.g. while the coupler 704 and the first adapter counterpart 302 are disposed in a relative movement interference relationship), the first adapter counterpart 302 and the second adapter counterpart 350 become disposed in: (i) angular alignment about the yaw axis, (ii) axial alignment about the pitch axis, and (iii) axial alignment about the roll axis, such that the first adapter counterpart 302 and the second adapter counterpart 350 are disposed in the operable communication-effectible alignment. At this point, in some embodiments, for example, the first adapter counterpart 302 and the second adapter counterpart 350 are disposed in opposing relationship.

In some embodiments, for example, the transitioning of the end effector 700 from the end effector alignment-ready configuration to the end effector alignment-effective configuration, includes displacement of the end effector 700, relative to the end effector supporter 600, as guided by the guide assembly 606.

In some embodiments, for example, transitioning of the end effector 700 from the end effector alignment-ready configuration to the end effector alignment-effective configuration, includes: (i) displacement, of the end effector 700, relative to the end effector supporter 600, in a direction along the longitudinal axis 615 of the first rail 614, defined by the curvature of the curved guide 602, (ii) displacement, of the end effector 700, relative to the end effector supporter 600, in a direction along the longitudinal axis 621 of the second rail 620, defined by the curvature of the curved guide 602, and (iii) rotation, of the end effector 700, relative to the end effector supporter 600, about the axis 617 of the slew ring 616, defined by the curvature of the curved guide 602.

In some embodiments, for example, the: (i) displacement, of the end effector 700, relative to the end effector supporter 600, in a direction along the longitudinal axis 615 of the first rail 614, defined by the curvature of the curved guide 602, (ii) displacement, of the end effector 700, relative to the end effector supporter 600, in a direction along the longitudinal axis 621 of the second rail 620, defined by the curvature of the curved guide 602, and (iii) rotation, of the end effector 700, relative to the end effector supporter 600, about the axis 617 of the slew ring 616, defined by the curvature of the curved guide 602, is with effect that the end effector 700, for example, the coupler 704, is displaced along a curved path, as defined by the curved guide 602, and is facing the second adapter counterpart 350 that is mounted to the trailer 12.

In some embodiments, for example, as depicted in FIG. 22, a sensor 104C, for example, a proximity sensor, mounted to the coupler supporter 702, is configured to collect data representative of the proximity of the first engagement-ready surface 706A relative to the front surface 52, defined by the front wall 53 of the trailer 12. Based on the data from the sensor 104C, the controller 102 determines that the first engagement-ready surface 706A is disposed in abutting engagement with the front surface 52 of the trailer 12.

In some embodiments, for example, as depicted in FIG. 22, a sensor 104D, for example, a proximity sensor, mounted to the coupler supporter 702, is configured to collect data representative of the proximity of the second engagement-ready surface 706B relative to the front surface 52 of the trailer 12. Based on the data from the sensor 104D, the controller 102 determines that the second engagement-ready surface 706B is disposed in abutting engagement with the front surface 52 of the trailer 12.

At this point, in some embodiments, for example, the coupled object manipulator 110 is disposed in a coupled object manipulator alignment-effective configuration. The towing vehicle 13 is configured to co-operate with the trailer 12 such that, while the coupled object manipulator 110 is disposed in the coupled object manipulator alignment-effective configuration, the first adapter counterpart 302 and the second adapter counterpart 350 are co-operatively disposed in an aligned relationship or in an alignment relationship, for example, the operable communication-effectible alignment, wherein, in the aligned relationship, the first adapter counterpart 302 is disposed in alignment with the second adapter counterpart 350, for establishing connection between the first adapter counterpart 302 and the second adapter counterpart 350.

In some embodiments, for example, while the coupled object manipulator 110 is disposed in the coupled object manipulator alignment-effective configuration, the coupled object manipulator 100 is elevated relative to its disposition in the coupled object manipulator retracted configuration. In some embodiments, for example, while the coupled object manipulator 110 is disposed in the coupled object manipulator alignment-effective configuration, the coupled object manipulator 110 is disposed above the frame 40 of the towing vehicle 13.

In some embodiments, for example, the coupled object manipulator 110 is transitionable between the coupled object manipulator retracted configuration and the coupled object manipulator alignment-effective configuration. In some embodiments, the transitioning of the coupled object manipulator 110 from the coupled object manipulator retracted configuration and the coupled object manipulator alignment-effective configuration is effected by displacement of the coupled end effector 700 by the alignment relationship-obtaining displacement, as described above.

In some embodiments, for example, the emplacement of the first adapter counterpart 302 and the second adapter counterpart 350 in the alignment relationship is obtained while the fifth wheel 15 is coupled to the fifth wheel guiding counterpart 14 of the trailer 12 (e.g. the kingpin), such that a fifth wheel coupling relationship is established. In some embodiments, for example, the connection of the first adapter counterpart 302 to the second adapter counterpart 350 is effectuatable while the fifth wheel coupling relationship is established.

While (i) the end effector 700 is disposed in the end effector alignment-effective configuration, and (ii) the first adapter counterpart 302 is coupled to the coupler 704, such that the first adapter counterpart 302 and the second adapter counterpart 350 are disposed in the operable communication-effectible alignment, for example, in opposing relationship, the coupler 704, to which the first adapter counterpart 302 is coupled, is transitioned from a coupler retracted configuration to a coupler extended configuration.

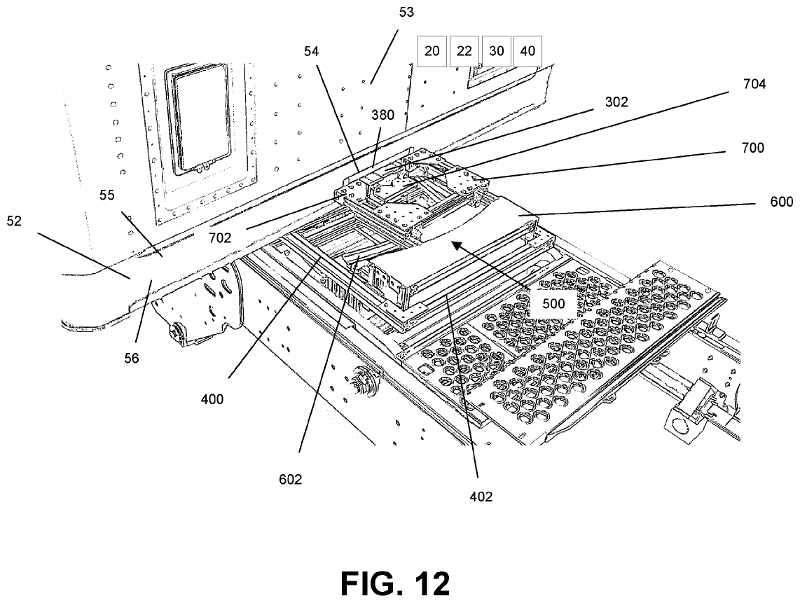

FIG. 10 depicts the coupler 704 disposed in the coupler retracted configuration, and FIG. 12 depicts the coupler 704 disposed in the coupler extended configuration.

While the coupler 704 is disposed in the coupler extended configuration, relative to its disposition in the coupler retracted configuration, the coupler 704 is disposed further from a front surface 708 of the coupler supporter 702, along a displacement axis of the coupler 704, and closer towards the front wall 53 of the trailer 12. In some embodiments, for example, the displacement axis of the coupler 704 is parallel to the central longitudinal axis 18 of the trailer 12. In some embodiments, for example, the displacement axis of the coupler 704 is a linear axis.

In some embodiments, for example, transitioning of the coupler 704 from the coupler retracted configuration to the coupler extended configuration includes displacement of the coupler 704, relative to the coupler supporter 702, includes displacement of the coupler 704 along the displacement axis of the coupler 704.

In some embodiments, for example, while the first engagement-ready surface 706A and the second engagement-ready surface 706B of the coupler supporter 702 are disposed in contact engagement with the front surface 52 of the trailer 12, and while the first adapter counterpart 302 is releasably coupled to the coupler 704, such that a coupled first adapter counterpart 302 is established, the first adapter counterpart 302 and the second adapter counterpart 350 are disposed in alignment, wherein the alignment of the first adapter counterpart 302 and the second adapter counterpart 350 is along the displacement axis of the coupler 704.

In some embodiments, for example, transitioning of the coupler 704 from the coupler retracted configuration to the coupler extended configuration includes displacement of the coupler 704, relative to the coupler supporter 702, away from the front surface 708 of the coupler supporter 702, and towards the second adapter counterpart 350.

While the first adapter counterpart 302 is coupled to the coupler 704, such that the coupled first adapter counterpart 302 is established, the transitioning the coupler 704 from the coupler retracted configuration to the coupler extended configuration, is with effect that the first adapter counterpart 302 is displaced in a direction towards the second adapter counterpart 350. In some embodiments, for example, the displacement of the first adapter counterpart 302 towards the second adapter counterpart 350 is along the displacement axis of the coupler 704.

In some embodiments, for example, the first adapter counterpart 302 and the second adapter counterpart 350 are co-operatively configured such that, in response to emplacement of the first adapter counterpart 302 and the second adapter counterpart 350 in the operable communication-effectible alignment, the first adapter counterpart 302 and the second adapter counterpart 350 become connected. In some embodiments, for example, the connection, obtained in response to the emplacement of the first adapter counterpart 302 and the second adapter counterpart 350 in the operable communication-effectible alignment, is obtained autonomously.

The transition of the coupler 704 from the coupler retracted configuration to the coupler extended configuration is effected by actuation of the actuator 106E. In some embodiments, for example the actuator 106E is a pneumatic actuator. In some embodiments, for example, the actuator 106E is actuated by the controller 102, in response to determination by the controller 102 that the end effector 700 is disposed in the end effector alignment-effective configuration (e.g. the first engagement-ready surface 706A and the second engagement-ready surface 706B are disposed in contact engagement with the front wall 53 of the trailer 12). As depicted in FIG. 22, the actuator 106E is connected to the coupler supporter 702 and to the coupler 704, such that relative displacement between the coupler supporter 702 and the coupler 704 is effectuatable.

In some embodiments, for example, the displacement of the first adapter counterpart 302 towards the second adapter counterpart 350, for effecting establishment of operable communication between the first adapter counterpart 302 and the second adapter counterpart 350, is guided by the co-operation of the guide pins 312 and the guide ports 3120.

While the first adapter counterpart 302 and the second adapter counterpart 350 are disposed in the operable communication-effectible alignment, the displacement of the first adapter counterpart 302 towards the second adapter counterpart 350 is with effect that the first adapter counterpart 302 is displaced through the opening 382 of the frame 380. In response to further displacement of the first adapter counterpart 302 towards the second adapter counterpart 350, for example, via the actuator 106E, the guide pins 312 of the first adapter counterpart 302 are received into the guide ports 3120 of the second adapter counterpart 350 to guide further displacement of the first adapter counterpart 302 towards the second adapter counterpart 350. In response to further displacement of the first adapter counterpart 302 towards the second adapter counterpart 350, the first adapter counterpart 302 becomes connected with the second adapter counterpart 350, as depicted in FIG. 2B, with effect that the first adapter counterpart 302 and the second adapter counterpart 350 becomes disposed in operable communication, for example, electrical communication, fluid communication, and data communication.

In some embodiments, for example, while the first adapter counterpart 302 and the second adapter counterpart 350 are disposed in the operable communication-effectible alignment, the displacement of the first adapter counterpart 302 towards the second adapter counterpart 350 is with effect that the electrical connectors 308 of the first adapter counterpart 302 become disposed within the electrical ports 3080 of the second adapter counterpart 350. In some embodiments, for example, the disposition of the electrical connectors 308 within the electrical ports 3080 is with effect that electrical communication is established between the first adapter counterpart 302 and the second adapter counterpart 350. In some embodiments, for example, the establishment of electrical communication between the first adapter counterpart 302 and the second adapter counterpart 350 is with effect that electrical communication is established between the trailer communicator-defined electrical conductor 1204 and the towing vehicle communicator-defined electrical conductor 1304. In some embodiments, for example, the establishment of electrical communication between the trailer communicator-defined electrical conductor 1204 and the towing vehicle communicator-defined electrical conductor 1304 is with effect that electrical communication is established between the electrical energy storage device of the towing vehicle 13 and the electrical system of the trailer 12.

In this respect, in some embodiments, for example, the establishment of electrical communication between the first adapter counterpart 302 and the second adapter counterpart 350 is with effect that the electrical energy storage device of the towing vehicle 13 becomes disposed in electrical communication with the electrical system of the trailer 12.

In some embodiments, for example, while the first adapter counterpart 302 and the second adapter counterpart 350 are disposed in the operable communication-effectible alignment, the displacement of the first adapter counterpart 302 towards the second adapter counterpart 350 is with effect that the fluid connectors 310 of the first adapter counterpart 302 become disposed within the fluid ports 3100 of the second adapter counterpart 350. In some embodiments, for example, the disposition of the fluid connectors 310 within the fluid ports 3100 is with effect that fluid communication is established between the first adapter counterpart 302 and the second adapter counterpart 350. In some embodiments, for example, the establishment of fluid communication between the first adapter counterpart 302 and the second adapter counterpart 350 is with effect that fluid communication is established between the trailer communicator-defined fluid conductor 1202 and the towing vehicle communicator-defined fluid conductor 1302. In some embodiments, for example, the establishment of fluid communication between the trailer communicator-defined fluid conductor 1202 and the towing vehicle communicator-defined fluid conductor 1302 is with effect that fluid communication is established between the fluid energy storage device of the towing vehicle 13 and the fluid system of the trailer 12.

In this respect, in some embodiments, for example, the establishment of fluid communication between the first adapter counterpart 302 and the second adapter counterpart 350 is with effect that the fluid energy storage device of the towing vehicle 13 becomes disposed in fluid communication with the fluid system of the trailer 12.

In some embodiments, for example, while the first adapter counterpart 302 and the second adapter counterpart 350 are disposed in the operable communication-effectible alignment, the displacement of the first adapter counterpart 302 towards the second adapter counterpart 350 is with effect that the data connectors 314 of the first adapter counterpart 302 become disposed within the data ports 3140 of the second adapter counterpart 350. In some embodiments, for example, the disposition of the data connectors 314 within the data ports 3140 is with effect that data communication is established between the first adapter counterpart 302 and the second adapter counterpart 350. In some embodiments, for example, the establishment of data communication between the first adapter counterpart 302 and the second adapter counterpart 350 is with effect that data communication is established between the trailer communicator-defined data conductor 1205 and the towing vehicle communicator-defined data conductor 1305. In some embodiments, for example, the establishment of data communication between the trailer communicator-defined data conductor 1205 and the towing vehicle communicator-defined data conductor 1305 is with effect that data communication is established between the data communication devices of the towing vehicle 13 and the data communication of the trailer 12.

In this respect, in some embodiments, for example, the establishment of data communication between the first adapter counterpart 302 and the second adapter counterpart 350 is with effect that the data communication devices of the towing vehicle 13 becomes disposed in data communication with the data communication devices of the trailer 12.

In some embodiments, for example, the disposition of the first adapter counterpart 302 in operable communication, for example, electrical communication, fluid communication, and data communication, with the second adapter counterpart 350, by the connection apparatus 100, is for actuating a vehicle operation, such that: (i) electrical communication between the electrical energy storage device of the towing vehicle 13 and the electrical system of the trailer 12 is established, for actuating a vehicular operation via actuation of an actuatable electrical system (e.g. ABS brakes and turn signals), and (ii) fluid communication between the fluid energy storage device of the towing vehicle 13 and the fluid system of the trailer 12 is established, for actuating a vehicular operation via actuation of an actuatable fluid system (e.g. service and parking brakes), and (iii) data communication between the data communication devices of the towing vehicle 13 and the data communication devices of the trailer 12, is established, for controlling the actuation of a vehicular operation.

In some embodiments, for example, the disposition of the first adapter counterpart 302 in operable communication, for example, electrical communication, fluid communication, and data communication, with the second adapter counterpart 350, by the connection apparatus 100, is for replenishing an energy storage device of the towing vehicle 13 by an energy source of the trailer 12, such that: (i) electrical communication between the electrical energy storage device of the towing vehicle 13 and the electrical system of the trailer 12 is established, for replenishing the electrical energy storage device (e.g. battery) of the towing vehicle 13 by an electrical energy source (e.g. battery, generator, solar panels, etc.) of the trailer 12, and (ii) fluid communication between the fluid energy storage device of the towing vehicle 13 and the fluid system of the trailer 12 is established, for replenishing the fluid energy storage device (e.g. pneumatic gas tank, fuel tank) of the towing vehicle 13 by the fluid energy source (e.g. pneumatic gas tank, fuel tank) of the trailer 12, and (iii) data communication between the data communication devices of the towing vehicle 13 and the data communication devices of the trailer 12, is established, for controlling the replenishing of the energy storage device of the towing vehicle 13 by the energy source of the trailer 12.

In some embodiments, for example, in response to disposition of the first adapter counterpart 302 and the second adapter counterpart 350 in operable communication, the first adapter counterpart 302 and the second adapter counterpart 350 become disposed in a coupled relationship.

In some embodiments, for example, in response to disposition of the first adapter counterpart 302 and the second adapter counterpart 350 in operable communication, it is desirable to tow the trailer 12 with the towing vehicle 13. In such embodiments, for example, it is desirable to dispose the object manipulator 110 outside of the swing radius 21, for example, below the swing radius 21, of the trailer 12, in order to avoid collision between the trailer 12 and the object manipulator 110 during towing of the trailer 12. In this respect, in some embodiments, for example, in response to disposition of the first adapter counterpart 302 and the second adapter counterpart 350 in operable communication, the coupling of the coupler 704 and the first adapter counterpart 302 is defeated. In some embodiments, for example, the controller 102 determines that the first adapter counterpart 302 and the second adapter counterpart 350 are disposed in operable communication via detection of: (i) the establishment of the electrical communication between the electrical connectors 308 and the electrical ports 3080, (ii) the establishment of the fluid communication between the fluid connectors 310 and the fluid ports 3100, (iii) the establishment of the data communication between the data connectors 314 and the data ports 3140, or (iv) the establishment of the electrical communication between the electrical connectors 308 and the electrical ports 3080, the establishment of the fluid communication between the fluid connectors 310 and the fluid ports 3100, and the establishment of the data communication between the data connectors 314 and the data ports 3140. In some embodiments, for example, in response to determination by the controller 102 that the first adapter counterpart 302 and the second adapter counterpart 350 are disposed in operable communication, the controller 102 sends a control command to actuate the first connector counterpart 232 or the second connector counterpart 315, for example, the spring-loaded latch, for defeating the coupling of the coupler 704 and the first adapter counterpart 302.

In some embodiments, for example, while the coupling between the coupler 704 and the first adapter counterpart 302 is defeated, the end effector 700 and the first adapter counterpart 302 are disposed in a relative movement effectible relationship.

In some embodiments, for example, as depicted in FIG. 13, while the coupling of the coupler 704 and the first adapter counterpart 302 is defeated, the coupler 704 is transitioned from the coupler extended configuration to the coupler retracted configuration, by being displaced away from the second adapter counterpart 350 and towards the coupler supporter 702.

In some embodiments, for example, while the first adapter counterpart 302 and the second adapter counterpart 350 are connected, the friction established between the: (i) electrical connectors 308 and electrical ports 3080, (ii) fluid connectors 310 and fluid ports 3100 (iii) data connectors 314 and data ports 3140, and/or (iv) guide pins 312 and guide ports 3120, is with effect that the connection between the first adapter counterpart 302 and the second adapter counterpart 350 is retained. In some embodiments, for example, such friction interferes with relative displacement between the first adapter counterpart 302 and the second adapter counterpart 350. In some embodiments, for example, the retention of the connection of the first adapter counterpart 302 and the second adapter counterpart 350 is such that, while the coupling between the coupler 704 and the first adapter counterpart 302 is defeated, there is an absence of defeating of the connection while the coupler 704 is transitioned from the coupler extended configuration to the coupler retracted configuration.

In some embodiments, for example, while the first adapter counterpart 302 and the second adapter counterpart 350 are connected, and the connection between the first adapter counterpart 302 and the second adapter counterpart 350 is retained, for example, via friction, the first adapter counterpart 302 and the second adapter counterpart 350 are disposed in a relative movement interference relationship.

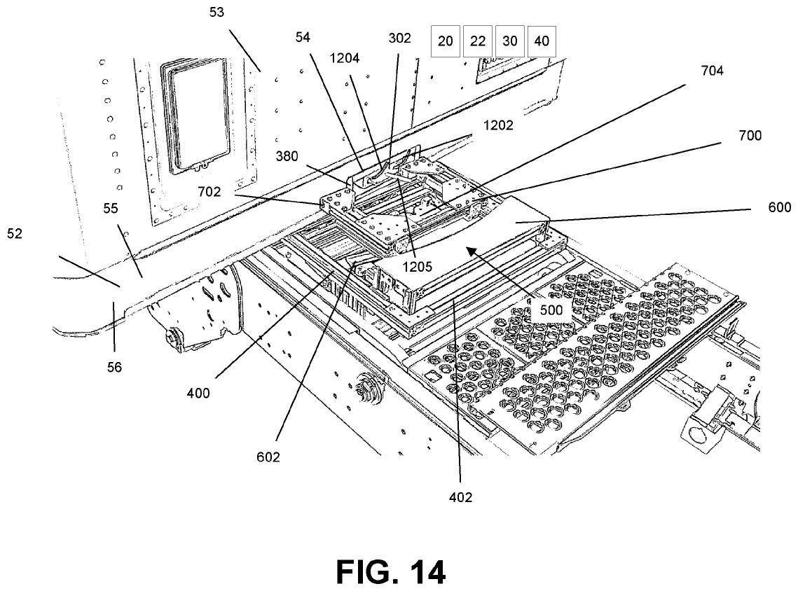

With the coupler 704 disposed in the coupler retracted configuration, the end effector 700 is transitioned from the end effector alignment-effective configuration to the end effector alignment-ready configuration, by displacing the coupler supporter 702 away from the front surface 52 of the trailer 12, with effect that the contact engagement of at least one of the first engagement-ready surface 706A and the second engagement-ready surface 706B with the front surface 52 of the trailer 12 is defeated. In some embodiments, for example, as depicted in FIG. 14, the transitioning of the end effector 700 from the end effector alignment-effective configuration to the end effector alignment-ready configuration is with effect that the contact engagement of the second engagement-ready surface 706B with the front surface 52 of the trailer 12 is defeated.

While the contact engagement of at least one of the first engagement-ready surface 706A and the second engagement-ready surface 706B with the front surface 52 of the trailer 12 is defeated, the end effector 700 is displaced in a curvilinear path, as guided by the guide assembly 606, such that the end effector 700 becomes disposed in the alignment-ready configuration. In some embodiments, for example, it is desirable to dispose the end effector 700 at the center of the curved guide 602, or to displace the end effector 700 towards the center of the curved guide 602, relative to its disposition in the end effector alignment-effective configuration, such that there is an absence of engagement of the end effector 700 with the platform 400 or frame 40 of the towing vehicle 13 while the object manipulator 110 is transitioned to the manipulator retracted configuration. In some embodiments, for example, as depicted in FIG. 35, the central longitudinal axis 19 of the towing vehicle 13 is coincident with the center of the curved guide 602, and also coincident with the center 15A of the fifth wheel 15. In some embodiments, for example, while the end effector 700 is disposed at the center of the curved guide 602, the displacement axis of the coupler 704 and the central longitudinal axis 19 of the towing vehicle 13 are disposed in a parallel relationship. In some embodiments, for example, while the end effector 700 is disposed at the center of the curved guide 602, the displacement of the coupler supporter 702, relative to the mounting plate 722, is along a displacement axis that is parallel to the central longitudinal axis 19 of the towing vehicle 13.

In this respect, in some embodiments, for example, the end effector alignment effector 500 includes a re-centering assembly 800 that, in some embodiments, for example, is a spring assembly 800A, as depicted in FIG. 20, including a spring 801, which is connected, at a first end, to the end effector supporter 600, and at a second end, to the mounting plate 722. While the contact engagement of at least one of the first engagement-ready surface 706A and the second engagement-ready surface 706B with the front surface 52 of the trailer 12 is defeated, the spring 801 applies a spring force to the mounting plate 722 to displace the end effector 700, along the curved guide 602, such that the end effector 700 becomes disposed at the urging-absent position, relative to the curved guide 602 (e.g. a position disposed at the middle of the curved guide 602). The coupler supporter 702 continues to be displaced, relative to the mounting plate 722, in a direction away from the front surface 52 of the trailer 12, such that the end effector 700 becomes disposed in the end effector alignment-ready configuration.

In some embodiments, for example, while the end effector alignment-ready configuration, the end effector-urging reaction force that is applied by the front surface 52 of the trailer 12 to the end effector 700, overcomes the spring force applied by the spring 801 to the mounting plate 722, for transitioning the end effector 700 to the end effector alignment-effective configuration.

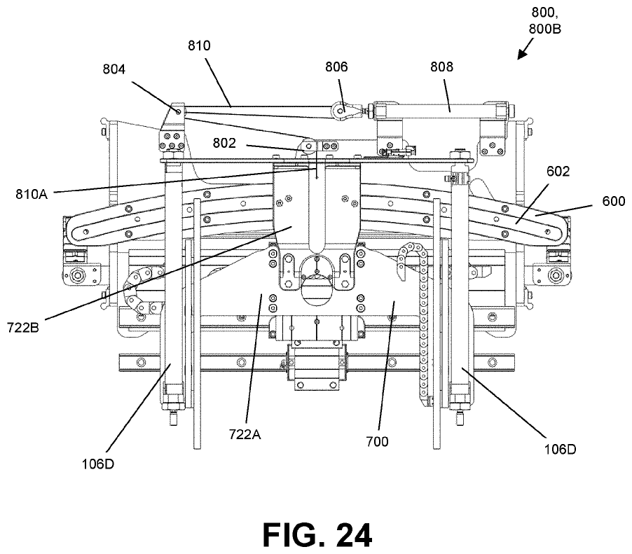

In some embodiments, for example, the end effector alignment effector 500 includes the re-centering assembly 800 that, in some embodiments, for example, is a pulley assembly 800B, as depicted in FIG. 24 to FIG. 26. In some embodiments, for example, the pulley assembly 800B includes a first pulley 802, a second pulley 804, a third pulley 806, an actuator 808, and a transmission component 810.

In some embodiments, example, the actuator 808 is a pneumatic actuator. In some embodiments, for example, the actuator 808 is actuatable by the controller 102. In some embodiments, for example, the actuator 808 is actuated by the controller 102, in response to determination by the controller 102 that the end effector 700 is being transitioned from the end effector alignment-effective configuration to the end effector alignment-ready configuration. In some embodiments, for example, while the controller 102 sends a control command to the actuators 106D to displace the coupler supporter 702 away from the front surface 52 of the trailer 12, the controller 102 sends a control command to the actuator 808 to retract.

In some embodiments, for example, the transmission component 810 is defined by a drive belt, a chain, a cable, and the like.

As depicted, in some embodiments, the first pulley 802, the second pulley 804, and the actuator 808 are mounted to the support plate 608 of the end effector supporter 600, and the third pulley 806 is mounted to the displaceable actuator rod of the actuator 808, such that the third pulley 806 is displaceable with the rod of the actuator 808.

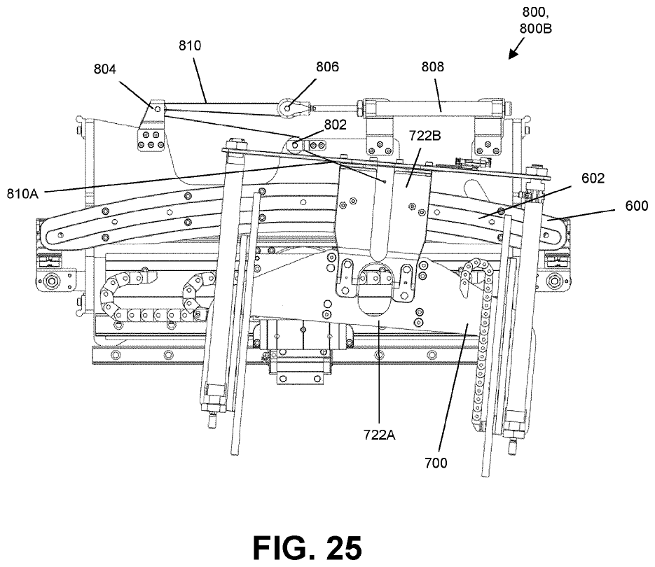

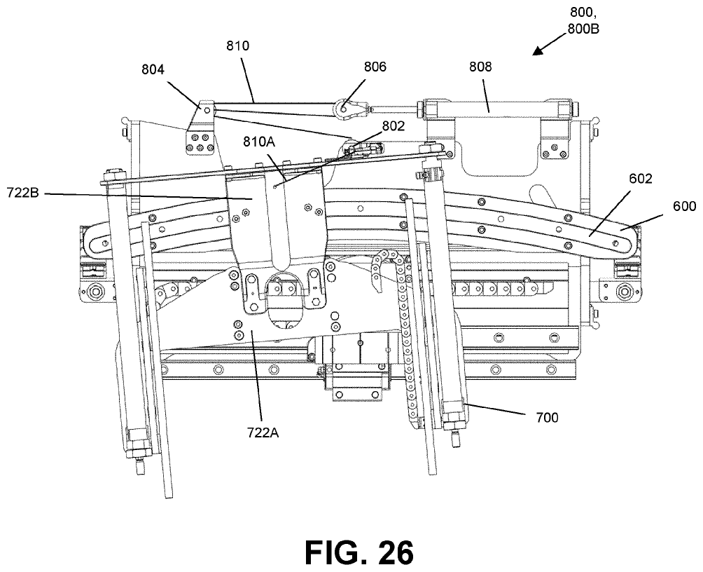

In some embodiments, for example, the actuator 808 is configurable in a retracted configuration, as depicted in FIG. 24, and an extended configuration, as depicted in FIG. 25 and FIG. 26. Relative to its disposition while the actuator 808 is disposed in the retracted configuration, the rod of the actuator 808 is extended, while the actuator 808 is disposed in the extended configuration.

In some embodiments, for example, while the actuator 808 is disposed in the retracted configuration, the third pulley 806 is disposed in a first position. In some embodiments, for example, while the actuator 808 is disposed in the extended configuration, the third pulley 806 is disposed in a second position.

In some embodiments, for example, while the end effector 700 is disposed at the center or the middle of the curved guide 602, as depicted in FIG. 24, the actuator 808 is disposed in the retracted configuration, and the third pulley 806 is disposed in the first position. In some embodiments, for example, while the end effector 700 is disposed at the end effector retracted configuration, the actuator 808 is disposed in the retracted configuration, and the third pulley 806 is disposed in the first position. In some embodiments, for example, while the end effector 700 is disposed at the end effector alignment-ready configuration, the actuator 808 is disposed in the retracted configuration, and the third pulley 806 is disposed in the first position.

In some embodiments, for example, while the end effector 700 is disposed at a position of the curved guide 602 that is offset from the center or the middle of the curved guide 602, as depicted in FIG. 25 and FIG. 26, the actuator 808 is disposed in the extended configuration, and the third pulley 806 is disposed in the second position. In some embodiments, for example, while the end effector 700 is disposed at the end effector alignment-effective configuration, the actuator 808 is disposed in the extended configuration, and the third pulley 806 is disposed in the second position.

As depicted, a first end of the transmission component 810 is connected to the mounting plate 722 of the end effector 700, for example, the second mounting plate portion 722B. The transmission component 810 extends from the mounting plate 722 to the first pulley 802, then from the first pulley 802 to the second pulley 804, then from the second pulley 804 to the third pulley 806, and then extends to the second pulley 804. The second end of the transmission component 810 is connected to the second pulley 804.

In some embodiments, for example, the transmission component 810 defines a transmission component portion 810A. In some embodiments, for example, the transmission component portion 810A is defined between the first end of the transmission component 810 and the first pulley 802.

In some embodiments, for example, while the end effector 700 is disposed at the center or the middle of the curved guide 602, the mounting plate 722 is disposed relative to the first pulley 802 such that the length of the transmission component portion 810A is the minimum length of the transmission component portion 810A. In some embodiments, for example, while the end effector 700 is disposed at the end effector retracted configuration, the mounting plate 722 is disposed relative to the first pulley 802 such that the length of the transmission component portion 810A is the minimum length of the transmission component portion 810A. In some embodiments, for example, while the end effector 700 is disposed at the end effector alignment-ready configuration, the mounting plate 722 is disposed relative to the first pulley 802 such that the length of the transmission component portion 810A is the minimum length of the transmission component portion 810A.

In some embodiments, for example, while the end effector 700 is disposed at a position of the curved guide 602 that is offset from the center or the middle of the curved guide 602, as depicted in FIG. 25 and FIG. 26, the mounting plate 722 is disposed relative to the first pulley 802 such that the length of the transmission component portion 810A is greater than the minimum length of the transmission component portion 810A. In some embodiments, for example, while the end effector 700 is disposed at the end effector alignment-effective configuration, the mounting plate 722 is disposed relative to the first pulley 802 such that the length of the transmission component portion 810A is greater than the minimum length of the transmission component portion 810A.

In some embodiments, for example, while the end effector 700 is disposed in the end effector alignment-ready configuration, in response to the transition of the end effector 700 from the end effector alignment-ready configuration to the end effector alignment-effective configuration, the end effector 700, for example, the mounting plate 722, applies a force to the transmission component 810. In response to application of the force to the transmission component 810 by the end effector 700, a force is applied to the third pulley 806 and the actuator 808, with effect that: (i) the actuator 808 is transitioned from the retracted configuration to the extended configuration, and (ii) the third pulley 806 is transitioned from the first position to the second position.

In some embodiments, for example, while the end effector 700 is disposed in the end effector alignment-ready configuration, in response to the transition of the end effector 700 from the end effector alignment-ready configuration to the end effector alignment-effective configuration, there is an absence of actuation of the extension component of the actuator 808 for extending the actuator 808. Rather, in some embodiments, for example, the actuator 808 is transitioned from the retracted configuration to the extended configuration via the force applied to the transmission component 810 by the end effector 700.

In some embodiments, for example, while the end effector 700 is disposed in the end effector alignment-effective configuration, in response to the transition of the end effector 700 from the end effector alignment-effective configuration to the end effector alignment-ready configuration, the controller 102 sends a control command to the actuator 808, with effect that: (i) the actuator 808 is transitioned from the extended configuration to the retracted configuration (e.g. the actuator 808 is retracted), and (ii) the third pulley 806 is transitioned from the second position to the first position. In some embodiments, for example, in response to (i) the transitioning of the actuator 808 from the extended configuration to the retracted configuration (e.g. the actuator 808 is retracted), and (ii) the transitioning of the third pulley 806 from the second position to the first position, a force is applied to the transmission component 810 to the mounting plate 722, such that the end effector 700 is guidedly displaced, by the guide assembly 606, with effect that the end effector 700 becomes disposed at the center position of the curved guide 602. In some embodiments, for example, in response to (i) the transitioning of the actuator 808 from the extended configuration to the retracted configuration (e.g. the actuator 808 is retracted), and (ii) the transitioning of the third pulley 806 from the second position to the first position, a force is applied to the transmission component 810 to the mounting plate 722, such that the end effector 700 is guidedly displaced, by the guide assembly 606, towards the center position of the curved guide 602.

At this point, in some embodiments, for example, the end effector 700 becomes disposed at the urging-absent position, relative to the curved guide 602 (e.g. a position disposed at the center of the curved guide 602). The coupler supporter 702 continues to be displaced, relative to the mounting plate 722, in a direction away from the front surface 52 of the trailer 12 such that the end effector 700 becomes disposed in the end effector alignment-ready configuration.

In some embodiments, for example, the: (i) displacement of the end effector 700 towards the center of the curved guide 602 (e.g. centering of the end effector 700 relative to the curved guide 602), and (ii) displacement of the coupler supporter 702, relative to the mounting plate 722, in a direction away from the front surface 52 of the trailer 12, for transitioning the end effector 700 from the end effector alignment-effective configuration to the end effector alignment-ready configuration, and then from the end effector alignment-ready configuration to the end effector retracted configuration, occurs at the same time. In this respect, in some embodiments, for example, the retraction portions of the actuators 106D and the retraction portion of the actuator 808 are disposed in fluid communication, such that retraction of the actuators 106D and the retraction of the actuator 808 occurs at the same time.

In some embodiments, for example, due to the configuration of the pulley assembly 800B, the actuator 808 has to apply twice as much force to the transmission component 810 to displace the end effector 700, and the end effector 700 has to apply half as much force to the transmission component 810 to extend the actuator 808.

In some embodiments, for example, while the end effector alignment-ready configuration, the end effector-urging reaction force that is applied by the front surface 52 of the trailer 12 to the end effector 700, overcomes a resistance force, for example, due to friction in the actuator 808, applied by the actuator 808 to the mounting plate 722, for example, via the transmission component 810, for transitioning the end effector 700 to the end effector alignment-effective configuration.

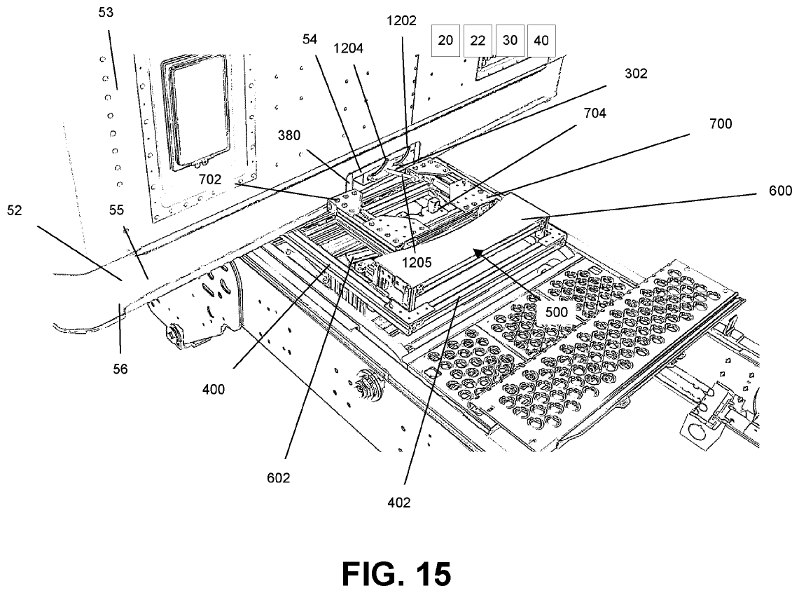

While the end effector 700 is disposed in the end effector alignment-ready configuration, as depicted in FIG. 14, the end effector 700 is transitioned from the end effector alignment-ready configuration to the end effector retracted configuration, as depicted in FIG. 15, for example, via actuation of the actuators 106D.

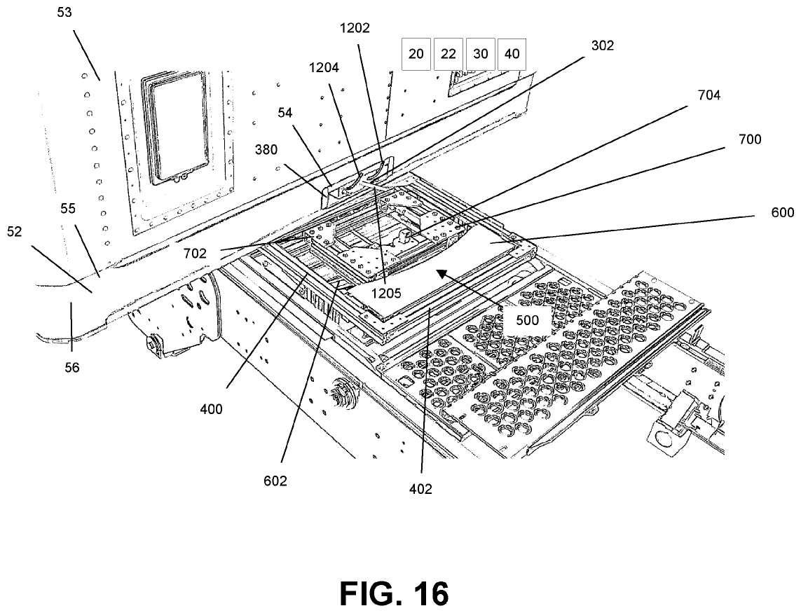

While the end effector 700 is disposed in the end effector retracted configuration, as depicted in FIG. 15, the end effector alignment effector 500 is transitioned from the alignment effector extended configuration to the alignment effector retracted configuration, as depicted in FIG. 16 for example, via actuation of the actuators 106C.

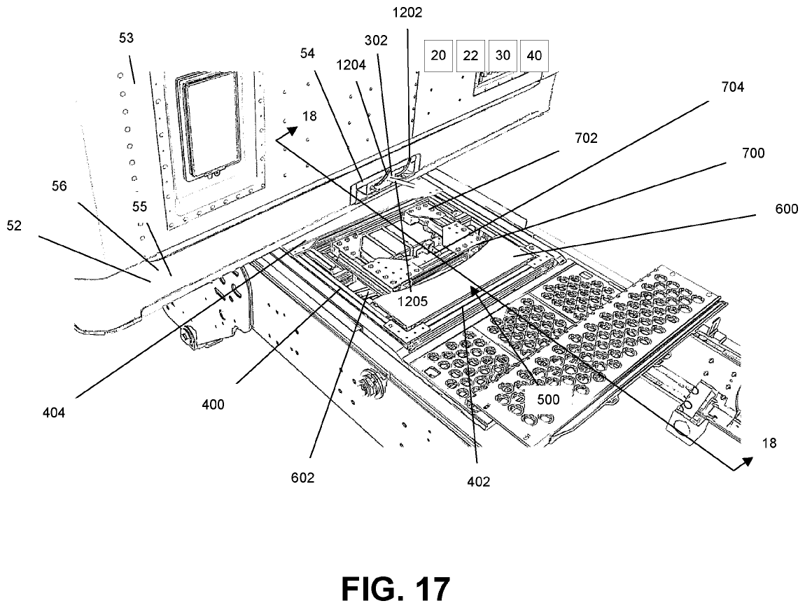

With the end effector alignment effector 500 disposed in the alignment effector retracted configuration, as depicted in FIG. 16, the object manipulator 110 is transitioned from the manipulator extended configuration to the manipulator retracted configuration, as depicted in FIG. 17, for example, via actuation of the actuators 106A and 106B.

At this point, the object manipulator 110 is disposed outside the swing path of the trailer 12, such that the towing vehicle 13 can tow the trailer 12, for example, about a truck yard or on a road. In some embodiments, for example, the towing of the trailer 12 by the towing vehicle 13 is effectible due to the establishment of electrical communication between the electrical energy storage device of the towing vehicle 13 and the electrical system of the trailer 12, the establishment of fluid communication between the fluid energy storage device of the towing vehicle 13 and the fluid system of the trailer 12, and the establishment of data communication between the data communication devices of the towing vehicle 13 and the data communication devices of the trailer 12, as depicted in FIG. 2B, as vehicular operation is actuatable and controllable. For example, during towing of the trailer 12 by the towing vehicle 13, the actuatable electrical system (e.g. ABS brakes and turn signals) and actuatable fluid system (e.g. service brakes and parking brakes) are operable, to effect the towing of the trailer 12 by the towing vehicle 13, and to improve the safety of said towing. In some embodiments, for example, the controller 102 or the controller of the towing vehicle 13 sends a control command to the data communication systems of the trailer 12 for controlling the actuation of the vehicular operation.

At this point, In some embodiments, for example, after the first adapter counterpart 302 and the second adapter counterpart 350 are connected, for example, releasably coupled, operable communication between the energy sources and data communication devices of the trailer 12 and the energy storage devices and data communication devices of the towing vehicle 13, is established, via the adapter 300, as depicted in FIG. 2B, such that energy is transferrable from the energy source of the trailer 12 to the energy storage device of the towing vehicle 13. In this respect, in some embodiments, for example, the towing vehicle 13 and the trailer 12 are disposed in operable communication via the adapter 300. While operable communication between the energy sources and data communication devices of the trailer 12 and the energy storage devices and data communication devices of the towing vehicle 13, via the adapter 300, is established, the controller 102 sends a control command to the energy sources and data communication devices of the trailer 12, via the one or more trailer communicator-defined data conductors 1205 and the one or more towing vehicle communicator-defined data conductors 1305, to effect the transfer of one or more kinds of energy (e.g. diesel, hydrogen, natural gas, pneumatic gas, electricity) from the energy source of the trailer 12 to the energy storage device of the towing vehicle 13 via the adapter 300, the one or more trailer communicator-defined fluid conductors 1202, the one or more towing vehicle communicator-defined fluid conductors 1302, the one or more trailer communicator-defined electrical conductors 1204, and the one or more towing vehicle communicator-defined fluid conductors 1304, to replenish the energy storage devices of the towing vehicle 13. In some embodiments, for example, it is a controller of the towing vehicle 13 that sends the control command to the to the energy sources and data communication devices of the trailer 12 to effect the transfer of one or more kinds of energy (e.g. diesel, hydrogen, natural gas, pneumatic gas, electricity, etc.) from the energy source of the trailer 12 to the energy storage device of the towing vehicle 13. In some embodiments, for example, the energy storage devices of the towing vehicle 13 are replenished while the first adapter counterpart 302 and the second adapter counterpart 350 are releasably coupled, and also while the coupler 704 is releasably coupled to the first adapter counterpart 302. In some embodiments, for example, after the first adapter counterpart 302 and the second adapter counterpart 350 are releasably coupled, the coupler 704 is retracted and the object manipulator 110 is transitioned to the manipulator retracted configuration, and then the energy storage devices of the towing vehicle 13 are replenished.

In some embodiments, for example, after the trailer 12 is towed by the towing vehicle 13 to a desired destination, and/or after it is determined by the controller 102 or the controller of the towing vehicle 13, for example, that the energy storage devices of the towing vehicle 13 are replenished, for example, via detection of the capacity of the energy storage devices, it is desirable to decouple the towing vehicle 13 from the trailer 12, such that the towing vehicle 13 can be driven, separately from the trailer 12, for example, to park the towing vehicle 13, to tow another trailer 12, or to establish operable communication with a trailer 12 having a desired energy source for replenishing an energy storage device of the towing vehicle 13. In such embodiments, for example, while the first adapter counterpart 302 is disposed in operable communication with the second adapter counterpart 350, the object manipulator 110 is configured to align the coupler 704 and first adapter counterpart 302 and effect connection between the coupler 704 and the first adapter counterpart 302, for displacing the first adapter counterpart 302, relative to the second adapter counterpart 350, to defeat the operable communication between the first adapter counterpart 302 and the second adapter counterpart 350.

At this point, the first adapter counterpart 302 and the second adapter counterpart 350 are connected such that the first adapter counterpart 302 is disposed in operable communication with the second adapter counterpart 350, and there is an absence of connection between the coupler 704 and the first adapter counterpart 302 (e.g. the coupler 704 and the first adapter counterpart 302 are disposed in a relative movement effectible relationship).

In some embodiments, for example, while the first adapter counterpart 302 is disposed in operable communication with the second adapter counterpart 350, and while the towing vehicle 13 and trailer 12 are connected via the fifth wheel 15 and kingpin 14, the object manipulator 110 is disposed in the manipulator extended configuration, the end effector alignment effector 500 is disposed in the alignment effector extended configuration, and the end effector 700 is disposed in the end effector alignment-effective configuration, such that the coupler 704 becomes disposed in a coupling-effectible alignment, for example, in alignment along a linear alignment axis, for example, in opposing relationship, with the first adapter counterpart 302, similar to the manner by which the first adapter counterpart 302 is disposed in the operable communication-effectible alignment with the second adapter counterpart 350 for effecting operable communication between the first adapter counterpart 302 with the second adapter counterpart 350, as described above.

In some embodiments, for example, while coupler 704 and the first adapter counterpart 302 are disposed in the coupling-effectible alignment or operable communication-effectible alignment, connection between the coupler 704 and the first adapter counterpart 302 is effectible in response to displacement of the coupler 704 towards the first adapter counterpart 302. In some embodiments, for example, while coupler 704 and the first adapter counterpart 302 are disposed in the coupling-effectible alignment or operable communication-effectible alignment, the coupler 704 and the first adapter counterpart 302 are aligned along an axis that is parallel to the central longitudinal axis of the trailer 12. In some embodiments, for example, while coupler 704 and the first adapter counterpart 302 are disposed in the coupling-effectible alignment or operable communication-effectible alignment, the coupler 704 and the first adapter counterpart 302 are axially aligned along the roll axis.

While the coupler 704 is disposed in the coupling-effectible alignment or operable communication-effectible alignment with the first adapter counterpart 302, the coupler 704 is transitioned from the coupler retracted configuration to the coupler extended configuration, with effect that connection of the coupler 704 with the first adapter counterpart 302 is established, for example, via co-operation of the second connector counterpart 315 of the first adapter counterpart 302 and the first connector counterpart 232 of the coupler 704. In some embodiments, for example, while the connection between the coupler 704 and the first adapter counterpart 302 is established via the second connector counterpart 315 of the first adapter counterpart 302 and the first connector counterpart 232 of the coupler 704, the coupler 704 and the first adapter counterpart 302 are disposed in a relative movement interference relationship.

In some embodiments, for example, the displacement of the coupler 704 towards the first adapter counterpart 302, for effecting establishment of connection between the coupler 704 and the first adapter counterpart 302, is guided by the co-operation of the guide pins 322 of the first adapter counterpart 302 and the guide ports 240 of the coupler 704.

While the coupler 704 and the first adapter counterpart 302 are disposed in the coupling-effectible alignment, the displacement of the coupler 704 towards the first adapter counterpart 302 is with effect that the coupler 704 is displaced through the opening 382 of the frame 380. In response to further displacement of the coupler 704 towards the first adapter counterpart 302, for example, via the actuator 106E, the guide pins 322 of the first adapter counterpart 302 are received into the guide ports 240 of the coupler 704 to guide further displacement of the coupler 704 towards the first adapter counterpart 302. In response to further displacement of the coupler 704 towards the first adapter counterpart 302, the coupler 704 becomes connected with the first adapter counterpart 302, for example, via co-operation of the second connector counterpart 315 of the first adapter counterpart 302 and the first connector counterpart 232 of the coupler 704.

While the coupler 704 is coupled with the first adapter counterpart 302, the coupler 704 is transitioned from the coupler extended configuration to the coupler retracted configuration, with effect that the operable communication between the first adapter counterpart 302 and the trailer defined adapter counterpart 350 is defeated. In some embodiments, for example, while the coupler 704 is coupled with the first adapter counterpart 302, the transitioning of the coupler 704 from the coupler extended configuration to the coupler retracted configuration overcomes the friction established between the: (i) electrical connectors 308 and electrical ports 3080, (ii) fluid connectors 310 and fluid ports 3100, (iii) data connectors 314 and data ports 3140, and/or (iv) guide pins 312 and guide ports 3120, for defeating the connection between the first adapter counterpart 302 and the second adapter counterpart 350. At this point, in some embodiments, for example, the first adapter counterpart 302 and the second adapter counterpart 350 are disposed in a relative movement effectible relationship. While the operable communication between the first adapter counterpart 302 and the second adapter counterpart 350 is defeated, the end effector 700 is transitioned to the end effector retracted configuration, the end effector alignment effector 500 is transitioned to the alignment effector retracted configuration, and the object manipulator 110 is transitioned to the manipulator retracted configuration, similar to the manner as described above. At this point, in some embodiments, for example, the controller 102 or controller of the towing vehicle 13 sends a control command to the fifth wheel coupling 15 to decouple from the kingpin 14, and in other embodiments, for example, the fifth wheel coupling 15 and the kingpin 14 are decoupled manually, for example, by an operator With the fifth wheel coupling 15 decoupled from the kingpin 14, the towing vehicle 13 is decoupled from the trailer 12, and the towing vehicle 13 can drive elsewhere, for example, to effect operable communication between the first adapter counterpart 302 and a second adapter counterpart 350 that is mounted on another trailer 12, for actuating a vehicular operation of the another trailer 12, or for replenishing an energy storage device of the towing vehicle 13.

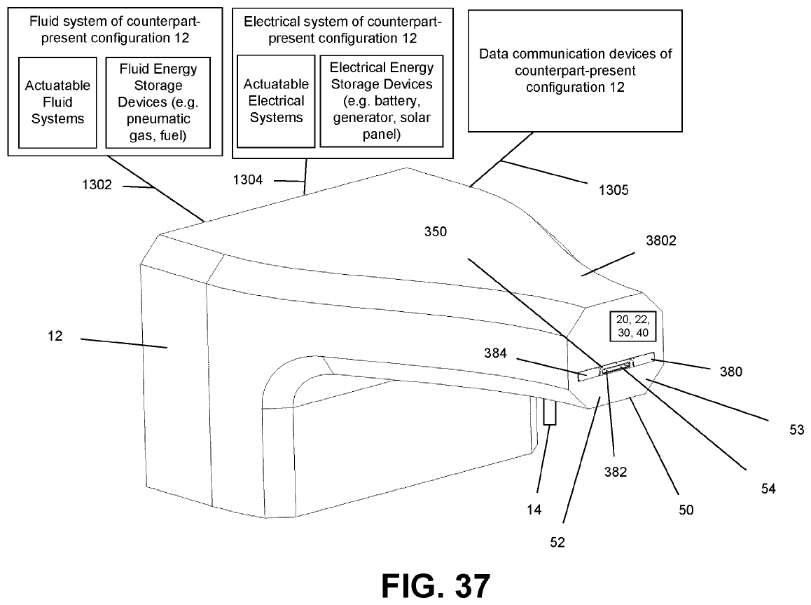

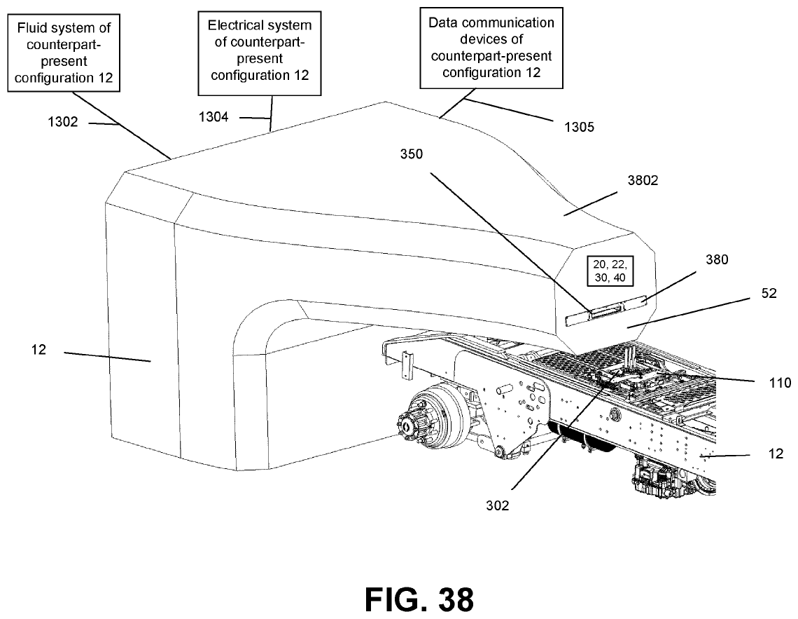

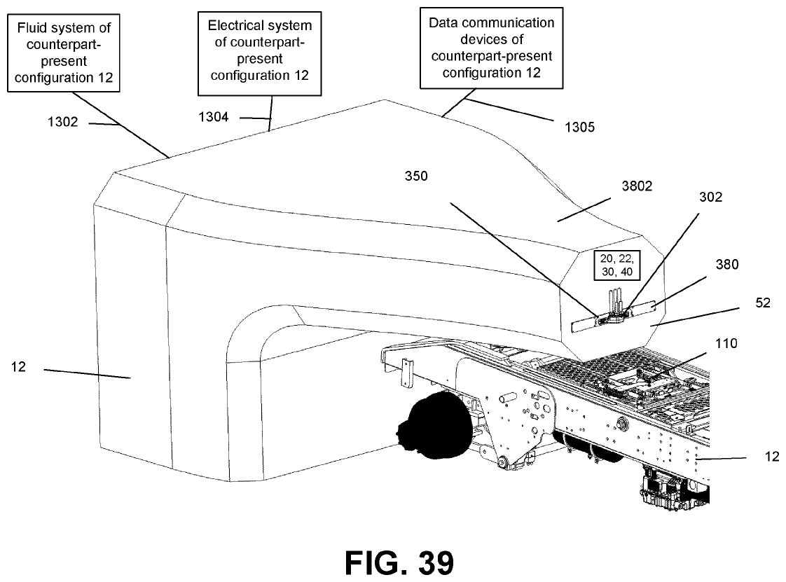

In some embodiments, for example, as depicted in FIG. 37 to FIG. 39, the counterpart-disposed configuration 12 is a charging dock 12. The charging dock 12 has substantially the same features as the trailer 12, including fluid systems including one or more fluid energy sources (e.g. pneumatic gas, diesel, natural gas, hydrogen, etc.), electrical systems including one or more electrical energy sources, data communication devices, the front surface 52, the bottom surface 50, the opening 54, the frame 380, the second adapter counterpart 350 mounted to the charging dock 12 such that it is facing in a direction towards the front surface 52 the fluid connector 20, the fuel connector 22, the electrical connector 30, and the data connector 40, and the kingpin 14, except the charging dock 12 is not towable by the vehicle 13. In some embodiments, for example, the charging dock 12 is part of a building, for example, comprising a plurality of charging docks 12, a loading bay, a warehouse, a shipping area, and the like. In some embodiments, for example, the charging dock 12 is a standalone charging dock 12. In some embodiments, for example, the charging dock 12 and the vehicle 13 are supported by the same reaction surface (e.g. the ground). In some embodiments, for example, the charging dock 12 is secured to the reaction surface, such that the charging dock 12 is not displaceable, relative to the reaction surface.

The connection of the first adapter counterpart 302 of the vehicle 13 and the second adapter counterpart 350 of the charging dock 12, for establishing operable communication between the fluid systems, electrical systems, and data communication devices of the charging dock 12 and the energy storage devices and data communication devices of the vehicle 13, is effectuated in a manner that is substantially similar to the manner by which the connection of the first adapter counterpart 302 of the vehicle 13 and the second adapter counterpart 350 of the trailer 12 is effectuated, as described herein.

While the first adapter counterpart 302 of the vehicle 13 and the second adapter counterpart 350 of the charging dock 12 are connected, such that operable communication between the fluid systems, electrical systems, and data communication devices of the charging dock 12 and the energy storage devices and data communication devices of the vehicle 13 is established, actuatable systems of the charging dock 12 can be actuated by the energy sources of the vehicle 13, and the energy storage devices of the vehicle 13 can be replenished by the energy sources of the charging dock 12, in a manner that is substantially similar to the manner by which the actuatable systems of the trailer 12 can be actuated by the energy sources of the vehicle 13, and the energy storage devices of the vehicle 13 can be replenished by the energy sources of the trailer 12, as described herein.

In some embodiments, example, the kingpin 14 of the charging dock 12 is connected to a charging dock body 3802, such that the kingpin 14 extends from the charging dock body 3802. The connection of the kingpin 14 to the charging dock body 3802 is such that the kingpin 14 is displaceable, relative to the charging dock body 3802. In some embodiments, for example, the kingpin 14 is displaceable, relative to the charging dock body 3802, along a longitudinal axis (e.g. displacement in a forward or rearward direction), along a lateral axis (e.g. displacement in a left or right direction), or a combination thereof. In some embodiments, for example, the displaceability of the kingpin 14, relative to the charging dock body 3802, is effectuated by a spring assembly.

In some embodiments, for example, to dispose the object manipulator 110 of the vehicle and the counterpart-disposed configuration 12, for example, the charging dock 12, in the guiding-effective relationship, the fifth wheel coupling 15 of the vehicle 13 and the kingpin 14 are coupled. To couple the fifth wheel coupling 15 and the kingpin 14, the vehicle 13 is displaced towards the charging dock 12, such that the fifth wheel coupling 15 is displaced towards the kingpin 14, such that a surface of the fifth wheel coupling 15 is disposed in contact engagement with the kingpin 14. In response to further displacement of the vehicle 13 towards the charging dock 12, the fifth wheel coupling 15 is displaced towards the kingpin 14, such that a force is applied by the fifth wheel coupling 15 to the kingpin 14, with effect that the kingpin 14 is displaced, relative to the charging dock body 3802. In some embodiments, for example, the displacement of the kingpin 14, relative to the charging dock body 3802, is with effect that the kingpin 14 and the fifth wheel coupling 15, for example, a slot of the fifth wheel coupling 15, become disposed in alignment. In response to further displacement of the vehicle 13 towards the charging dock 12, such that the fifth wheel coupling 15 is displaced towards the kingpin 14, the fifth wheel coupling 15 and the kingpin 14 become coupled, for example, at the center 15A of the fifth wheel 15.

In some embodiments, for example, it is desirable for the kingpin 14 to be displaceable, relative to the charging dock body 3802, such that, while the fifth wheel coupling 15 is displaced towards the kingpin 14 and the force is applied to the kingpin 14 by the fifth wheel coupling 15, the stress experienced by the kingpin 14 and the charging dock body 3802 is reduced, which, in some embodiments, for example, reduces damage or wear and tear to the kingpin 14 and the charging dock body 3802. In some embodiments, for example, by reducing the stress experienced by the kingpin 14 and the charging dock body 3802, shearing of the kingpin 14 from the charging dock body 3802 is mitigated.

In some embodiments, for example, a kit for modifying a vehicle and a counterpart-absent configuration, such as a counterpart-absent trailer or a counterpart-absent charging dock, includes vehicle adaptor components and configuration adapter components. The vehicle adaptor components includes a vehicle-defined connection counterpart, for example, the first adapter counterpart 302, and an object manipulator, for example, the object manipulator 110, including, for example, an end effector, such as the end effector 704, configured for being releasably coupled with the vehicle-defined connection counterpart, such that a coupled end effector is established, and a guide, for example, the guide assembly 606. The configuration adaptor components include a configuration-defined connection counterpart, for example, the second adapter counterpart 350. The vehicle-defined connection counterpart is configured for connection to the configuration-defined connection counterpart.

While: (i) the vehicle adaptor components are installed within a vehicle 13, with effect that a modified vehicle is established, such that the modified vehicle includes the vehicle-defined connection counterpart 302 and the object manipulator 110, and (ii) the configuration adaptor components are installed within the counterpart-absent configuration with effect that a modified configuration is established, such that the modified configuration includes the configuration-defined connection counterpart:
the modified vehicle and the modified configuration are co-operatively configured such that:
while: (i) the coupled end effector is established, (ii) the vehicle-defined connection counterpart and the configuration-defined connection counterpart are co-operatively disposed in a misaligned relationship, wherein, in the misaligned relationship, there is an absence of alignment between the vehicle-defined connection counterpart and the configuration-defined connection counterpart, and (iii) the object manipulator is disposed in a guiding-effective relationship with the modified configuration, wherein, in the guiding-effective relationship, contact engagement between the object manipulator and the front surface and bottom surface of the modified configuration is effectible:
while the object manipulator is disposed in contact engagement with the front surface and bottom surface, in response to a force applied to the object manipulator for urging displacement of the object manipulator towards the front surface and the bottom surface, an alignment reaction force is applied by the front surface and the bottom surface to the object manipulator to urge displacement of the object manipulator, with effect that an alignment relationship-obtaining displacement of the coupled end effector, relative to the configuration-defined connection counterpart, is effectuated by the alignment reaction force, wherein the alignment relationship-obtaining displacement is guided by the guide, wherein the guided displacement is effective for emplacing the vehicle-defined connection counterpart in alignment with the configuration-defined connection counterpart, such that the vehicle-defined connection counterpart and the configuration-defined connection counterpart become disposed in an alignment relationship for establishing connection between the vehicle-defined connection counterpart and the configuration-defined connection counterpart.

In some embodiments, for example, a kit for modifying a vehicle 13 and a counterpart-absent configuration, such as a counterpart-absent trailer or a counterpart-absent charging dock, includes vehicle adaptor components and configuration adapter components. The vehicle adaptor components includes a vehicle-defined connection counterpart, for example, the first adapter counterpart 302, and an object manipulator, for example, the object manipulator 110, including, for example, an end effector, such as the end effector 704, configured for being releasably coupled with the vehicle-defined connection counterpart, such that a coupled end effector is established, a pivotable platform, for example, platform 400, and a curved guide or curved track, such as the curved guide 602 of the guide assembly 606. The configuration adaptor components include a configuration-defined connection counterpart, for example, the second adapter counterpart 350. The vehicle-defined connection counterpart is configured for connection to the configuration-defined connection counterpart.

While: (i) the vehicle adaptor components are installed within a vehicle, with effect that a modified vehicle is established, such that the modified vehicle includes the vehicle-defined connection counterpart and the object manipulator, and (ii) the configuration adaptor components are installed within the counterpart-absent configuration with effect that a modified configuration is established, such that the modified configuration includes the configuration-defined connection counterpart:
the modified vehicle and the modified configuration are co-operatively configured such that:
while: (i) the coupled end effector is established, (ii) the vehicle-defined connection counterpart and the configuration-defined connection counterpart are co-operatively disposed in a misaligned relationship, wherein, in the misaligned relationship, there is an absence of alignment between the vehicle-defined connection counterpart and the configuration-defined connection counterpart, and (iii) the object manipulator is disposed in a guiding-effective relationship with the modified configuration, wherein, in the guiding-effective relationship, contact engagement between the pivotable platform and the modified configuration is effectible, and contact engagement between the coupled end effector and the modified configuration is effectible:
the pivotable platform is configured to co-operate with the modified configuration such that, while the pivotable platform is disposed in contact engagement with the modified configuration, in response to a platform-displacement force applied to the pivotable platform to urge displacement of the pivotable platform towards the modified configuration, a platform-urging reaction force is applied by the counterpart-disposed configuration to the pivotable platform to urge pivoting of the object manipulator, with effect that a pivoting of the coupled end effector, relative to the configuration-defined connection counterpart, is effectuated by the platform-urging reaction force, wherein the pivoting is effective for emplacing the vehicle-defined connection counterpart in angular alignment with the configuration-defined connection counterpart about a pitch axis;
the curved track and the end effector are configured to co-operate with the modified configuration such that, while the coupled end effector is disposed in contact engagement with the modified configuration, in response to an end effector-displacement force applied to the end effector to urge displacement of the end effector towards the modified configuration, an end effector-urging reaction force is applied by the modified configuration to the end effector to urge displacement of the end effector, with effect that a curvilinear displacement of the coupled end effector, relative to the configuration-defined connection counterpart, is effectuated by the end effector-urging reaction force, wherein the curvilinear displacement is guided by the curved track along the curved path, wherein the curvilinear displacement is effective for emplacing the vehicle-defined connection counterpart in angular alignment with the configuration-defined connection counterpart about a yaw axis;
wherein the pivoting and curvilinear displacement of the coupled end effector are for emplacing the vehicle-defined connection counterpart in alignment with the configuration-defined connection counterpart, such that the vehicle-defined connection counterpart and the configuration-defined connection counterpart become disposed in an alignment relationship for establishing connection between the vehicle-defined connection counterpart and the configuration-defined connection counterpart.

In some embodiments, for example, a system includes the vehicle 13 and the counterpart-disposed configuration 12, for example, the trailer 12 or the charging dock 12.

In some embodiments, for example, wherein a vehicle 13 includes an object manipulator 110 for coupling with a first adapter counterpart 302, and the vehicle 13 is coupled to a counterpart-absent configuration, such as a trailer or charging dock that does not include a second adapter counterpart 350, communication between the vehicle 13 and the counterpart-absent configuration is effectible for actuating a vehicular operation, or for replenishing an energy storage device of the vehicle 13.

As described above, in some embodiments, for example, the vehicle 13 comprises a vehicle-defined counterpart, such as the first adapter counterpart 302, an energy storage device (e.g. pneumatic gas storage device, fuel storage device, or electrical energy storage device), and a vehicle-defined communicator 120 that is disposed in communication with the energy storage device. The vehicle-defined communicator 120 is configured for connection with the first adapter counterpart 302, such that a communicating counterpart is established, with effect that communication is established between the first adapter counterpart 302 and the energy storage device. In some embodiments, for example, the vehicle 13 includes more than one energy storage device.

The vehicle 13 is configured to co-operate with a counterpart-present configuration 12, for example, the trailer 12 as depicted in FIG. 1, or the charging dock 12 as depicted in FIG. 37. The counterpart-present configuration 12 comprises a configuration-defined connection counterpart, such as the second adapter counterpart 350, and a counterpart-present configuration system (e.g. fluid system or electrical system of the configuration 12) that is disposed in communication with the second adapter counterpart 350. The co-operation of the vehicle 13 and the counterpart-present configuration 12 is such that while: (i) the communicating counterpart is established, and (ii) vehicle-defined connection counterpart is connected to the configuration-defined connection counterpart, operable communication between the energy storage device and the counterpart-present configuration system is established, for example, for actuating a vehicular operation or actuatable system of the counterpart-present configuration 12 and controlling the actuation of the vehicular operation or the actuatable system, and/or for replenishing the energy storage device of the vehicle 13 by an energy source of the counterpart-present configuration system of the counterpart-present configuration 12, for example, as described herein with respect to the vehicle 13 and trailer 12, and/or the vehicle 13 and docking station 12.

The vehicle 13 is further configured to co-operate with a counterpart-absent configuration, wherein the configuration-defined connection counterpart is absent from the counterpart-absent configuration 12 (e.g. a trailer or a charging dock that does not include the counterpart-defined connection counterpart). The counterpart-absent configuration further comprises a counterpart-absent configuration system (e.g. fluid system or electrical system) and a counterpart-absent configuration-defined connector that is disposed in communication with the actuatable counterpart-absent configuration system. The co-operation of the vehicle 13 and the counterpart-absent configuration is such that, while there is an absence of connection between the vehicle-defined communicator 120 and the vehicle-defined connection counterpart, the vehicle-defined communicator 120 is connectible with the counterpart-absent configuration-defined connector, with effect that communication between the energy storage device of the vehicle 13 and the counterpart-absent configuration system is established, for example, for actuating a vehicular operation or actuatable system of the counterpart-absent configuration and controlling the actuation of the vehicular operation or the actuatable system, and/or for replenishing the energy storage device of the vehicle 13 by an energy source of the counterpart-absent configuration system of the counterpart-absent configuration. In some embodiments, for example, the absence of connection between the vehicle-defined communicator 120 and the vehicle-defined connection counterpart is in response to defeating of the connection between the vehicle-defined communicator 120 and the vehicle-defined connection counterpart.

In some embodiments, for example, the energy storage device of the vehicle 13 is a fluid energy storage device, such as a pneumatic gas storage device, the vehicle-defined communicator 120 is a vehicle-defined fluid conductor 1202, the counterpart-absent configuration-defined connector is a fluid connector 20 such as a glad hand, and the counterpart-absent configuration system is an counterpart-absent configuration fluid system (e.g. pneumatic gas system), wherein the counterpart-absent configuration fluid system is disposed in fluid communication with the fluid connector 20. In some embodiments, for example, while there is an absence of connection between the vehicle-defined fluid conductor 1202 and the vehicle-defined connection counterpart, the vehicle-defined fluid conductor 1202 is connectible with the fluid connector 20, with effect that fluid communication between the fluid energy storage device and the counterpart-absent configuration fluid system is established for actuating the vehicular operation of the counterpart-absent configuration 12. In some embodiments, for example, the counterpart-absent configuration fluid system comprises service brakes, and the vehicular operation that is actuatable, in response to the establishment of fluid communication between the fluid energy storage device and the counterpart-absent configuration fluid system, is actuation of the service brakes. In some embodiments, for example, the counterpart-absent configuration fluid system comprises parking brakes, and the vehicular operation that is actuatable, in response to the establishment of fluid communication between the fluid energy storage device source and the counterpart-absent configuration fluid system, is actuation of the parking brakes. In some embodiments, for example, while there is an absence of connection between the vehicle-defined fluid conductor 1202 and the vehicle-defined connection counterpart, the vehicle-defined fluid conductor 1202 is connectible with the fluid connector 20, with effect that fluid communication between the fluid energy storage device and the counterpart-absent configuration fluid system is established for transferring fluid energy from the fluid energy source of the counterpart-absent configuration to the fluid energy storage device of the vehicle 13. In some embodiments, for example, the fluid energy includes pneumatic gas. In some embodiments, for example, the fluid energy includes natural gas. In some embodiments, for example, the fluid energy includes hydrogen.

In some embodiments, for example, the energy storage device of the vehicle 13 is a fuel storage device, the vehicle-defined communicator 120 includes a vehicle-defined fluid conductor 1202, the counterpart-absent configuration-defined connector is a fuel connector 22, as depicted in FIG. 1, and counterpart-absent configuration system of the counterpart-absent configuration is an counterpart-absent configuration fluid system that includes a fluid energy source that is a fuel source, wherein the fuel source is disposed in fluid communication with the fuel connector 22. In some embodiments, for example, while there is an absence of connection between the vehicle-defined fluid conductor 1202 and the vehicle-defined connection counterpart, the vehicle-defined fluid conductor 1202 is connectible with the fuel connector 22, with effect that fluid communication between the fuel storage device of the vehicle 13 and the fuel source of the counterpart-absent configuration is established for transferring fuel from the fuel energy source of the counterpart-absent configuration to the fuel storage device of the vehicle 13. In some embodiments, for example, the fuel includes diesel.

In some embodiments, for example, the energy storage device is an electrical energy storage device, the vehicle-defined communicator 120 is a vehicle-defined electrical conductor 1204, the counterpart-absent trailer-defined connector is an electrical connector 30 (e.g. pin connector, 7-pin connector, 30-pin connector, fast charge adapter, etc.), and the counterpart-absent configuration system is a counterpart-absent configuration electrical system, wherein the actuatable counterpart-absent configuration electrical system is disposed in electrical communication with the electrical connector 30. In some embodiments, for example, while there is an absence of connection between the vehicle-defined electrical conductor 1204 and the vehicle-defined connection counterpart, the vehicle-defined electrical conductor 1204 is connectible with the electrical connector 30, with effect that electrical communication between the electrical energy storage device and the counterpart-absent configuration electrical system is established for actuating the vehicular operation of the counterpart-absent configuration. In some embodiments, for example, the counterpart-absent configuration electrical system comprises ABS brakes, and the vehicular operation that is actuatable, in response to the establishment of electrical communication between the electrical energy storage device and the actuatable counterpart-absent configuration electrical system, is actuation of the ABS brakes. In some embodiments, for example, the counterpart-absent configuration electrical system comprises turn signals, and the vehicular operation that is actuatable, in response to the establishment of electrical communication between the electrical energy storage device and the counterpart-absent configuration electrical system, is actuation of the turn signals. In some embodiments, for example, while there is an absence of connection between the vehicle-defined electrical conductor 1204 and the vehicle-defined connection counterpart, the vehicle-defined electrical conductor 1204 is connectible with the electrical connector 30, with effect that electrical communication between the electrical energy storage device of the vehicle 13 and the electrical energy source of the counterpart-absent configuration is established for transferring electrical energy from the electrical energy source of the counterpart-absent configuration to the electrical energy storage device of the vehicle 13.

In some embodiments, for example, the vehicle 13 includes one or more data communication devices, the vehicle-defined communicator 120 includes a vehicle-defined data conductor 1205 disposed in data communication with the data communication devices, for example, via a data communication system (e.g. databus), the counterpart-absent configuration-defined connector is a data connector 40 (e.g. a data port), and the counterpart-absent configuration includes one or more data communication devices, wherein the data communication devices is disposed in data communication with the data connector 40. In some embodiments, for example, while there is an absence of connection between the towing vehicle-defined data conductor 1205 and the vehicle-defined connection counterpart, the vehicle-defined data conductor 1205 is connectible with the data connector 40, with effect that data communication between the data communication devices of the vehicle 13 and the data communication devices of the counterpart-absent configuration is established for controlling the actuation of the vehicular operation, and for controlling the transferring of energy from the energy source of the counterpart-absent configuration to the energy storage device of the vehicle 13.

In some embodiments, for example, the second adapter counterpart 350 is disposed in fluid communication with a fluid connector 20 (e.g. a glad hand 20) that is mounted to the front wall 53 of the counterpart-present configuration 12, as depicted in FIG. 1, via a parallel circuit. The fluid connector 20 is disposed in fluid communication with the fluid system of the counterpart-present configuration 12. In some embodiments, for example, wherein the object manipulator 110 is unable to effect operable communication between the first adapter counterpart 302 and the second adapter counterpart 350, such that the fluid energy storage device of the vehicle 13 and the fluid system of the counterpart-present configuration 12 do not become disposed in fluid communication, an operator can manually establish said fluid communication. In some embodiments, for example, an operator can decouple the configuration communicator-defined fluid conductor 1202 from the first adapter counterpart 302 via the configuration communicator-defined fluid communication counterpart 1206. Then, the operator can couple the configuration communicator-defined fluid communication counterpart 1206 with the fluid connector 20, with effect that the fluid energy storage device of the vehicle 13 and the fluid system of the counterpart-present configuration 12 become disposed in fluid communication.

In some embodiments, for example, the second adapter counterpart 350 is disposed in fluid communication with a fuel connector 22 that is mounted to the counterpart-present configuration 12, for example, the front wall 53 of the counterpart-present configuration 12, via a parallel circuit. The fuel connector 22 is disposed in fluid communication with a fuel source of the fluid system of the counterpart-present configuration 12. In some embodiments, for example, wherein the object manipulator 110 is unable to effect operable communication between the first adapter counterpart 302 and the second adapter counterpart 350, such that the fuel storage device of the vehicle 13 and the fuel source of the counterpart-present configuration 12 do not become disposed in fluid communication, an operator can manually establish said fluid communication. In some embodiments, for example, an operator can decouple the configuration communicator-defined fluid conductor 1202 from the first adapter counterpart 302 via the configuration communicator-defined fluid communication counterpart 1206. Then, the operator can couple the configuration communicator-defined fluid communication counterpart 1206 with the fuel connector 22, with effect that the fuel storage device the vehicle 13 and the fuel source of the counterpart-present configuration 12 become disposed in fluid communication.

In some embodiments, for example, the second adapter counterpart 350 is disposed in electrical communication with a electrical connector 30 (e.g. 7-pin electrical connector, 30-pin electrical connector, fast charge adapter, etc.) that is mounted to the front wall 53 of the counterpart-present configuration 12, as depicted in FIG. 1, via a parallel circuit. The electrical connector 30 is disposed in electrical communication with the electrical system of the counterpart-present configuration 12. In some embodiments, for example, wherein the object manipulator 110 is unable to effect operable communication between the first adapter counterpart 302 and the second adapter counterpart 350, such that the electrical energy storage device of the vehicle 13 and the electrical system of the counterpart-present configuration 12 do not become disposed in electrical communication, an operator can manually establish said electrical communication. In some embodiments, for example, an operator can decouple the configuration communicator-defined electrical conductor 1204 from the first adapter counterpart 302 via the configuration communicator-defined electrical communication counterpart 1208. Then, the operator can couple the configuration communicator-defined electrical communication counterpart 1208 with the electrical connector 30, with effect that the electrical energy storage device of the vehicle 13 and the electrical system of the counterpart-present configuration 12 become disposed in electrical communication.

In some embodiments, for example, the second adapter counterpart 350 is disposed in data communication with a data connector 40 (e.g. a data port, pin connector) that is mounted to the counterpart-present configuration 12, for example, the front wall 53 of the counterpart-present configuration 12, as depicted in FIG. 1, via a parallel circuit. The data connector 40 is disposed in data communication with the data communication devices of the counterpart-present configuration 12. In some embodiments, for example, wherein the object manipulator 110 is unable to effect operable communication between the first adapter counterpart 302 and the second adapter counterpart 350, such that the data communication devices of the vehicle 13 and the data communication devices of the counterpart-present configuration 12 do not become disposed in data communication, an operator can manually establish said data communication. In some embodiments, for example, an operator can decouple the configuration communicator-defined data conductor 1205 from the first adapter counterpart 302 via the configuration communicator-defined data communication counterpart 1209. Then, the operator can couple the configuration communicator-defined data communication counterpart 1209 with the data connector 40, with effect that the data communication devices of the vehicle 13 and the data communication devices of the counterpart-present configuration 12 become disposed in data communication.

In some embodiments, for example, the vehicle 13, including the object manipulator 110, is coupled to a counterpart-absent configuration, for example, via the fifth wheel 15 and kingpin 14, wherein the counterpart-absent configuration does not have a second adapter counterpart 350 mounted thereon, but includes the fluid connector 20, fuel connector 20, electrical connector 30, and data connector 40.

In such embodiments, for example, an operator can decouple the configuration communicator-defined fluid conductor 1202 from the first adapter counterpart 302 via the configuration communicator-defined fluid communication counterpart 1206. Then, the operator can couple the configuration communicator-defined fluid communication counterpart 1206 with the fluid connector 20, with effect that the fluid energy storage device of the vehicle 13 and the fluid system of the counterpart-absent configuration become disposed in fluid communication. Similarly, an operator can decouple the configuration communicator-defined fluid conductor 1202 from the first adapter counterpart 302 via the configuration communicator-defined fluid communication counterpart 1206. Then, the operator can couple the configuration communicator-defined fluid communication counterpart 1206 with the fuel connector 22, with effect that the fuel storage device of the vehicle 13 and the fuel source of the counterpart-absent configuration become disposed in fluid communication. Similarly, an operator can decouple the configuration communicator-defined electrical conductor 1204 from the first adapter counterpart 302 via the configuration communicator-defined electrical communication counterpart 1208. Then, the operator can couple the configuration communicator-defined electrical communication counterpart 1208 with the electrical connector 30, with effect that the electrical energy storage device of the vehicle 13 and the electrical system of the counterpart-absent configuration become disposed in electrical communication. Similarly, an operator can decouple the configuration communicator-defined data conductor 1205 from the first adapter counterpart 302 via the configuration communicator-defined data communication counterpart 1209. Then, the operator can couple the configuration communicator-defined data communication counterpart 1209 with the data connector 40, with effect that the data communication devices of the vehicle 13 and the data communication devices of the counterpart-absent configuration become disposed in data communication.

Similarly, wherein a counterpart-present configuration 12 includes the second adapter counterpart 350, the fluid connector 20, fuel connector 22, the electrical connector 30, and the data connector 40, and the counterpart-present configuration 12 is coupled to a vehicle 13 wherein the first adapter counterpart 302 is absent from the vehicle 13 (e.g. the object manipulator 110 is not installed on the vehicle 13), the operator can: (i) operably couple the vehicle-defined fluid conductor 1202 with the fluid connector 20 of the counterpart-present configuration 12, with effect that the fluid energy storage device of the vehicle 13 and the fluid system of the counterpart-present configuration 12 become disposed in fluid communication, (ii) operably couple the vehicle-defined fluid conductor 1202 with the fuel connector 22 of the counterpart-present configuration 12, with effect that the fuel storage device of the vehicle 13 and the fuel source of the counterpart-present configuration 12 become disposed in fluid communication, (iii) operably couple the vehicle-defined electrical conductor 1204 with the electrical connector 30, with effect that the electrical energy storage device of the vehicle 13 and the electrical system of the counterpart-present configuration 12 become disposed in electrical communication, and (iii) operably couple the vehicle-defined data conductor 1205 with the data connector 40, with effect that the data communication devices of the vehicle 13 and the data communication devices of the counterpart-present configuration 12 become disposed in data communication.

In some embodiments, for example, a kit for modifying a vehicle, the vehicle comprising an energy storage device, includes vehicle adapter components, comprising: a vehicle-defined connection counterpart, for example, the first adapter counterpart 302, and a vehicle-defined communicator, for example, the vehicle-defined communicator 120, configured to be disposed in communication with the energy storage device, and configured to be disposed for connection with the vehicle-defined connection counterpart, such that a communicating counterpart is established, with effect that communication is established between the vehicle-defined connection counterpart and the energy storage device.

While the vehicle adaptor components are installed within a vehicle, with effect that a modified vehicle is established, such that the modified vehicle includes the vehicle-defined connection counterpart and the object manipulator:
the modified vehicle is configured to co-operate with a counterpart-present configuration, wherein the counterpart-present configuration comprises: a configuration-defined connection counterpart; and a counterpart-present configuration system that is disposed in communication with the configuration-defined connection counterpart.

The co-operation of the modified vehicle and the counterpart-present configuration is such that:
while: (i) the communicating counterpart is established, and (ii) the vehicle-defined connection counterpart is connected to the configuration-defined connection counterpart, communication between the energy storage device and the counterpart-present configuration system is established.

The modified vehicle is further configured to co-operate with a counterpart-absent configuration, wherein the configuration-defined connection counterpart is absent from the counterpart-absent configuration, the counterpart-absent configuration further comprising: a counterpart-absent configuration system; and a counterpart-absent configuration-defined connector that is disposed in communication with the counterpart-absent configuration system.

The co-operation of the modified vehicle and the counterpart-absent configuration is such that:
while there is an absence of connection between the vehicle-defined communicator and the vehicle-defined connection counterpart, the vehicle-defined communicator is connectible with the counterpart-absent configuration-defined connector, with effect that communication between the energy storage device and the counterpart-absent configuration system is established.

In some embodiments, for example, a system includes the vehicle 13, the counterpart-absent configuration, and the counterpart-present configuration 12.

In some embodiments, for example, wherein the vehicle 13 is a tractor, the object manipulator 110 is mounted on the frame 40 in a recess 41 defined forwardly of the fifth wheel 15. In some embodiments, for example, wherein the vehicle 13 is a terminal tractor, the object manipulator 110 is mounted on a fifth wheel boom in a recess defined by the fifth wheel boom.

In some embodiments, for example, the guided displacement of the end effector 700, by the guide assembly 606, is effected mechanically, for example, by a reaction force applied to the end effector 700 by the front surface 52. In some embodiments, for example, the guided displacement of the end effector 700, by the guide assembly 606, is not effected electrically, for example, by a motor, such that, in the absence of electrical power to such a motor, the end effector 700 is still guidedly displaceable by the guide assembly 606.

In some embodiments, for example, the disposition of the object manipulator 110 between the fifth wheel 15 and cab of the towing vehicle 13 provides relative ease of access by an operator to the object manipulator 110, towing vehicle defined fluid conductor 1202, and towing vehicle defined electrical conductor 1204, and towing vehicle defined data conductor 1205, in the event that manual connection between the towing vehicle 13 and the configuration 12 is needed.

In the preceding description, for purposes of explanation, numerous details are set forth in order to provide a thorough understanding of the embodiments; however the specific details are not necessarily required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

The steps and/or operations in the flowcharts and drawings described herein are for purposes of example only. There may be many variations to these steps and/or operations without departing from the teachings of the present disclosure. For instance, the steps may be performed in a differing order, or steps may be added, deleted, or modified.

The coding of software for carrying out the above-described methods described for execution by a controller (or processor) of the apparatus 100 is within the scope of a person of ordinary skill in the art having regard to the present disclosure. Machine readable code executable by one or more processors of one or more respective devices to perform the above-described method may be stored in a machine readable medium such as the memory of the data manager. The terms “software” and “firmware” are interchangeable within the present disclosure and comprise any computer program stored in memory for execution by a processor, comprising RAM memory, ROM memory, erasable programmable ROM (EPROM) memory, electrically EPROM (EEPROM) memory, and non-volatile RAM (NVRAM) memory. The above memory types are example only, and are thus not limiting as to the types of memory usable for storage of a computer program.

All values and sub-ranges within disclosed ranges are also disclosed. Also, although the systems, devices and processes disclosed and shown herein may comprise a specific plurality of elements/components, the systems, devices and assemblies may be modified to comprise additional or fewer of such elements/components. For example, although any of the elements/components disclosed may be referenced as being singular, the embodiments disclosed herein may be modified to comprise a plurality of such elements/components. The subject matter described herein intends to cover and embrace all suitable changes in technology.

Although the present disclosure is described, at least in part, in terms of methods, a person of ordinary skill in the art will understand that the present disclosure is also directed to the various components for performing at least some of the aspects and features of the described methods, be it by way of hardware (DSPs, ASIC, or FPGAs), software or a combination thereof. Accordingly, the technical solution of the present disclosure may be embodied in a non-volatile or non-transitory machine readable medium (e.g., optical disk, flash memory, etc.) having stored thereon executable instructions tangibly stored thereon that enable a processing device (e.g., a data manager) to execute examples of the methods disclosed herein.

The term “processor” may comprise any programmable system comprising systems using micro- or nano-processors/controllers, reduced instruction set circuits (RISC), application specific integrated circuits (ASICs), logic circuits, and any other circuit or processor capable of executing the functions described herein. The term “database” may refer to either a body of data, a relational database management system (RDBMS), or to both. As used herein, a database may comprise any collection of data comprising hierarchical databases, relational databases, flat file databases, object-relational databases, object oriented databases, and any other structured collection of records or data that is stored in a computer system. The above examples are example only, and thus are not intended to limit in any way the definition and/or meaning of the terms “processor” or “database”.

The present disclosure may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

1-197. (canceled)

198. A vehicle, comprising:
a vehicle-defined connection counterpart; and
an object manipulator, comprising:
an end effector releasably coupled with the vehicle-defined connection counterpart, such that a coupled end effector is established;
a pivotable platform; and
a curved track, wherein the coupled end effector and the curved track are co-operatively configured such that displacement of the coupled end effector is guided by the curved track along a curvilinear path defined by the curved track;
wherein:
the vehicle-defined connection counterpart is configured for connection to a configuration-defined connection counterpart of a counterpart-disposed configuration;
the vehicle is configured to co-operate with the counterpart-disposed configuration such that:
while: (i) the coupled end effector is established, (ii) the vehicle-defined connection counterpart and the configuration-defined connection counterpart are co-operatively disposed in a misaligned relationship, wherein, in the misaligned relationship, there is an absence of alignment between the vehicle-defined connection counterpart and the configuration-defined connection counterpart, and (iii) the object manipulator is disposed in a guiding-effective relationship with the counterpart-disposed configuration, wherein, in the guiding-effective relationship, contact engagement between the pivotable platform and the counterpart-disposed configuration is effectible, and contact engagement between the coupled end effector and the counterpart-disposed configuration is effectible:
the pivotable platform is configured to co-operate with the counterpart-disposed configuration such that, while the pivotable platform is disposed in contact engagement with the counterpart-disposed configuration, in response to a platform-displacement force applied to the pivotable platform to urge displacement of the pivotable platform towards the counterpart-disposed configuration, a platform-urging reaction force is applied by the counterpart-disposed configuration to the pivotable platform to urge pivoting of the object manipulator, with effect that a pivoting of the coupled end effector, relative to the configuration-defined connection counterpart, is effectuated by the platform-urging reaction force, wherein the pivoting is effective for emplacing the vehicle-defined connection counterpart in angular alignment with the configuration-defined connection counterpart about a pitch axis;
the curved track and the end effector are configured to co-operate with the counterpart-disposed configuration such that, while the coupled end effector is disposed in contact engagement with the counterpart-disposed configuration, in response to an end effector-displacement force applied to the end effector to urge displacement of the end effector towards the counterpart-disposed configuration, an end effector-urging reaction force is applied by the counterpart-disposed configuration to the end effector to urge displacement of the end effector, with effect that a curvilinear displacement of the coupled end effector, relative to the configuration-defined connection counterpart, is effectuated by the end effector-urging reaction force, wherein the curvilinear displacement is guided by the curved track along the curved path, wherein the curvilinear displacement is effective for emplacing the vehicle-defined connection counterpart in angular alignment with the configuration-defined connection counterpart about a yaw axis;
wherein the pivoting and curvilinear displacement of the coupled end effector are for emplacing the vehicle-defined connection counterpart in alignment with the configuration-defined connection counterpart, such that the vehicle-defined connection counterpart and the configuration-defined connection counterpart become disposed in an alignment relationship for establishing connection between the vehicle-defined connection counterpart and the configuration-defined connection counterpart.

199. The vehicle of claim 198, wherein:
the vehicle is configured to co-operate with the counterpart-disposed configuration such that:
while: (i) the coupled end effector is established, (ii) the vehicle-defined connection counterpart and the configuration-defined connection counterpart are co-operatively disposed in the misaligned relationship, and (iii) the object manipulator is disposed in the guiding-effective relationship with the counterpart-disposed configuration:
the pivotable platform is configured to co-operate with the counterpart-disposed configuration such that, while the pivotable platform is disposed in contact engagement with a downward-facing surface of the counterpart-disposed configuration, in response to the platform-displacement force applied to the pivotable platform to urge displacement of the pivotable platform towards the downward-facing surface, the platform-urging reaction force is applied by the downward-facing surface to the pivotable platform to urge the pivoting of the object manipulator, with effect that the pivoting of the coupled end effector, relative to the configuration-defined connection counterpart, is effectuated by the platform-urging reaction force, wherein the pivoting is effective for emplacing the vehicle-defined connection counterpart in angular alignment with the configuration-defined connection counterpart about the pitch axis.

200. The vehicle of claim 198, wherein:
the vehicle is configured to co-operate with the counterpart-disposed configuration such that:
while: (i) the coupled end effector is established, (ii) the vehicle-defined connection counterpart and the configuration-defined connection counterpart are co-operatively disposed in the misaligned relationship, and (iii) the object manipulator is disposed in the guiding-effective relationship with the counterpart-disposed configuration:
the curved track and the end effector are configured to co-operative with the counterpart-disposed configuration such that, while the coupled end effector is disposed in contact engagement with a forward-facing surface of the counterpart-disposed configuration, in response to the end effector-displacement force applied to the end effector to urge displacement of the end effector towards the counterpart-disposed configuration, the end effector-urging reaction force is applied by the forward-facing surface of the counterpart-disposed configuration to the end effector to urge displacement of the end effector, with effect that the curvilinear displacement of the coupled end effector, relative to the configuration-defined connection counterpart, is effectuated by the end effector-urging reaction force, wherein the curvilinear displacement is guided by the curved track along the curved path, wherein the curvilinear displacement is effective for emplacing the vehicle-defined connection counterpart in angular alignment with the configuration-defined connection counterpart about the yaw axis.

201. The vehicle of claim 200, wherein:
the vehicle is a towing vehicle; and
a center of the curved track is coincident with a center of a fifth wheel of the towing vehicle.

202. The vehicle of claim 201, wherein:
a length of a radius of curvature of the curved track has the same value as a minimum spacing distance between the center of the fifth wheel and the curved track.

203. The vehicle of claim 198, wherein:
the establishing of the connection between the vehicle-defined connection counterpart and the configuration-defined connection counterpart is with effect that communication between the vehicle and the counterpart-disposed configuration is established.

204. The vehicle of claim 198, wherein:
the vehicle is configured to co-operate with the counterpart-disposed configuration such that:
a displacement, which is effective for emplacing the vehicle-defined connection counterpart in alignment with the configuration-defined connection counterpart, such that the vehicle-defined connection counterpart and the configuration-defined connection counterpart become disposed in the alignment relationship for establishing connection between the vehicle-defined connection counterpart and the configuration-defined connection counterpart, includes the pivoting and curvilinear displacement of the coupled end effector, relative to the configuration-defined connection counterpart.

205. The vehicle of claim 198, wherein:
the vehicle is configured to co-operate with the counterpart-disposed configuration such that:
while: (i) the coupled end effector is established, (ii) the vehicle-defined connection counterpart and the configuration-defined connection counterpart are co-operatively disposed in the misaligned relationship, and (iii) the object manipulator is disposed in the guiding-effective relationship with the counterpart-disposed configuration:
the coupled end effector is vertically displaceable, relative to the counterpart-disposed configuration, wherein a vertical displacement of the coupled end effector, relative to the counterpart-disposed configuration, is effective for emplacing the vehicle-defined connection counterpart in axial alignment with the configuration-defined connection counterpart about a yaw axis;
wherein the pivoting, curvilinear displacement, and the vertical displacement of the coupled end effector are for emplacing the vehicle-defined connection counterpart in alignment with the configuration-defined connection counterpart, such that the vehicle-defined connection counterpart and the configuration-defined connection counterpart become disposed in the alignment relationship for establishing connection between the vehicle-defined connection counterpart and the configuration-defined connection counterpart.

206. A kit for modifying a vehicle and a counterpart-absent configuration, the kit comprising:
vehicle adaptor components including:
a vehicle-defined connection counterpart; and
an object manipulator, comprising:
an end effector configured for being releasably coupled with the vehicle-defined connection counterpart, such that a coupled end effector is established; and
a pivotable platform; and
a curved track, wherein the coupled end effector and the curved track are co-operatively configured such that displacement of the coupled end effector is guided by the curved track along a curvilinear path defined by the curved track;
configuration adaptor components including:
a configuration-defined connection counterpart; and
wherein:
while: (i) the vehicle adaptor components are installed within a vehicle, with effect that a modified vehicle is established, such that the modified vehicle includes the vehicle-defined connection counterpart and the object manipulator, and (ii) the configuration adaptor components are installed within the counterpart-absent configuration with effect that a modified configuration is established, such that the modified configuration includes the configuration-defined connection counterpart:
the vehicle-defined connection counterpart is configured for connection to the configuration-defined connection counterpart; and
the modified vehicle and the modified configuration are co-operatively configured such that:
while: (i) the coupled end effector is established, (ii) the vehicle-defined connection counterpart and the configuration-defined connection counterpart are co-operatively disposed in a misaligned relationship, wherein, in the misaligned relationship, there is an absence of alignment between the vehicle-defined connection counterpart and the configuration-defined connection counterpart, and (iii) the object manipulator is disposed in a guiding-effective relationship with the modified configuration, wherein, in the guiding-effective relationship, contact engagement between the pivotable platform and the modified configuration is effectible, and contact engagement between the coupled end effector and the modified configuration is effectible:
the pivotable platform is configured to co-operate with the modified configuration such that, while the pivotable platform is disposed in contact engagement with the modified configuration, in response to a platform-displacement force applied to the pivotable platform to urge displacement of the pivotable platform towards the modified configuration, a platform-urging reaction force is applied by the modified configuration to the pivotable platform to urge pivoting of the object manipulator, with effect that a pivoting of the coupled end effector, relative to the configuration-defined connection counterpart, is effectuated by the platform-urging reaction force, wherein the pivoting is effective for emplacing the vehicle-defined connection counterpart in angular alignment with the configuration-defined connection counterpart about a pitch axis;
the curved track and the end effector are configured to co-operate with the modified configuration such that, while the coupled end effector is disposed in contact engagement with the modified configuration, in response to an end effector-displacement force applied to the end effector to urge displacement of the end effector towards the modified configuration, an end effector-urging reaction force is applied by the modified configuration to the end effector to urge displacement of the end effector, with effect that a curvilinear displacement of the coupled end effector, relative to the configuration-defined connection counterpart, is effectuated by the end effector-urging reaction force, wherein the curvilinear displacement is guided by the curved track along the curved path, wherein the curvilinear displacement is effective for emplacing the vehicle-defined connection counterpart in angular alignment with the configuration-defined connection counterpart about a yaw axis;
wherein the pivoting and curvilinear displacement of the coupled end effector are for emplacing the vehicle-defined connection counterpart in alignment with the configuration-defined connection counterpart, such that the vehicle-defined connection counterpart and the configuration-defined connection counterpart become disposed in an alignment relationship for establishing connection between the vehicle-defined connection counterpart and the configuration-defined connection counterpart.

207. The kit of claim 206, wherein:
the modified vehicle and the modified configuration are co-operatively configured such that:
while: (i) the coupled end effector is established, (ii) the vehicle-defined connection counterpart and the configuration-defined connection counterpart are co-operatively disposed in the misaligned relationship, and (iii) the object manipulator is disposed in the guiding-effective relationship with the modified configuration:
the pivotable platform is configured to co-operate with the modified configuration such that, while the pivotable platform is disposed in contact engagement with a downward-facing surface of the modified configuration, in response to the platform-displacement force applied to the pivotable platform to urge displacement of the pivotable platform towards the downward-facing surface, the platform-urging reaction force is applied by the downward-facing surface to the pivotable platform to urge the pivoting of the object manipulator, with effect that the pivoting of the coupled end effector, relative to the configuration-defined connection counterpart, is effectuated by the platform-urging reaction force, wherein the pivoting is effective for emplacing the vehicle-defined connection counterpart in angular alignment with the configuration-defined connection counterpart about the pitch axis.

208. The kit of claim 206, wherein:
the modified vehicle and the modified configuration are co-operatively configured such that:
while: (i) the coupled end effector is established, (ii) the vehicle-defined connection counterpart and the configuration-defined connection counterpart are co-operatively disposed in the misaligned relationship, and (iii) the object manipulator is disposed in the guiding-effective relationship with the modified configuration:
the curved track and the end effector are configured to co-operative with the modified configuration such that, while the coupled end effector is disposed in contact engagement with a forward-facing surface of the modified configuration, in response to the end effector-displacement force applied to the end effector to urge displacement of the end effector towards the modified configuration, the end effector-urging reaction force is applied by the forward-facing surface of the modified configuration to the end effector to urge displacement of the end effector, with effect that the curvilinear displacement of the coupled end effector, relative to the configuration-defined connection counterpart, is effectuated by the end effector-urging reaction force, wherein the curvilinear displacement is guided by the curved track along the curved path, wherein the curvilinear displacement is effective for emplacing the vehicle-defined connection counterpart in angular alignment with the configuration-defined connection counterpart about the yaw axis.

209. The kit of claim 208, wherein:
the vehicle is a towing vehicle; and
a center of the curved track is coincident with a center of a fifth wheel of the towing vehicle.

210. The kit of claim 209, wherein:
a length of a radius of curvature of the curved track has the same value as a minimum spacing distance between the center of the fifth wheel and the curved track.

211. The kit of claim 206, wherein:
the establishing of the connection between the vehicle-defined connection counterpart and the configuration-defined connection counterpart is with effect that communication between the modified vehicle and the modified configuration is established.

212. The kit of claim 206, wherein:
the modified vehicle and the modified configuration are co-operatively configured such that:
a displacement, which is effective for emplacing the vehicle-defined connection counterpart in alignment with the configuration-defined connection counterpart, such that the vehicle-defined connection counterpart and the configuration-defined connection counterpart become disposed in the alignment relationship for establishing connection between the vehicle-defined connection counterpart and the configuration-defined connection counterpart, includes the pivoting and curvilinear displacement of the coupled end effector, relative to the configuration-defined connection counterpart.

213. The kit of claim 206, wherein:
the modified vehicle and the modified configuration are co-operatively configured such that:
while: (i) the coupled end effector is established, (ii) the vehicle-defined connection counterpart and the configuration-defined connection counterpart are co-operatively disposed in the misaligned relationship, and (iii) the object manipulator is disposed in the guiding-effective relationship with the modified configuration:
the coupled end effector is vertically displaceable, relative to the modified configuration, wherein a vertical displacement of the coupled end effector, relative to the modified configuration, is effective for emplacing the vehicle-defined connection counterpart in axial alignment with the configuration-defined connection counterpart about a yaw axis;
wherein the pivoting, curvilinear displacement, and the vertical displacement of the coupled end effector are for emplacing the vehicle-defined connection counterpart in alignment with the configuration-defined connection counterpart, such that the vehicle-defined connection counterpart and the configuration-defined connection counterpart become disposed in the alignment relationship for establishing connection between the vehicle-defined connection counterpart and the configuration-defined connection counterpart.

214. A system, comprising:
a vehicle, comprising:
a vehicle-defined connection counterpart;
an object manipulator, comprising:
an end effector configured to be releasably coupled with the vehicle-defined connection counterpart, such that a coupled end effector is established;
a pivotable platform; and
a curved track, wherein the coupled end effector and the curved track are co-operatively configured such that displacement of the coupled end effector is guided by the curved track along a curvilinear path defined by the curved track;
a counterpart-disposed configuration, comprising:
a configuration-defined connection counterpart;
wherein:
the vehicle-defined connection counterpart and the configuration-defined connection counterpart are co-operatively configured for connection;
the vehicle and the counterpart-disposed configuration are co-operatively configured such that:
while: (i) the coupled end effector is established, (ii) the vehicle-defined connection counterpart and the configuration-defined connection counterpart are co-operatively disposed in a misaligned relationship, wherein, in the misaligned relationship, there is an absence of alignment between the vehicle-defined connection counterpart and the configuration-defined connection counterpart, and (iii) the object manipulator is disposed in a guiding-effective relationship with the counterpart-disposed configuration, wherein, in the guiding-effective relationship, contact engagement between the pivotable platform and the counterpart-disposed configuration is effectible, and contact engagement between the coupled end effector and the counterpart-disposed configuration is effectible:
the pivotable platform is configured to co-operate with the counterpart-disposed configuration such that, while the pivotable platform is disposed in contact engagement with the counterpart-disposed configuration, in response to a platform-displacement force applied to the pivotable platform to urge displacement of the pivotable platform towards the counterpart-disposed configuration, a platform-urging reaction force is applied by the counterpart-disposed configuration to the pivotable platform to urge pivoting of the object manipulator, with effect that a pivoting of the coupled end effector, relative to the configuration-defined connection counterpart, is effectuated by the platform-urging reaction force, wherein the pivoting is effective for emplacing the vehicle-defined connection counterpart in angular alignment with the configuration-defined connection counterpart about a pitch axis;
the curved track and the end effector are configured to co-operate with the counterpart-disposed configuration such that, while the coupled end effector is disposed in contact engagement with the counterpart-disposed configuration, in response to an end effector-displacement force applied to the end effector to urge displacement of the end effector towards the counterpart-disposed configuration, an end effector-urging reaction force is applied by the counterpart-disposed configuration to the end effector to urge displacement of the end effector, with effect that a curvilinear displacement of the coupled end effector, relative to the configuration-defined connection counterpart, is effectuated by the end effector-urging reaction force, wherein the curvilinear displacement is guided by the curved track along the curved path, wherein the curvilinear displacement is effective for emplacing the vehicle-defined connection counterpart in angular alignment with the configuration-defined connection counterpart about a yaw axis;
wherein the pivoting and curvilinear displacement of the coupled end effector are for emplacing the vehicle-defined connection counterpart in alignment with the configuration-defined connection counterpart, such that the vehicle-defined connection counterpart and the configuration-defined connection counterpart become disposed in an alignment relationship for establishing connection between the vehicle-defined connection counterpart and the configuration-defined connection counterpart.

215. The system of claim 214, wherein:
the vehicle and the counterpart-disposed configuration are co-operatively configured such that:
while: (i) the coupled end effector is established, (ii) the vehicle-defined connection counterpart and the configuration-defined connection counterpart are co-operatively disposed in the misaligned relationship, and (iii) the object manipulator is disposed in the guiding-effective relationship with the counterpart-disposed configuration:
the pivotable platform is configured to co-operate with the counterpart-disposed configuration such that, while the pivotable platform is disposed in contact engagement with a downward-facing surface of the counterpart-disposed configuration, in response to the platform-displacement force applied to the pivotable platform to urge displacement of the pivotable platform towards the downward-facing surface, the platform-urging reaction force is applied by the downward-facing surface to the pivotable platform to urge the pivoting of the object manipulator, with effect that the pivoting of the coupled end effector, relative to the configuration-defined connection counterpart, is effectuated by the platform-urging reaction force, wherein the pivoting is effective for emplacing the vehicle-defined connection counterpart in angular alignment with the configuration-defined connection counterpart about the pitch axis.

216. The system of claim 214, wherein:
the vehicle and the counterpart-disposed configuration are co-operatively configured such that:
while: (i) the coupled end effector is established, (ii) the vehicle-defined connection counterpart and the configuration-defined connection counterpart are co-operatively disposed in the misaligned relationship, and (iii) the object manipulator is disposed in the guiding-effective relationship with the counterpart-disposed configuration:
the curved track and the end effector are configured to co-operative with the counterpart-disposed configuration such that, while the coupled end effector is disposed in contact engagement with a forward-facing surface of the counterpart-disposed configuration, in response to the end effector-displacement force applied to the end effector to urge displacement of the end effector towards the counterpart-disposed configuration, the end effector-urging reaction force is applied by the forward-facing surface of the counterpart-disposed configuration to the end effector to urge displacement of the end effector, with effect that the curvilinear displacement of the coupled end effector, relative to the configuration-defined connection counterpart, is effectuated by the end effector-urging reaction force, wherein the curvilinear displacement is guided by the curved track along the curved path, wherein the curvilinear displacement is effective for emplacing the vehicle-defined connection counterpart in angular alignment with the configuration-defined connection counterpart about the yaw axis.

217. The system of claim 216, wherein:
the vehicle is a towing vehicle; and
a center of the curved track is coincident with a center of a fifth wheel of the vehicle.

218. The system of claim 217, wherein:
a length of a radius of curvature of the curved track has the same value as a minimum spacing distance between the center of the fifth wheel and the curved track.

219. The system of claim 214, wherein:
the establishing of the connection between the vehicle-defined connection counterpart and the configuration-defined connection counterpart is with effect that communication between the vehicle and the counterpart-disposed configuration is established.

220. The system of claim 214, wherein:
the vehicle and the counterpart-disposed configuration are co-operatively configured such that:
a displacement, which is effective for emplacing the vehicle-defined connection counterpart in alignment with the configuration-defined connection counterpart, such that the vehicle-defined connection counterpart and the configuration-defined connection counterpart become disposed in the alignment relationship for establishing connection between the vehicle-defined connection counterpart and the configuration-defined connection counterpart, includes the pivoting and curvilinear displacement of the coupled end effector, relative to the configuration-defined connection counterpart.

221. The system of claim 214, wherein:
the vehicle and the counterpart-disposed configuration are co-operatively configured such that:
while: (i) the coupled end effector is established, (ii) the vehicle-defined connection counterpart and the configuration-defined connection counterpart are co-operatively disposed in the misaligned relationship, and (iii) the object manipulator is disposed in the guiding-effective relationship with the counterpart-disposed configuration:
the coupled end effector is vertically displaceable, relative to the counterpart-disposed configuration, wherein a vertical displacement of the coupled end effector, relative to the counterpart-disposed configuration, is effective for emplacing the vehicle-defined connection counterpart in axial alignment with the configuration-defined connection counterpart about a yaw axis;
wherein the pivoting, curvilinear displacement, and the vertical displacement of the coupled end effector are for emplacing the vehicle-defined connection counterpart in alignment with the configuration-defined connection counterpart, such that the vehicle-defined connection counterpart and the configuration-defined connection counterpart become disposed in the alignment relationship for establishing connection between the vehicle-defined connection counterpart and the configuration-defined connection counterpart.

222. A counterpart-disposed configuration, comprising:
a configuration-defined connection counterpart;
wherein:
the configuration-defined connection counterpart is configured for connection to a vehicle-defined connection counterpart of a vehicle, the vehicle comprising:
an object manipulator, comprising:
an end effector releasably coupled with the vehicle-defined connection counterpart, such that a coupled end effector is established;
a pivotable platform; and
a curved track, wherein the coupled end effector and the curved track are co-operatively configured such that displacement of the coupled end effector is guided by the curved track along a curvilinear path defined by the curved track;
the counterpart-disposed configuration is configured to co-operate with the vehicle such that:
while: (i) the coupled end effector is established, (ii) the vehicle-defined connection counterpart and the configuration-defined connection counterpart are co-operatively disposed in a misaligned relationship, wherein, in the misaligned relationship, there is an absence of alignment between the vehicle-defined connection counterpart and the configuration-defined connection counterpart, and (iii) the object manipulator is disposed in a guiding-effective relationship with the counterpart-disposed configuration, wherein, in the guiding-effective relationship, contact engagement between the pivotable platform and the counterpart-disposed configuration is effectible, and contact engagement between the coupled end effector and the counterpart-disposed configuration is effectible:
the pivotable platform is configured to co-operate with the counterpart-disposed configuration such that, while the pivotable platform is disposed in contact engagement with the counterpart-disposed configuration, in response to a platform-displacement force applied to the pivotable platform to urge displacement of the pivotable platform towards the counterpart-disposed configuration, a platform-urging reaction force is applied by the counterpart-disposed configuration to the pivotable platform to urge pivoting of the object manipulator, with effect that a pivoting of the coupled end effector, relative to the configuration-defined connection counterpart, is effectuated by the platform-urging reaction force, wherein the pivoting is effective for emplacing the vehicle-defined connection counterpart in angular alignment with the configuration-defined connection counterpart about a pitch axis;
the curved track and the end effector are configured to co-operate with the counterpart-disposed configuration such that, while the coupled end effector is disposed in contact engagement with the counterpart-disposed configuration, in response to an end effector-displacement force applied to the end effector to urge displacement of the end effector towards the counterpart-disposed configuration, an end effector-urging reaction force is applied by the counterpart-disposed configuration to the end effector to urge displacement of the end effector, with effect that a curvilinear displacement of the coupled end effector, relative to the configuration-defined connection counterpart, is effectuated by the end effector-urging reaction force, wherein the curvilinear displacement is guided by the curved track along the curved path, wherein the curvilinear displacement is effective for emplacing the vehicle-defined connection counterpart in angular alignment with the configuration-defined connection counterpart about a yaw axis;
wherein the pivoting and curvilinear displacement of the coupled end effector are for emplacing the vehicle-defined connection counterpart in alignment with the configuration-defined connection counterpart, such that the vehicle-defined connection counterpart and the configuration-defined connection counterpart become disposed in an alignment relationship for establishing connection between the vehicle-defined connection counterpart and the configuration-defined connection counterpart.
